(19) United States
(12) Patent Application Publication
(10) Pub. No.: US 2024/0142682 A1
(43) Pub. Date: May 2, 2024

(54) LIGHT ABSORPTION ANISOTROPIC LAYER, LAMINATE, AND INFRARED LIGHT SENSOR SYSTEM

(71) Applicant: FUJIFILM Corporation, Tokyo (JP)

(72) Inventors: Mayumi NOJIRI, Kanagawa (JP); Ayako MURAMATSU, Kanagawa (JP); Naoya SHIBATA, Kanagawa (JP); Yuki HIRAI, Kanagawa (JP); Ryoji HIMENO, Kanagawa (JP); Shinichi MORISHIMA, Kanagawa (JP); Takashi KATOU, Kanagawa (JP)

(73) Assignee: FUJIFILM Corporation, Tokyo (JP)

(21) Appl. No.: 18/481,056

(22) Filed: Oct. 4, 2023

Related U.S. Application Data
(63) Continuation of application No. PCT/JP2022/017497, filed on Apr. 11, 2022.

(30) Foreign Application Priority Data
Apr. 9, 2021 (JP) 2021-066771

(51) Int. Cl. G02B 5/20; C09K 19/60; G02B 5/30

(52) U.S. Cl. CPC G02B 5/208; C09K 19/60; G02B 5/3058

(57) ABSTRACT

A light absorption anisotropic layer which has a high S/N ratio for generating polarized light with respect to rays in an infrared wavelength region, is lightweight, and has excellent handleability, a laminate, and a sensor system including the light absorption anisotropic layer or the laminate. The light absorption anisotropic layer contains a dichroic coloring agent having a maximal absorption at a wavelength of 700 to 1500 nm, in which an average absorbance at a wavelength of 850 nm is 0.24 to 0.50 and a thickness is 5 μm or less.

### CROSS-REFERENCE TO RELATED APPLICATIONS

This application is a Continuation of PCT International Application No. PCT/JP2022/017497 filed on Apr. 11, 2022, which was published under PCT Article 21(2) in Japanese, and which claims priority under 35 U.S.C. § 119(a) to Japanese Patent Application No. 2021-066771 filed on Apr. 9, 2021. The above applications are hereby expressly incorporated by reference, in their entirety, into the present application.

### BACKGROUND OF THE INVENTION

### 1. Field of the Invention

The present invention relates to a light absorption anisotropic layer, a laminate, and an infrared light sensor system.

### 2. Description of the Related Art

In recent years, in applications such as a recognition light source for a touch panel, a security camera, a sensor, forgery prevention, and communication equipment, there has been a demand for not only a polarizing plate for a visible wavelength region but also a polarizing plate for use in an infrared wavelength region. The polarizing plate is used for a waveguide of light to which a polarization function of rays in the infrared wavelength region is applied, switching, sensing, antireflection of rays in the infrared wavelength region, and the like. On the other hand, a polarizer obtained by containing iodine in iodine in polyvinyl alcohol (PVA) and stretch-aligning the polyvinyl alcohol, which has been most commonly used in the related art, has insufficient polarization performance in an infrared wavelength region of 850 nm or more.

Meanwhile, as a polarizer or a polarizing plate used in the infrared wavelength region, an infrared polarizing plate to which wire grid is applied, as disclosed in JP2016-148871A, and an infrared polarizer in which a coloring agent having infrared absorption is dispersed in PVA and stretch-aligned, as disclosed in WO2018/088558A, have been reported.

### SUMMARY OF THE INVENTION

The wire grid type polarizing plate (light absorption anisotropic layer) as disclosed in JP2016-148871A can also be processed into a film type, and is becoming popular because it is stable as a product. On the other hand, in a case where a surface does not have nano-level irregularities, optical properties cannot be maintained, so that the polarizing plate cannot be applied to an application in which the surface is touched, and it is difficult to apply antireflection processing or antiglare processing. In addition, since nano-level processing is required, it is difficult to manufacture in a large area, and it is very expensive.

In addition, since the PVA-stretched type polarizer (light absorption anisotropic layer) as disclosed in WO2018/088558A has a film thickness of several tens of m or more and is not flexible, the polarizer is not suitable for processing into a curved surface and is not suitable for bending, so that there is a problem with handling.

In addition, in a case where the light absorption anisotropic layer is applied to various applications, there is a demand for the light absorption anisotropic layer to has a high efficiency of generating polarized light with respect to unpolarized light rays in the infrared wavelength region, that is, to has a high S/N ratio for generating polarized light with respect to rays in the infrared wavelength region.

An object of the present invention is to provide a light absorption anisotropic layer which has a high S/N ratio for generating polarized light with respect to rays in an infrared wavelength region, is lightweight, and has excellent handleability, a laminate, and a sensor system including the light absorption anisotropic layer or the laminate.

As a result of intensive research to achieve the above-described objects, the present inventors have found that the above-described objects can be achieved by a light absorption anisotropic layer containing a dichroic coloring agent having a maximal absorption at a wavelength of 700 to 1500 nm, in which an average absorbance at 850 nm is 0.24 to 0.50 and a thickness is 5 μm or less.
[1] Alight absorption anisotropic layer comprising:
a dichroic coloring agent having a maximal absorption at a wavelength of 700 to 1500 nm,
in which an average absorbance at a wavelength of 850 nm is 0.24 to 0.50, and
a thickness is 5 μm or less.
[2] The light absorption anisotropic layer according to [1], further comprising: a liquid crystalline compound.
[3] The light absorption anisotropic layer according to [1] or [2],
in which an angle between an absorption axis at a wavelength of 250 nm and an absorption axis at a maximal absorption wavelength of the dichroic coloring agent is 0° to 5°.
[4] The light absorption anisotropic layer according to any one of [1] to [3],
in which the light absorption anisotropic layer is formed of a composition containing the dichroic coloring agent and a liquid crystalline polymer.
[5] The light absorption anisotropic layer according to [2] or [4],
in which a content of the dichroic coloring agent is 1% to 50% by mass with respect to a content of the liquid crystalline compound.
[6] The light absorption anisotropic layer according to [4],
in which an aqueous solution of the liquid crystalline polymer exhibits lyotropic liquid crystallinity.
[7] The light absorption anisotropic layer according to [2], [4], or [5],
in which the liquid crystalline compound exhibits thermotropic liquid crystallinity.
[8] The light absorption anisotropic layer according to any one of [1] to [7],
in which the dichroic coloring agent exhibits thermotropic liquid crystallinity.
[9] The light absorption anisotropic layer according to any one of [1] to [7],
in which an aqueous solution of the dichroic coloring agent exhibits lyotropic liquid crystallinity.
[10] The light absorption anisotropic layer according to any one of [1] to [9],
in which an alignment degree at a maximal absorption wavelength of the dichroic coloring agent is 0.80 or more.
[11] The light absorption anisotropic layer according to any one of [1] to [10],
in which the light absorption anisotropic layer shows a Bragg peak in an X-ray diffraction measurement.
[12] The light absorption anisotropic layer according to any one of [1] to [11],
in which the light absorption anisotropic layer contains two or more kinds of the dichroic coloring agents.
[13] The light absorption anisotropic layer according to any one of [1] to [12], further comprising:
a dichroic coloring agent having a maximal absorption at a wavelength of 400 to 700 nm.
[14] The light absorption anisotropic layer according to [13],
in which an angle between an absorption axis at a maximal absorption wavelength of the dichroic coloring agent having a maximal absorption at a wavelength of 400 to 700 nm and an absorption axis at a maximal absorption wavelength of the dichroic coloring agent is 10° to 90°.
[15] The light absorption anisotropic layer according to any one of [1] to [14],
in which a luminosity corrected single transmittance at a wavelength of 400 to 700 nm is 30% to 50%.
[16] The light absorption anisotropic layer according to any one of [1] to [15],
in which an average absorbance at a wavelength of 400 to 700 nm is 0.2 or less.
[17] The light absorption anisotropic layer according to any one of [1] to [16],
in which an average absorbance at a wavelength of 750 nm is 0.2 to 0.5.
[18] The light absorption anisotropic layer according to any one of [1] to [17],
in which an average absorbance at a wavelength of 1100 nm is 0.2 to 0.5.
[19] A laminate comprising:
the light absorption anisotropic layer A according to any one of [1] to [18]; and
a light absorption anisotropic layer B,
in which the light absorption anisotropic layer B contains a dichroic coloring agent having a maximal absorption at a wavelength of 400 to 700 nm, and
a luminosity corrected single transmittance of the light absorption anisotropic layer B at a wavelength of 400 to 700 nm is 30% to 50%.
[20] The laminate according to [19],
in which the light absorption anisotropic layer B consists of a stretched polyvinyl alcohol dyed with iodine.
[21] The laminate according to [19],
in which the light absorption anisotropic layer B contains a liquid crystalline compound.
[22] The laminate according to any one of [19] to [21],
in which an absorption axis at a maximal absorption wavelength of the light absorption anisotropic layer A is parallel to an absorption axis at a maximal absorption wavelength of the light absorption anisotropic layer B.
[23] The laminate according to any one of [19] to [21],
in which an angle between an absorption axis at a maximal absorption wavelength of the light absorption anisotropic layer A and an absorption axis at a maximal absorption wavelength of the light absorption anisotropic layer B is 10° to 90°.
[24] A laminate comprising:
the light absorption anisotropic layer A according to any one of [1] to [18]; and
an optically anisotropic layer,
in which, in a case where a maximal absorption wavelength of the light absorption anisotropic layer A is defined as a wavelength λ_{A}, an in-plane retardation of the optically anisotropic layer at the wavelength λ_{A} is 10 to λ_{A}/4 nm.
[25] A laminate comprising:
the light absorption anisotropic layer A according to any one of [1] to [18]; and
an optically anisotropic layer,
in which an in-plane retardation of the entire laminate at a wavelength of 550 nm is 0 to 50 nm.
[26] The laminate according to any one of [19] to [25], further comprising:
an optically anisotropic layer,
in which, in a case where a maximal absorption wavelength of the light absorption anisotropic layer A is defined as a wavelength λ_{A}, an in-plane retardation of the optically anisotropic layer at the wavelength λ_{A} is 10 to λ_{A}/4 nm.
[27] The laminate according to any one of [19] to [26], further comprising:
an optically anisotropic layer,
in which a sum of out-plane retardations of respective members of the laminate at a wavelength of 550 nm is −50 to 50 nm.
[28] A laminate comprising:
the light absorption anisotropic layer A according to any one of [1] to [18]; and
a wire grid polarizer,
in which an angle between an absorption axis of the light absorption anisotropic layer A and an absorption axis of the wire grid polarizer is 1° or less.
[29] An infrared light sensor system comprising:
the light absorption anisotropic layer according to any one of [1] to [18] or the laminate according to any one of [19] to [28]; and
at least one of an infrared reception unit or an infrared light source.
[30] The light absorption anisotropic layer according to any one of [1] to [18],
in which the light absorption anisotropic layer is used for a display device, a sensor, a lens, a switching element, an isolator, or a camera.
[31] The laminate according to any one of [19] to [28],
in which the laminate is used for a display device, a sensor, a lens, a switching element, an isolator, or a camera.

According to the present invention, it is possible to provide a light absorption anisotropic layer which has a high S/N ratio for generating polarized light with respect to rays in an infrared wavelength region, is lightweight, and has excellent handleability, a laminate, and a sensor system including the light absorption anisotropic layer or the laminate.

### BRIEF DESCRIPTION OF THE DRAWINGS

FIG. 1 is a schematic cross-sectional view showing an example of a sensor system according to an embodiment of the present invention.

FIG. 2 is a schematic cross-sectional view showing an example of a sensor system according to an embodiment of the present invention.

FIG. 3 is a schematic cross-sectional view showing an example of a sensor system according to an embodiment of the present invention.

FIG. 4 is a schematic cross-sectional view showing an example of a display device according to an embodiment of the present invention.

### DESCRIPTION OF THE PREFERRED EMBODIMENTS

Hereinafter, the present invention will be described in detail.

The description of configuration requirements described below may be made based on typical embodiments of the present invention, but the present invention is not limited to such embodiments.

Any numerical range expressed using “to” in the present specification refers to a range including the numerical values before and after the “to” as a lower limit value and an upper limit value, respectively.

In addition, in the present specification, a term “parallel” or “orthogonal” does not indicate parallel or orthogonal in a strict sense, but indicates a range of ±5° from parallel or orthogonal.

In addition, in the present specification, concepts of a liquid crystalline composition and a liquid crystalline compound also include those that no longer exhibit liquid crystallinity due to curing or the like.

[Substituent W]

A substituent W used in the present specification represents any of the following groups.

Examples of the substituent W include a halogen atom, an alkyl group having 1 to 20 carbon atoms, a halogenated alkyl group having 1 to 20 carbon atoms, a cycloalkyl group having 1 to 20 carbon atoms, an alkylcarbonyl group having 1 to 10 carbon atoms, an alkyloxycarbonyl group having 1 to 10 carbon atoms, an alkylcarbonyloxy group having 1 to 10 carbon atoms, an alkylamino group having 1 to 10 carbon atoms, an alkylaminocarbonyl group, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group (also referred to as a hetero ring group), a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), and other known substituents.

Details of the substituent are described in paragraph of JP2007-234651A.

In addition, the substituent W may be a group represented by Formula (W1).

*-LW-SPW-Q (W1)

In Formula (W1), LW represents a single bond or a divalent linking group, SPW represents a divalent spacer group, Q represents Q1 or Q2 in Formula (LC) described later, and * represents a bonding position.

Examples of the divalent linking group represented by LW include —O—, —(CH₂)_{g}—, —(CF₂)_{g}—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ each independently represent a hydrogen atom, an alkyl group having 1 to 4 carbon atoms, a cycloalkyl group, an aryl group, a cyano group, or a halogen atom), —C≡C—, —N═N—, —S—, —S(O)—, —S(O)(O)—, —(O)S(O)O—, —O(O)S(O)O—, —SC(O)—, and —C(O)S—. LW may be a group in which two or more of these groups are combined (hereinafter, also abbreviated as “L-C”).

Examples of the divalent spacer group represented by SPW include a linear, branched, or cyclic alkylene group having 1 to 50 carbon atoms, and a heterocyclic group having 1 to 20 carbon atoms.

The carbon atom of the above-described alkylene group or the carbon atom of the heterocyclic group may be substituted with —O—, —Si(CH₃)₂—, —(Si(CH₃)₂O)_{g}—, —(OSi(CH₃)₂)_{g}— (g represents an integer of 1 to 10), —N(Z)—, —C(Z)═C(Z′)—, —C(Z)═N—, —N═C(Z)—, —C(Z)₂—C(Z′)₂—, —C(O)—, —OC(O)—, —C(O)O—, —O—C(O)O—, —N(Z)C(O)—, —C(O)N(Z)—, —C(Z)═C(Z′)—C(O)O—, —O—C(O)—C(Z)═C(Z′)—, —C(Z)═N—, —N═C(Z)—, —C(Z)═C(Z′)—C(O)N(Z″)—, —N(Z″)—C(O)—C(Z)═C(Z′)—, —C(Z)═C(Z′)—C(O)—S—, —S—C(O)—C(Z)═C(Z′)—, —C(Z)═N—N═C(Z′)— (Z, Z′, and Z″ each independently represent a hydrogen atom, an alkyl group having 1 to 4 carbon atoms, a cycloalkyl group, an aryl group, a cyano group, or a halogen atom), —C≡C—, —N═N—, —S—, —C(S)—, —S(O)—, —SO₂—, —(O)S(O)O—, —O(O)S(O)O—, —SC(O)—, —C(O)S—, or a group obtained by combining two or more of these groups (hereinafter, also collectively abbreviated as “SP-C”).

The hydrogen atom of the above-described alkylene group or the hydrogen atom of the heterocyclic group may be substituted with a halogen atom, a cyano group, —Z^{H}, —OH, —OZ^{H}, —COOH, —C(O)Z^{H}, —C(O)OZ^{H}, —OC(O)Z^{H}, —OC(O)OZ^{H}, —NZ^{H}Z^{H}′, —NZ^{H}C(O)Z^{H}′, —NZ^{H}C(O)OZ^{H}′, —C(O)NZ^{H}Z^{H}′, —OC(O)NZ^{H}Z^{H}′, —NZ^{H}C(O)NZ^{H}′OZ^{H}″, —SH, —SZ^{H}, —C(S)Z^{H}, —C(O)SZ^{H}, or —SC(O)Z^{H} (hereinafter, also collectively abbreviated as “SP-H”). Here, Z^{H} and Z^{H}′ each independently represent an alkyl group having 1 to 10 carbon atoms, a halogenated alkyl group, or -L-CL (L represents a single bond or a divalent linking group, and specific examples of the divalent linking group are the same as those for LW and SPW described above; CL represents a crosslinkable group, examples thereof include a group represented by Q1 or Q2 in Formula (LC) described later, and a crosslinkable group represented by Formulae (P1) to (P30) described later is preferable).

[Light Absorption Anisotropic Layer A]

The light absorption anisotropic layer according to the embodiment of the present invention contains a dichroic coloring agent having a maximal absorption at a wavelength of 700 to 1500 nm, in which an average absorbance of the light absorption anisotropic layer at a maximal absorption wavelength of the dichroic coloring agent is 0.24 to 0.5, and a thickness is m or less. The light absorption anisotropic layer having absorption in the above-described infrared region is also referred to as a light absorption anisotropic layer A.

The average absorbance of the light absorption anisotropic layer in the present invention denotes an absorbance with respect to unpolarized light. In addition, the maximal absorption wavelength of the dichroic coloring agent can be obtained by measuring the light absorption anisotropic layer A with an ultraviolet-visible-near infrared spectrophotometer V-660. The average absorbance of the light absorption anisotropic layer A at the maximal absorption wavelength is obtained by irradiating the light absorption anisotropic layer A with unpolarized rays having the above-described maximal absorption wavelength and measuring the absorbance at the maximal absorption wavelength with the ultraviolet-visible-near infrared spectrophotometer V-660. The average absorbance of the light absorption anisotropic layer according to the embodiment of the present invention at the maximal absorption wavelength of the dichroic coloring agent is preferably 0.3 or more, more preferably 0.35 or more, and still more preferably 0.4 or more.

The mechanism by which the light absorption anisotropic layer A has a high S/N ratio for generating polarized light with respect to rays in the infrared wavelength region, is lightweight, and has excellent handleability is not necessarily clear, but the present inventors have presumed as follows.

Since the light absorption anisotropic layer A contains the dichroic coloring agent satisfying the above-described requirement, and the above-described average absorbance is within the above-described range, it is considered that absorption of infrared light by the dichroic coloring agent occurs moderately, and the S/N ratio for generating polarized light with respect to rays in the infrared wavelength region increases. On the other hand, since the thickness is 5 m or less, it is considered that the light absorption anisotropic layer A is lightweight and has excellent handleability.

Hereinafter, a case where at least one of a higher S/N ratio for generating polarized light with respect to rays in the infrared wavelength region or a lighter weight and more excellent handleability is satisfied is also referred to as “effect of the present invention is more excellent”.

The light absorption anisotropic layer A may be produced by various known techniques as long as the above-described requirements are satisfied. The anisotropy of light absorption can be realized by aligning a substance (dichroic coloring agent) having different absorbances depending on directions.

Examples of a method of aligning the dichroic coloring agent include a method of aligning the dichroic coloring agent using alignment of a liquid crystalline compound. The above-described method is preferably used in the present invention from the viewpoint of moisture-heat resistance of the light absorption anisotropic layer A. In the above-described method, in a case where the dichroic coloring agent itself exhibits liquid crystallinity, the dichroic coloring agent can also be aligned using only the liquid crystallinity of the dichroic coloring agent.

In a case where the light absorption anisotropic layer A is formed by aligning the dichroic coloring agent using the above-described method, the light absorption anisotropic layer contains a liquid crystalline compound.

In a case where the dichroic coloring agent of the present invention is aligned to form the light absorption anisotropic layer A by the above-described method, it is preferable that the absorption axis of the dichroic coloring agent is parallel to an alignment axis of the liquid crystalline compound. The above-described state is advantageous from the viewpoint of cost and aligning properties because the structure is simple.

Examples of a method of utilizing the alignment of the liquid crystalline compound include the following method.

A preferred aspect 1 is a method of aligning a water-soluble dichroic coloring agent by utilizing aligning properties of lyotropic liquid crystals. A preferred aspect 2 is a method of aligning a water-insoluble infrared-absorbing coloring agent by utilizing aligning properties of thermotropic liquid crystals.

In a case where the light absorption anisotropic layer A is used by being laminated with a polarizer in a visible wavelength region, it is preferable that the light absorption anisotropic layer A has substantially no absorption in the visible light region. In this case, an average absorbance of the light absorption anisotropic layer A at a wavelength of 400 to 700 nm is preferably 0.2 or less. The lower limit of the average absorbance is not particularly limited, and may be, for example, 0.0 or more.

Other requirements of the light absorption anisotropic layer A are not particularly limited as long as the light absorption anisotropic layer A satisfies the above-described requirements. For example, an average absorbance of the light absorption anisotropic layer A at a wavelength of 750 nm may be 0.2 to 0.5. In addition, an average absorbance of the light absorption anisotropic layer A at a wavelength of 1100 nm may be 0.2 to 0.5. The light absorption anisotropic layer A may simultaneously satisfy the requirements of the average absorbances at the above-described wavelengths.

<Preferred Aspect 1>

Hereinafter, a preferred method (preferred aspect 1) for forming the light absorption anisotropic layer A will be described.

(Composition)

In the preferred aspect 1, it is also preferable that the light absorption anisotropic layer A according to the embodiment of the present invention is formed of a composition containing a lyotropic liquid crystalline compound.

The lyotropic liquid crystalline compound is a compound exhibiting lyotropic liquid crystallinity. The lyotropic liquid crystallinity refers to a property of causing a phase transition between an isotropic phase and a liquid crystal phase by changing a temperature or a concentration in a solution state of being dissolved in a solvent. In a case where a solvent is removed by drying, since the lyotropic liquid crystalline compound can form an organic film with a high alignment degree by transitioning from a liquid crystal phase to a crystal phase, by using the composition containing a lyotropic liquid crystalline compound, a high-contrast and high-performance polarizing plate is obtained.

From the viewpoint that it is easy to control the expression of liquid crystallinity, the lyotropic liquid crystalline compound is preferably water-soluble. The water-soluble lyotropic liquid crystalline compound represents a lyotropic liquid crystalline compound which is dissolved in water in an amount of 1% by mass or more, and a lyotropic liquid crystalline compound which is dissolved in water in an amount of 5% by mass or more is preferable.

The type of the lyotropic liquid crystalline compound in the composition is not particularly limited as long as the above-described light absorption anisotropic layer A can be formed. For example, the dichroic coloring agent may exhibit the lyotropic liquid crystallinity, or the composition may contain a lyotropic liquid crystalline compound different from the dichroic coloring agent. In a case where the composition contains a dichroic coloring agent exhibiting the lyotropic liquid crystallinity, the light absorption anisotropic layer A formed of the composition contains the dichroic coloring agent. In addition, in a case where the composition contains a lyotropic liquid crystalline compound different from the dichroic coloring agent, the light absorption anisotropic layer A formed of the composition contains the dichroic coloring agent and the lyotropic liquid crystalline compound.

The light absorption anisotropic layer A can be formed by applying a composition in which the dichroic coloring agent exhibiting the lyotropic liquid crystallinity is dispersed in water or an organic solvent to form a film, and aligning the composition in a lyotropic liquid crystal phase. In addition, the light absorption anisotropic layer A can also be formed by applying a composition containing the dichroic coloring agent and a lyotropic liquid crystalline compound portion to form a film. Among these, from the viewpoint the light absorption anisotropic layer A according to the embodiment of the present invention can be formed with high productivity, the composition preferably contains a lyotropic liquid crystalline polymer. That is, it is preferable that an aqueous solution of the liquid crystalline polymer exhibits lyotropic liquid crystallinity.

Hereinafter, preferred properties of the dichroic coloring agent in the aspect 1 will be described in detail.

—Dichroic Coloring Agent—

The dichroic coloring agent means a substance having different absorbances depending on directions. In the present invention, in order to obtain a polarizing plate which functions in the infrared region, a dichroic coloring agent having a maximal absorption at a wavelength of 700 to 1500 nm is used.

The dichroic coloring agent may or may not exhibit liquid crystallinity (for example, lyotropic liquid crystallinity). That is, it is preferable that an aqueous solution of the dichroic coloring agent exhibits lyotropic liquid crystallinity.

In a case where the dichroic coloring agent exhibits liquid crystallinity, any of nematic properties or smectic properties may be exhibited.

The dichroic coloring agent preferably has a hydrophilic group.

Examples of the hydrophilic group include an acid group or a salt thereof, an onium base, a hydroxy group or a salt thereof, a sulfonamide group (H₂N—SO₂—), and a polyoxyalkylene group. Among these, an acid group or a salt thereof is preferable.

The onium base is a group derived from an onium salt, and examples thereof include an ammonium base (*—N⁺(R^{Z})₃A⁻), a phosphonium base (*—P⁺(R^{Z})₄A⁻), and a sulfonium base (*—S⁺(R^{Z})₂A⁻). R^{Z}'s each independently represent a hydrogen atom, an alkyl group, an aryl group, or a heteroaryl group. A⁻ represents an anion (for example, a halogen ion). * represents a bonding position.

The salt of the hydroxy group is represented by *—O⁻M⁺, and M⁺ represents a cation and * represents a bonding position. Examples of the cation represented by M⁺ include a cation in a salt of an acid group, which will be described below.

Examples of the polyoxyalkylene group include a group represented by R^{Z}—(O-L^{Z})ₙ-*. R^{Z} is as described above. L^{Z} represents an alkylene group. * represents a bonding position.

Examples of the acid group or a salt thereof include a sulfo group (—SO₃H) or a salt thereof (—SO₃⁻M⁺; M⁺ represents a cation), and a carboxyl group (—COOH) or a salt thereof (—COO⁻M⁺; M⁺ represents a cation), and from the viewpoint that alignment of the dichroic coloring agent in the light absorption anisotropic layer is more excellent, a sulfo group or a salt thereof is preferable.

The above-described salt refers to a salt in which the hydrogen ion of the acid is replaced with another cation such as metal. That is, the salt of an acid group refers to a salt in which the hydrogen ion of the acid group such as a —SO₃H group is replaced with another cation.

Examples of the cation in the salt of an acid group (for example, a cation in the salt of a sulfo group and a cation in the salt of a carboxyl group) include Na⁺, K⁺, Li⁺, Rb+, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, and Zr⁴⁺. Among these, from the viewpoint that the alignment of the dichroic coloring agent in the light absorption anisotropic layer is more excellent, an alkali metal ion is preferable, Na⁺ or Li⁺ is more preferable, and Li⁺ is still more preferable.

The dichroic coloring agent has a maximal absorption wavelength in a wavelength range of 700 to 1500 nm. That is, the dichroic coloring agent is an infrared-absorbing dichroic coloring agent. Examples of the infrared-absorbing dichroic coloring agent include a near-infrared-absorbing dichroic coloring agent.

The type of the dichroic coloring agent (particularly, the near-infrared-absorbing dichroic coloring agent having a hydrophilic group) is not particularly limited, and examples thereof include known materials. Examples of the dichroic coloring agent include a phthalocyanine-based coloring agent having a hydrophilic group, a naphthalocyanine-based coloring agent having a hydrophilic group, a metal complex-based coloring agent having a hydrophilic group, a boron complex-based coloring agent having a hydrophilic group, a cyanine-based coloring agent having a hydrophilic group, an oxonol-based coloring agent having a hydrophilic group, a squarylium-based coloring agent having a hydrophilic group, a rylene-based coloring agent having a hydrophilic group, a diimonium-based coloring agent having a hydrophilic group, a diphenylamines-based coloring agent having a hydrophilic group, a triphenylamines-based coloring agent having a hydrophilic group, a quinone-based coloring agent having a hydrophilic group, and an azo-based coloring agent having a hydrophilic group. In general, these coloring agents extend an absorption wavelength to a long wavelength side by extending the existing rr-conjugated system, and exhibit a wide variety of absorption wavelengths depending on their structure.

The definition of the hydrophilic group included in the coloring agents exemplified above (a phthalocyanine-based coloring agent having a hydrophilic group, a naphthalocyanine-based coloring agent having a hydrophilic group, a metal complex-based coloring agent having a hydrophilic group, a boron complex-based coloring agent having a hydrophilic group, a cyanine-based coloring agent having a hydrophilic group, an oxonol-based coloring agent having a hydrophilic group, a squarylium-based coloring agent having a hydrophilic group, a rylene-based coloring agent having a hydrophilic group, a diimonium-based coloring agent having a hydrophilic group, a diphenylamines-based coloring agent having a hydrophilic group, a triphenylamines-based coloring agent having a hydrophilic group, a quinone-based coloring agent having a hydrophilic group, and an azo-based coloring agent having a hydrophilic group) is as described above.

Next, the lyotropic liquid crystalline polymer will be described in detail.

—Lyotropic Liquid Crystalline Polymer—

The lyotropic liquid crystalline polymer can be aligned in a predetermined direction by applying a shearing force, using an alignment film, or the like, by utilizing the fact that a solution in which the lyotropic liquid crystalline polymer is dissolved in water or an organic solvent at a predetermined concentration exhibits liquid crystallinity.

From the viewpoint that it is easy to control the expression of liquid crystallinity, the lyotropic liquid crystalline polymer is preferably water-soluble. The water-soluble lyotropic liquid crystalline polymer represents a lyotropic liquid crystalline polymer which is dissolved in water in an amount of 1% by mass or more, and a lyotropic liquid crystalline polymer which is dissolved in water in an amount of 5% by mass or more is preferable.

Examples of a specific structure of the lyotropic liquid crystalline polymer include a compound having a structure in which ring structures (an aromatic ring, a non-aromatic ring, and the like) are one-dimensionally connected through a single bond or a divalent linking group. The lyotropic liquid crystalline polymer described above often has a property of aligning there major axes to each other in a solvent.

The lyotropic liquid crystalline polymer preferably has a maximal absorption wavelength in a wavelength range of 300 nm or less. That is, the lyotropic liquid crystalline polymer preferably has a maximal absorption peak in a wavelength range of 300 nm or less.

The maximal absorption wavelength of the above-described lyotropic liquid crystalline polymer means a wavelength at which absorbance is the maximal value in an absorption spectrum of the lyotropic liquid crystalline polymer (measurement range: wavelength range of 230 to 400 nm). In a case where there are a plurality of maximal values in the absorbance of the absorption spectrum of the lyotropic liquid crystalline polymer, a wavelength on the longest wavelength side in the measurement range is selected.

Among these, from the viewpoint that the effect of the present invention is excellent, the lyotropic liquid crystalline polymer preferably has a maximal absorption wavelength in a range of 230 to 300 nm, and more preferably has a maximal absorption wavelength in a range of 250 to 290 nm. As described above, the maximal absorption wavelength of the lyotropic liquid crystalline polymer is preferably located at 250 nm or more.

A measuring method of the above-described maximal absorption wavelength is as follows.

The lyotropic liquid crystalline polymer (5 to 50 mg) is dissolved in pure water (1000 ml), and using a spectrophotometer (MPC-3100 (manufactured by SHIMADZU Corporation)), an absorption spectrum of the obtained solution is measured.

From the viewpoint that the effect of the present invention is more excellent, the lyotropic liquid crystalline polymer preferably has a hydrophilic group.

The lyotropic liquid crystalline polymer may have only one hydrophilic group, or may have a plurality of hydrophilic groups.

Examples of the hydrophilic group include an acid group or a salt thereof, an onium base, a hydroxy group, a sulfonamide group (H₂N—SO₂—), and a polyoxyalkylene group. Among these, an acid group or a salt thereof is preferable.

The acid group or the salt thereof will be described in detail later.

The onium base is a group derived from an onium salt, and examples thereof include an ammonium base (*—N⁺(R^{Z})₃A⁻), a phosphonium base (*—P⁺(R^{Z})₄A⁻), and a sulfonium base (*—S⁺(R^{Z})₂A⁻). R^{Z}'s each independently represent a hydrogen atom, an alkyl group, an aryl group, or a heteroaryl group. A⁻ represents an anion (for example, a halogen ion). * represents a bonding position.

Examples of the polyoxyalkylene group include a group represented by R^{Z}—(O-L^{Z})ₙ-*. R^{Z} is as described above. L^{Z} represents an alkylene group. * represents a bonding position.

Examples of the acid group or a salt thereof include a sulfo group (—SO₃H) or a salt thereof (—SO₃⁻M⁺; M⁺ represents a cation), and a carboxyl group (—COOH) or a salt thereof (—COO⁻M⁺; M⁺ represents a cation), and from the viewpoint that the effect of the present invention is more excellent, a sulfo group or a salt thereof is preferable.

The above-described salt refers to a salt in which the hydrogen ion of the acid is replaced with another cation such as metal. That is, the salt of an acid group refers to a salt in which the hydrogen ion of the acid group such as a —SO₃H group is replaced with another cation. Examples of the cation in the salt of an acid group (for example, a cation in the salt of a sulfo group and a cation in the salt of a carboxyl group) include Na⁺, K⁺, Li⁺, Rb⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, and Zr⁴⁺. Among these, from the viewpoint that the effect of the present invention is more excellent, an alkali metal ion is preferable, K⁺, Na⁺ or Li⁺ is more preferable, and Li⁺ is still more preferable.

From the viewpoint that the effect of the present invention is more excellent, the lyotropic liquid crystalline polymer is preferably a polymer having a repeating unit represented by Formula (X).

R^{x1}-L^{x1}-R^{x2}-L^{x2} (X)

R^{x1} represents a divalent aromatic ring group having a substituent including a hydrophilic group, a divalent non-aromatic ring group having a substituent including a hydrophilic group, or a group represented by Formula (X1). In Formula (X1), * represents a bonding position.

*—R^{x3}-L^{x3}-R^{x4}—* Formula (X1)

R^{x3} and R^{x4} each independently represent a divalent aromatic ring group which may have a substituent including a hydrophilic group or a divalent non-aromatic ring group which may have a substituent including a hydrophilic group, and at least one of R^{x3} or R^{x4} represents a divalent aromatic ring group having a substituent including a hydrophilic group or a divalent non-aromatic ring group having a substituent including a hydrophilic group.

L^{x3} represents a single bond, —O—, —S—, an alkylene group, an alkenylene group, or an alkynylene group.

The divalent aromatic ring group and the divalent non-aromatic ring group represented by R^{x1} have a substituent including a hydrophilic group.

Examples of the hydrophilic group included in the substituent including a hydrophilic group include the above-described groups, and an acid group or a salt thereof is preferable.

The substituent including a hydrophilic group is preferably a group represented by Formula (H). In Formula (H), * represents a bonding position.

R^{H}-L^{H}-* Formula (H)

R^{H} represents a hydrophilic group. The definition of the hydrophilic group is as described above.

L^{H} represents a single bond or a divalent linking group. The divalent linking group is not particularly limited, and examples thereof include a divalent hydrocarbon group (for example, a divalent aliphatic hydrocarbon group such as an alkylene group having 1 to 10 carbon atoms, an alkenylene group having 1 to 10 carbon atoms, or an alkynylene group having 1 to 10 carbon atoms, and a divalent aromatic hydrocarbon group such as an arylene group); a divalent heterocyclic group, —O—, —S—, —NH—, —CO—, and a group obtained by combining these groups (for example, —CO—O—, —O-divalent hydrocarbon group-, —(O-divalent hydrocarbon group)ₘ-O— (m represents an integer of 1 or more), -divalent hydrocarbon group-O—CO—, and the like).

The number of substituents including a hydrophilic group in the divalent aromatic ring group is not particularly limited, but from the viewpoint that the effect of the present invention is more excellent, it is preferably 1 to 3 and more preferably 1.

The number of substituents including a hydrophilic group in the divalent non-aromatic ring group is not particularly limited, but from the viewpoint that the effect of the present invention is more excellent, it is preferably 1 to 3 and more preferably 1.

An aromatic ring constituting the divalent aromatic ring group having the substituent including a hydrophilic group, represented by R^{x1}, may have a monocyclic structure or a polycyclic structure.

Examples of the aromatic ring constituting the above-described divalent aromatic ring group include an aromatic hydrocarbon ring and an aromatic heterocyclic ring. That is, examples of R^{x1} include a divalent aromatic hydrocarbon ring group having the substituent including a hydrophilic group and a divalent aromatic heterocyclic group having the substituent including a substituent.

Examples of the aromatic hydrocarbon ring include a benzene ring and a naphthalene ring.

Examples of a structure of only the divalent aromatic hydrocarbon ring group portion of the divalent aromatic hydrocarbon ring group having the substituent including a hydrophilic group include the following group. * represents a bonding position.

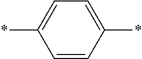 [SMILES: *c1ccc(*)cc1]

Examples of the aromatic heterocyclic ring include a pyridine ring, a thiophene ring, a pyrimidine ring, a thiazole ring, a furan ring, a pyrrole ring, an imidazole ring, and an indole ring.

Examples of a structure of only the divalent aromatic heterocyclic group portion of the divalent aromatic heterocyclic group having the substituent including a hydrophilic group include the following groups. * represents a bonding position.

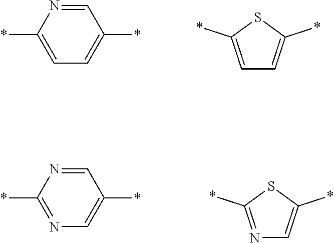 [SMILES: *c1ccc(*)nc1 ; *c1ccc(*)s1 ; *c1cnc(*)nc1 ; *c1cnc(*)s1]

A non-aromatic ring constituting the divalent non-aromatic ring group having the substituent including a hydrophilic group, represented by R^{x1}, may have a monocyclic structure or a polycyclic structure.

Examples of the non-aromatic ring constituting the above-described divalent non-aromatic ring group include an aliphatic ring and a non-aromatic heterocyclic ring, and from the viewpoint that the effect of the present invention is more excellent, an aliphatic ring is preferable, cycloalkane is more preferable, and cyclohexane is still more preferable. That is, examples of R^{x1} include a divalent aliphatic ring group having a substituent including a hydrophilic group and a divalent non-aromatic heterocyclic group having a substituent including a hydrophilic group, and a divalent cycloalkylene group having a substituent including a hydrophilic group is preferable.

The aliphatic ring may be a saturated aliphatic ring or an unsaturated aliphatic ring.

Examples of a structure of only the divalent aliphatic ring group portion of the divalent aliphatic ring group having the substituent including a hydrophilic group include the following groups. * represents a bonding position.

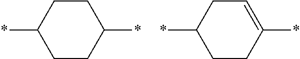

A heteroatom included in the non-aromatic heterocyclic ring is not particularly limited, and examples thereof include an oxygen atom, a nitrogen atom, and a sulfur atom.

The number of heteroatoms included in the non-aromatic heterocyclic ring is not particularly limited, and examples thereof include 1 to 3.

Examples of a structure of only the divalent non-aromatic heterocyclic group portion of the divalent non-aromatic heterocyclic group having the substituent including a hydrophilic group include the following group. * represents a bonding position.

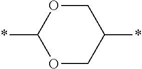 [SMILES: *C1COC(*)OC1]

The divalent aromatic ring group having a substituent including a hydrophilic group and the divalent non-aromatic ring group having a substituent including a hydrophilic group, represented by R^{x1}, may have a substituent other than the substituent including a hydrophilic group.

The substituent is not particularly limited, and examples thereof include an alkyl group, an alkenyl group, an alkynyl group, an aryl group, an amino group, an alkoxy group, an aryloxy group, an aromatic heterocyclic oxy group, an acyl group, an alkoxycarbonyl group, an aryloxycarbonyl group, an acyloxy group, an acylamino group, an alkoxycarbonylamino group, an aryloxycarbonylamino group, an alkylthio group, an arylthio group, an aromatic heterocyclic thio group, a ureido group, a halogen atom, a cyano group, a hydrazino group, a heterocyclic group (for example, a heteroaryl group), a silyl group, and a group obtained by combining there groups. The above-described substituent may be further substituted with a substituent.

R^{x3} and R^{x4} each independently represent a divalent aromatic ring group which may have a substituent including a hydrophilic group or a divalent non-aromatic ring group which may have a substituent including a hydrophilic group, and at least one of R^{x3} or R^{x4} represents a divalent aromatic ring group having a substituent including a hydrophilic group or a divalent non-aromatic ring group having a substituent including a hydrophilic group.

The definition of the substituent including a hydrophilic group, which may be included in the divalent aromatic ring group represented by R^{x3} and R^{x4}, is as described above.

In addition, the definition of the aromatic ring constituting the divalent aromatic ring group, which may have the substituent including a hydrophilic group and is represented by R^{x3} and R^{x4}, is the same as the definition of the aromatic ring constituting the above-described divalent aromatic ring group having the substituent including a hydrophilic group, represented by R^{x1}.

The definition of the substituent including a hydrophilic group, which may be included in the divalent non-aromatic ring group represented by R^{x3} and R^{x4}, is as described above.

In addition, the definition of the non-aromatic ring constituting the divalent non-aromatic ring group, which may have the substituent including a hydrophilic group and is represented by R^{x3} and R^{x4}, is the same as the definition of the non-aromatic ring constituting the above-described divalent non-aromatic ring group having the substituent including a hydrophilic group, represented by R^{x1}.

At least one of R^{x3} or R^{x4} represents a divalent aromatic ring group having a substituent including a hydrophilic group or a divalent non-aromatic ring group having a substituent including a hydrophilic group, and both R^{x3} and R^{x4} may represent the divalent aromatic ring group having a substituent including a hydrophilic group or the divalent non-aromatic ring group having a substituent including a hydrophilic group.

The definition of the divalent aromatic ring group having the substituent including a hydrophilic group, represented by R^{x3} and R^{x4}, has the same meaning as the above-described divalent aromatic ring group having the substituent including a hydrophilic group, represented by R^{x1}.

In addition, the definition of the divalent non-aromatic ring group having the substituent including a hydrophilic group, represented by R^{x3} and R^{x4}, has the same meaning as the above-described divalent non-aromatic ring group having the substituent including a hydrophilic group, represented by R^{x1}.

L^{x3} represents a single bond, —O—, —S—, an alkylene group, an alkenylene group, or an alkynylene group.

The number of carbon atoms in the alkylene group is not particularly limited, but from the viewpoint that the effect of the present invention is more excellent, it is preferably 1 to 3 and more preferably 1.

The number of carbon atoms in the alkenylene group and in the alkenylene group is not particularly limited, but from the viewpoint that the effect of the present invention is more excellent, it is preferably 2 to 5 and more preferably 2 to 4.

R^{x2} represents a divalent non-aromatic ring group or a group represented by Formula (X2). In Formula (X2), * represents a bonding position.

*—Z^{x1}—Z^{x2}—* Formula (X2)

Z^{x1} and Z^{x2} each independently represent a divalent non-aromatic ring group. * represents a bonding position.

A non-aromatic ring constituting the divalent non-aromatic ring group represented by R^{x2} may have a monocyclic structure or a polycyclic structure.

Examples of the non-aromatic ring constituting the above-described divalent non-aromatic ring group include an aliphatic ring and a non-aromatic heterocyclic ring, and from the viewpoint that the effect of the present invention is more excellent, an aliphatic ring is preferable, cycloalkane is more preferable, and cyclohexane is still more preferable. That is, examples of R^{x2} include a divalent aliphatic ring group and a divalent non-aromatic heterocyclic group, and a divalent cycloalkylene group is preferable.

The aliphatic ring may be a saturated aliphatic ring or an unsaturated aliphatic ring.

Examples of the divalent aliphatic ring group include the following groups. * represents a bonding position.

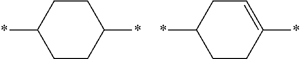

A heteroatom included in the non-aromatic heterocyclic ring is not particularly limited, and examples thereof include an oxygen atom, a nitrogen atom, and a sulfur atom.

The number of heteroatoms included in the non-aromatic heterocyclic ring is not particularly limited, and examples thereof include 1 to 3.

Examples of the divalent non-aromatic heterocyclic group include the following group. * represents a bonding position.

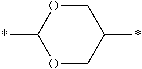 [SMILES: *C1COC(*)OC1]

The divalent non-aromatic ring group may have a substituent. The type of the substituent is not particularly limited, and examples thereof include the groups exemplified by the substituent other than the substituent including a hydrophilic group, which may be included in the divalent aromatic ring group having the substituent including a hydrophilic group or the divalent non-aromatic ring group having the substituent including a hydrophilic group, represented by R^{x1}.

Z^{x1} and Z^{x2} each independently represent a divalent non-aromatic ring group.

The definition of the divalent non-aromatic ring group represented by Z^{x1} and Z^{x2} is the same as the definition of the divalent non-aromatic ring group represented by R^{x2}.

L^{x1} and L^{x2} each independently represent —CONH—, —COO—, —O—, or —S—. Among these, from the viewpoint that the effect of the present invention is more excellent, —CONH— is preferable.

The repeating unit represented by Formula (X) is preferably a repeating unit represented by Formula (X4).

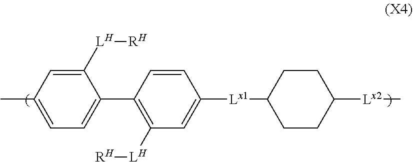

The definition of each group in Formula (X4) is as described above.

A content of the repeating unit represented by Formula (X) included in the polymer having the repeating unit represented by Formula (X) is not particularly limited, but is preferably 60% by mole or more and more preferably 80% by mole or more with respect to all repeating units in the polymer. The upper limit thereof is, for example, 100% by mass.

A molecular weight of the polymer having the repeating unit represented by Formula (X) is not particularly limited, and the number of repeating units represented by Formula (X) in the polymer is preferably 2 or more, more preferably 10 to 100,000, and still more preferably 100 to 10,000.

In addition, a number-average molecular weight of the polymer having the repeating unit represented by Formula (X) is not particularly limited, but is preferably 5,000 to 50,000 and more preferably 10,000 to 30,000.

In addition, a molecular weight distribution of the polymer having the repeating unit represented by Formula (X) is not particularly limited, but is preferably 1 to 12 and more preferably 1 to 7.

Here, the number-average molecular weight and the molecular weight distribution in the present invention are values measured by a gel permeation chromatography (GPC) method.
Solvent (eluent): 20 mM phosphate (pH: 7.0)/acetonitrile=4/1
Device name: TOSOH HLC-8220GPC
Column: using three columns of G6000PWxL, 4500PWxL, and G2500pWwL manufactured by Tosoh Corporation connected with each other
Column temperature: 40° C.
Sample concentration: 2 mg/mL
Flow rate: 1 mL/min Calibration curve: calibration curve using 8 samples up to polystyrene sulfonic acid (PSS) Mp=891, 4200, 10200, 29500, 78400, 152000, 258000, and 462000

—Other Components—

The composition may contain a component other than the lyotropic liquid crystalline polymer and the dichroic coloring agent.

The composition may contain a salt (salt consisting of a cation and an anion). In a case where the dichroic coloring agent has an acid group or a salt thereof, by containing the salt in the composition, the dichroic coloring agents are more likely to associate with each other, and an aggregated having shape anisotropy is likely to be formed.

The above-described salt does not include the lyotropic liquid crystalline polymer and the dichroic coloring agent described above. That is, the above-described salt is a compound different from the lyotropic liquid crystalline polymer and the dichroic coloring agent described above.

The salt is not particularly limited and may be an organic salt or an inorganic salt, but from the viewpoint that the effect of the present invention is more excellent, an inorganic salt is preferable. Examples of the inorganic salt include an alkali metal salt, an alkaline earth metal salt, and a transition metal salt, and from the viewpoint that the effect of the present invention is more excellent, an alkali metal salt is preferable.

The alkali metal salt is a salt in which a cation is an alkali metal ion, and the alkali metal salt is preferably lithium ion or sodium ion, and more preferably lithium ion. That is, as the salt, a lithium salt or a sodium salt is preferable, and a lithium salt is more preferable.

Examples of the alkali metal salt include hydroxides of an alkali metal, such as lithium hydroxide, sodium hydroxide, and potassium hydroxide; carbonates of an alkali metal, such as lithium carbonate, sodium carbonate, and potassium carbonate; and bicarbonates of an alkali metal, such as lithium bicarbonate, sodium bicarbonate, and potassium bicarbonate.

In addition to the above, the alkali metal salt may be, for example, a phosphate or a chloride.

Examples of an anion of the above-described salt include a hydroxide ion, a carbonate ion, a chloride ion, a sulfate ion, a nitrate ion, a phosphate ion, a borate ion, a tetrafluoroborate ion, a hexafluorophosphate ion, a perchlorate ion, a toluenesulfonate ion, an oxalate ion, a formate ion, a trifluoroacetate ion, a trifluoromethanesulfonate ion, a hexafluorophosphate ion, a bis(fluoromethanesulfonyl)imide ion, a bis(pentafluoroethanesulfonyl)imide ion, and a bis(trifluoromethanesulfonyl)imide ion.

In a case where the dichroic coloring agent has a salt of an acid group, it is preferable that the cation in the salt of an acid group and the cation in the salt used are of the same type.

The composition may contain a hydrophilic solvent. Examples of the hydrophilic solvent include water and a polar solvent such as alcohol and dimethyl formamide. Among these, a polar solvent is preferable, and water or alcohol is more preferable.

In addition to the above, examples of an additive which may be contained in the composition include a polymerizable compound, a polymerization initiator, a wavelength dispersion control agent, an optical properties modifier, a surfactant, an adhesion improver, a slipping agent, an alignment control agent, and an ultraviolet absorbing agent.

(Formulation of Composition)

The composition preferably contains the lyotropic liquid crystalline compound and the dichroic coloring agent.

In a case where the composition contains the lyotropic liquid crystalline compound, the composition corresponds to a lyotropic liquid crystalline composition.

Here, the lyotropic liquid crystalline composition is a composition having a property of causing a phase transition between an isotropic phase and a liquid crystal phase by changing a temperature or a concentration in a solution state. That is, the composition is a composition capable of exhibiting lyotropic liquid crystallinity by adjusting the concentration of each compound, or the like in a solution state containing various components such as the lyotropic liquid crystalline polymer, the dichroic coloring agent, and the solvent. Even in a case where the composition contains an excess solvent and does not exhibit lyotropic liquid crystallinity in that state, the composition corresponds to the above-described lyotropic liquid crystalline composition in a case where the lyotropic liquid crystallinity is exhibited upon changes in the concentration, such as a case where the lyotropic liquid crystallinity is exhibited in a drying step after application of the composition.

A content of the lyotropic liquid crystalline compound in the composition is not particularly limited, but is preferably 60% to 100% by mass and more preferably 80% to 99% by mass with respect to the total solid content in the composition.

The total solid content means components which can form the light absorption anisotropic layer A, excluding the solvent. In a case where the property of the above-described component is in a liquid state, the compound forming the light absorption anisotropic layer A is counted as the solid content.

In a case where the composition contains the lyotropic liquid crystalline polymer and the dichroic coloring agent, a content of the dichroic coloring agent with respect to the total mass of the lyotropic liquid crystalline polymer and the dichroic coloring agent is preferably 80% by mass or less and more preferably 50% by mass or less. With the content, since the aligned lyotropic liquid crystalline polymer acts as a host and the dichroic coloring agent is aligned in an alignment direction of the polymer, the light absorption anisotropic layer A with a high alignment degree is obtained.

In addition, the content of the dichroic coloring agent with respect to the total mass of the lyotropic liquid crystalline polymer and the dichroic coloring agent is preferably 1% by mass or more and more preferably 5% by mass or more. With this content, the dichroic coloring agent can form an aggregate, and a high alignment degree can be obtained.

In addition, in a case where the composition contains the lyotropic liquid crystalline polymer and the dichroic coloring agent, a content of the dichroic coloring agent is preferably 1% to 50% by mass with respect to a content of the lyotropic liquid crystalline compound.

The composition may contain one kind of the lyotropic liquid crystalline polymer, or may contain two or more kinds of the lyotropic liquid crystalline polymers. In a case of containing two or more kinds of the lyotropic liquid crystalline polymers, the above-described content of the lyotropic liquid crystalline polymer means the total content of the lyotropic liquid crystalline polymers.

The composition may contain one kind of the dichroic coloring agent, or may contain two or more kinds of the dichroic coloring agents. In a case of containing two or more kinds of the dichroic coloring agents, a wavelength range which functions as the polarizing plate is expanded and a wider band polarizing plate can be obtained, which is more preferable. In a case of containing two or more kinds of the dichroic coloring agents, the above-described content of the dichroic coloring agent means the total content of the dichroic coloring agents.

The composition may contain a dichroic coloring agent having a maximal absorption at 400 to 700 nm, different from the above-described dichroic coloring agent. By containing the dichroic coloring agent having a maximal absorption at 400 to 700 nm, a polarizing plate which functions even in the visible light region can be obtained.

As described above, the composition may contain a solvent.

A concentration of solid contents of the composition is not particularly limited, but from the viewpoint that the effect of the present invention is excellent, it is preferably 1% to 50% by mass and more preferably 3% to 30% by mass with respect to the total mass of the composition.

As described above, the composition is preferably a lyotropic liquid crystalline composition. In a case where the composition is a lyotropic liquid crystalline composition, the composition may be an aspect that contains a predetermined amount of a solvent and exhibits lyotropic liquid crystallinity (a state in which lyotropic liquid crystallinity is expressed), or may be a composition that contains an excessive amount of a solvent and does not exhibit lyotropic liquid crystallinity in that state (exhibits an isotropic phase), but exhibits lyotropic liquid crystallinity during the formation of a coating film due to volatilization of the solvent in a case where the light absorption anisotropic layer A is formed.

As will be described later, in a case where an alignment film is disposed on a support, the lyotropic liquid crystallinity is expressed in the drying process after the application of the composition, thereby inducing the alignment of the compound and making it possible to form the light absorption anisotropic layer A.

—Preparation of Coloring Agent Dispersion Liquid—

In a case of preparing the above-described composition, the dichroic coloring agent may be formed into a coloring agent dispersion liquid and the composition may be prepared using the coloring agent dispersion liquid.

The coloring agent dispersion liquid can be prepared by mixing the above-described components. In preparing the coloring agent dispersion liquid, the respective components may be formulated at once, or each component may be dissolved or dispersed in a solvent and then sequentially formulated. In addition, during formulation, the order of addition or working conditions are not particularly limited. For example, all the components may be dissolved or dispersed in a solvent at the same time to prepare the coloring agent dispersion liquid.

It is preferable that the preparation of the coloring agent dispersion liquid includes a process of dispersing the coloring agent. In the process of dispersing the coloring agent, examples of a mechanical force which is used for dispersing the coloring agent include compression, pressing, impact, shear, and cavitation. Specific examples of these processes include a beads mill, a sand mill, a roll mill, a ball mill, a paint shaker, a microfluidizer, a high-speed impeller, a sand grinder, a flow jet mixer, high-pressure wet atomization, and ultrasonic dispersion. In addition, as the process and the dispersing machine for dispersing the coloring agent, the process and the dispersing machine described in “Dispersion Technology Comprehension, published by Johokiko Co., Ltd., Jul. 15, 2005”, “Actual comprehensive data collection on dispersion technology and industrial application centered on suspension (solid/liquid dispersion system), published by Publication Department, Management Development Center, Oct. 10, 1978”, and paragraph No. 0022 of JP2015-157893A can be suitably used.

The dichroic coloring agent in the composition may be in a form of particles.

In a case where the composition contains particles composed of the dichroic coloring agent, an average particle diameter of the particles is not particularly limited, but from the viewpoint that the alignment degree of the dichroic coloring agent is more excellent, it is preferably 10 to 1000 nm, more preferably 10 to 500 nm, and still more preferably 10 to 200 nm.

<Manufacturing Method of Light Absorption Anisotropic Layer A>

A manufacturing method of the light absorption anisotropic layer A according to the embodiment of the present invention will be described. Hereinafter, a method for manufacturing the light absorption anisotropic layer A using the above-described composition will be described. As such a manufacturing method, for example, a method of forming the light absorption anisotropic layer A by applying the above-described composition and aligning the lyotropic liquid crystalline compound (for example, the lyotropic liquid crystalline polymer and the dichroic coloring agent) in the coating film is preferable.

Hereinafter, the procedure of the above-described method will be described in detail.

First, the composition is applied. Usually, the composition is often applied onto a support.

The support to be used is a member having a function as a base material to which the composition is applied. The support may be a so-called temporary support.

Examples of the support (temporary support) include a plastic substrate and a glass substrate. Examples of a material constituting the plastic substrate include a polyester resin such as polyethylene terephthalate, a polycarbonate resin, a (meth)acrylic resin, an epoxy resin, a polyurethane resin, a polyamide resin, a polyolefin resin, a cellulose resin, a silicone resin, and a polyvinyl alcohol.

A thickness of the support may be approximately 5 to 1000 μm, and is preferably 10 to 250 μm and more preferably 15 to 90 μm.

For the purpose of imparting application suitability, controlling adhesiveness, and the like, the support may be subjected to a surface treatment. Examples of a method for the surface treatment include physical treatments such as sputtering, sandblasting, plasma treatment, and corona treatment, application of a surface modifier such as a silane coupling agent, and saponification treatment with alkali.

As necessary, an alignment film may be disposed on the support.

The alignment film generally contains a polymer as a main component. The polymer for the alignment film is described in a large number of documents, and a large number of commercially available polymer products are available. The polymer for the alignment film is preferably a polyvinyl alcohol, a polyimide, a derivative thereof, an azo derivative, or a cinnamoyl derivative.

It is preferable that the alignment film is subjected to a known rubbing treatment.

In addition, a photo-alignment film may be used as the alignment film.

A thickness of the alignment film is preferably 0.01 to 10 μm and more preferably 0.01 to 1 μm.

The application method may be, for example, a known method, examples thereof include a curtain coating method, an extrusion coating method, a roll coating method, a dip coating method, a spin coating method, a print coating method, a spray coating method, and a slide coating method.

In addition, in a case where an application method in which a shearing force is applied is adopted, two treatments of compound alignment and application can be carried out at the same time.

In addition, the lyotropic liquid crystalline compound may be continuously aligned at the same time as the continuous application. Examples of the continuous application include a curtain coating method, an extrusion coating method, a roll coating method, and a slide coating method. A die coater, a blade coater, or a bar coater is preferably used as a specific application unit.

As a unit for aligning the lyotropic liquid crystalline compound (for example, the lyotropic liquid crystalline polymer and the plate-like compound) in the coating film, a method of applying the shearing force as described above is suitably used.

As necessary, the coating film formed on the support may be subjected to a heating treatment.

Conditions in a case of heating the coating film are not particularly limited, and the heating temperature is preferably 50° C. to 250° C., and the heating time is preferably 10 seconds to 10 minutes.

In addition, after heating the coating film, the coating film may be cooled as necessary. The cooling temperature is preferably 20° C. to 200° C. and more preferably 20° C. to 150° C.

Examples of another unit for aligning the lyotropic liquid crystalline compound in the coating film include a method of using an alignment film as described above.

An alignment direction can be controlled by subjecting the alignment film to an alignment treatment in advance in a predetermined direction. In particular, the method of using an alignment film is preferable in a case where continuous application is carried out using a roll-like support so that the compound is aligned in a direction oblique to a transport direction.

In the method of using an alignment film, a concentration of the solvent in the composition used is not particularly limited, and may be a concentration such that the composition exhibits lyotropic liquid crystallinity, or may be a concentration equal to or lower than the concentration. In a case where the composition is a lyotropic liquid crystalline composition, even in a case where the concentration of the solvent in the composition is high (a case where the composition itself exhibits an isotropic phase), in the drying process after the application of the composition, lyotropic liquid crystallinity is expressed, which induces alignment of the compound on the alignment film, so that the light absorption anisotropic layer A can be formed.

After forming the light absorption anisotropic layer A, a treatment of fixing an alignment state of the lyotropic liquid crystalline compound may be performed as necessary.

A method of fixing an alignment state of the lyotropic liquid crystalline compound is not particularly limited, and examples thereof include a method of heating and then cooling a coating film as described above.

In addition, in a case where the lyotropic liquid crystalline compound has an acid group or a salt thereof, examples of a method of fixing an alignment state of the lyotropic liquid crystalline compound include a method of bringing a solution containing a polyvalent metal ion into contact with the formed coating film. By bringing the solution containing a polyvalent metal ion into contact with the formed coating film, the polyvalent metal ion is supplied into the coating film. The polyvalent metal ion supplied into the coating film serves as a crosslinking point between the acid groups or the salts thereof contained in the lyotropic liquid crystalline compound, a crosslinking structure is formed in the coating film, and the alignment state of the lyotropic liquid crystalline compound is fixed.

The type of the polyvalent metal ion used is not particularly limited, but from the viewpoint that the alignment state of the lyotropic liquid crystalline compound is easily fixed, an alkaline earth metal ion is preferable, and a calcium ion is more preferable.

<Preferred Aspect 2>

Hereinafter, a preferred method (preferred aspect 2) for forming the light absorption anisotropic layer A will be described.

Examples of a technique of desirably aligning the dichroic coloring agent include a technique of producing a polarizer using the dichroic coloring agent and a technique of producing a guest-host liquid crystal cell. For example, techniques used in the method of producing a dichroic polarizer, described in JP1999-305036A (JP-H11-305036A) and JP2002-090526A, and the method of producing a guest-host type liquid crystal display device, described in JP2002-099388A and JP2016-027387A, can be used for the production of the light absorption anisotropic layer A used in the present invention.

For example, molecules of the dichroic coloring agent can be desirably aligned as described above in association with an alignment of host liquid crystals using the technique of the guest-host type liquid crystal cell. Specifically, the light absorption anisotropic layer A used in the present invention can be produced by mixing the dichroic coloring agent serving as a guest and a liquid crystalline compound (for example, a thermotropic liquid crystalline compound) serving as a host liquid crystal, aligning the host liquid crystal, aligning molecules of the dichroic coloring agent along the alignment of the liquid crystal molecules, and fixing the alignment state.

In order to prevent fluctuation of light absorption characteristics of the light absorption anisotropic layer A used in the present invention depending on the use environment, it is preferable that the alignment of the dichroic coloring agent is fixed by forming a chemical bond. For example, the alignment can be fixed by promoting the polymerization of the host liquid crystal, the dichroic coloring agent, or a polymerizable component to be added as desired.

In the preferred aspect 2, it is preferable that the light absorption anisotropic layer A is formed of a composition containing a liquid crystalline compound (for example, a thermotropic liquid crystalline compound) and a dichroic coloring agent (for example, a water-insoluble dichroic coloring agent). The light absorption anisotropic layer A formed of the above-described composition contains the liquid crystalline compound (for example, the thermotropic liquid crystalline compound) and the dichroic coloring agent (for example, the water-insoluble dichroic coloring agent).

Hereinafter, the water-insoluble dichroic coloring agent and the thermotropic liquid crystalline compound will be described.

(Water-Insoluble Dichroic Coloring Agent)

In a case where a dichroic coloring agent having a maximal absorption at a wavelength of 700 to 1500 nm, which is used in the present invention, is used in combination with a thermotropic liquid crystalline compound to produce the light absorption anisotropic layer A, a water-insoluble dichroic coloring agent is preferably used as the dichroic coloring agent.

The dichroic coloring agent may or may not exhibit liquid crystallinity (for example, thermotropic liquid crystallinity).

The dichroic coloring agent is not particularly limited as long as the maximal absorption wavelength is in a range of 700 to 1500 nm, and preferred examples thereof include cyanine, anthraquinone, azo, squarylium, pyrrolopyrrole, phthalocyanine, oxonol, perylene, diimmonium, and croconium. Particularly preferred examples thereof include cyanine, anthraquinone, azo, squarylium, pyrrolopyrrole, and phthalocyanine. Among these, pyrrolopyrrole is preferable. In addition, examples of the dichroic coloring agent also include coloring agents described in “Functional Coloring Agents”, co-authored by Shin Okawara, Ken Matsuoka, Tsuneaki Hirashima, and Eijiro Kitao, Kodansha Ltd., 1992, supervised by Sumio Tokita, and “Electronics-related Materials”, CMC Publishing Co., Ltd., 1998.

The cyanine exemplified as the above-described dichroic coloring agent denotes a cyanine-based coloring agent. The same applies to other coloring agents. Hereinafter, for example, the cyanine-based coloring agent will also be simply referred to as “cyanine”.

(Cyanine)

Specific examples of the cyanine used in the present invention are shown below. However, the cyanine used in the present invention is not limited thereto.

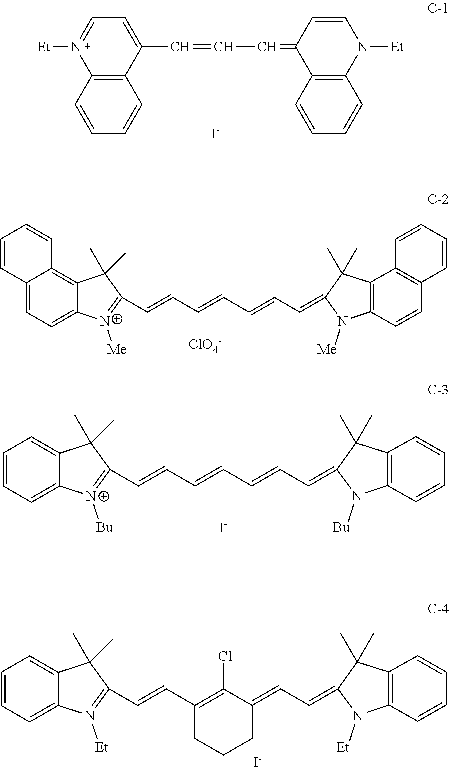

(Anthraquinone)

Specific examples of the cyanine used in the present invention are shown below. However, the anthraquinone used in the present invention is not limited thereto.

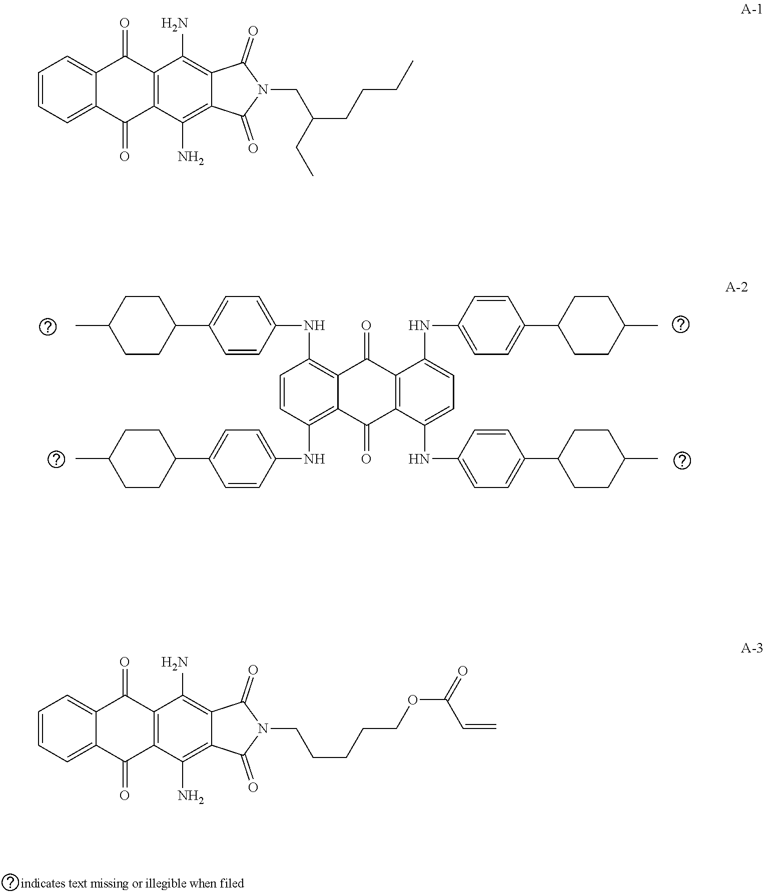

(Azo)

Specific examples of the azo used in the present invention are shown below. However, the azo used in the present invention is not limited thereto.

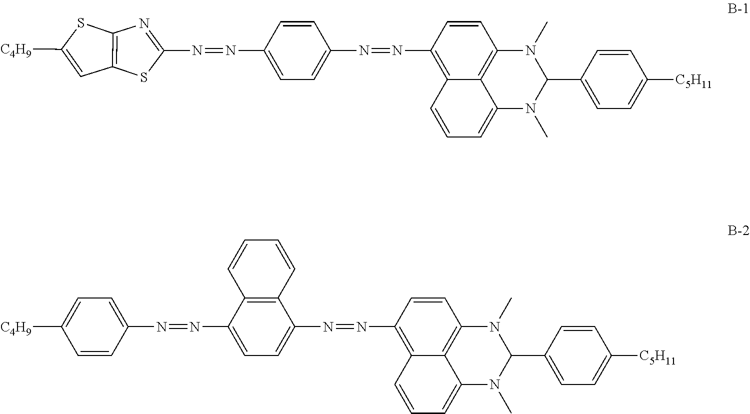

(Squarylium)

Specific examples of the squarylium used in the present invention are shown below. However, the squarylium used in the present invention is not limited thereto.

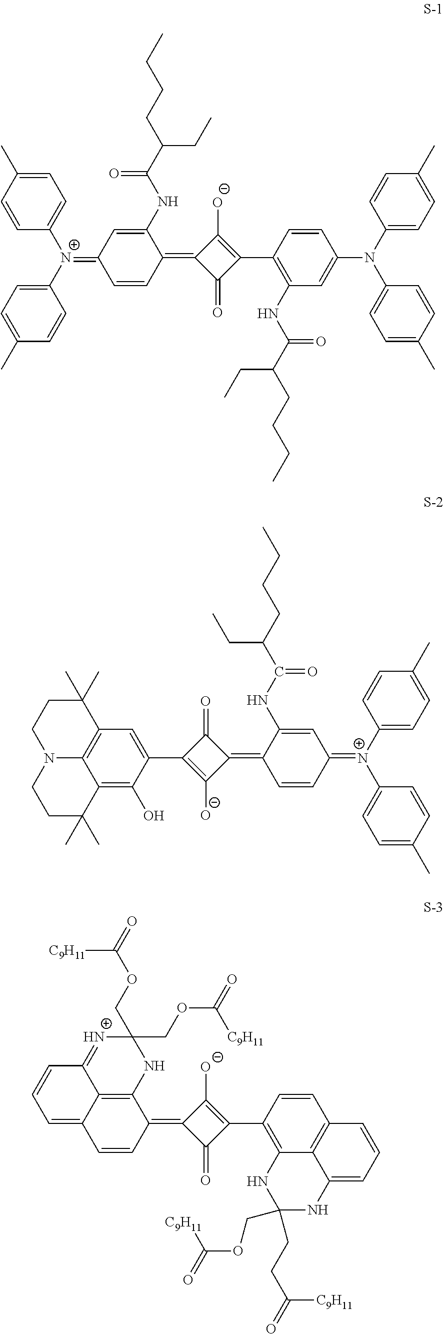

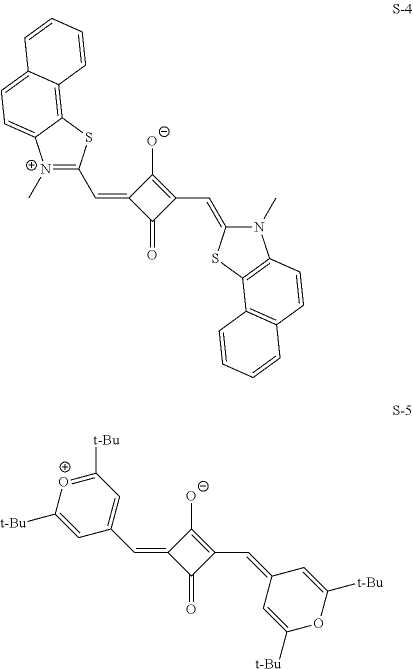 [SMILES: CN1/C(=C/C2=C([O-])C(=C\c3sc4c5ccccc5ccc4[n+]3C)/C2=O)Sc2c1ccc1ccccc21 ; CC(C)(C)C1=CC(=CC2=C([O-])/C(=C\c3cc(C(C)(C)C)[o+]c(C(C)(C)C)c3)C2=O)C=C(C(C)(C)C)O1]

(Pyrrolopyrrole)

Specific examples of the pyrrolopyrrole used in the present invention are shown below. However, the pyrrolopyrrole used in the present invention is not limited thereto.

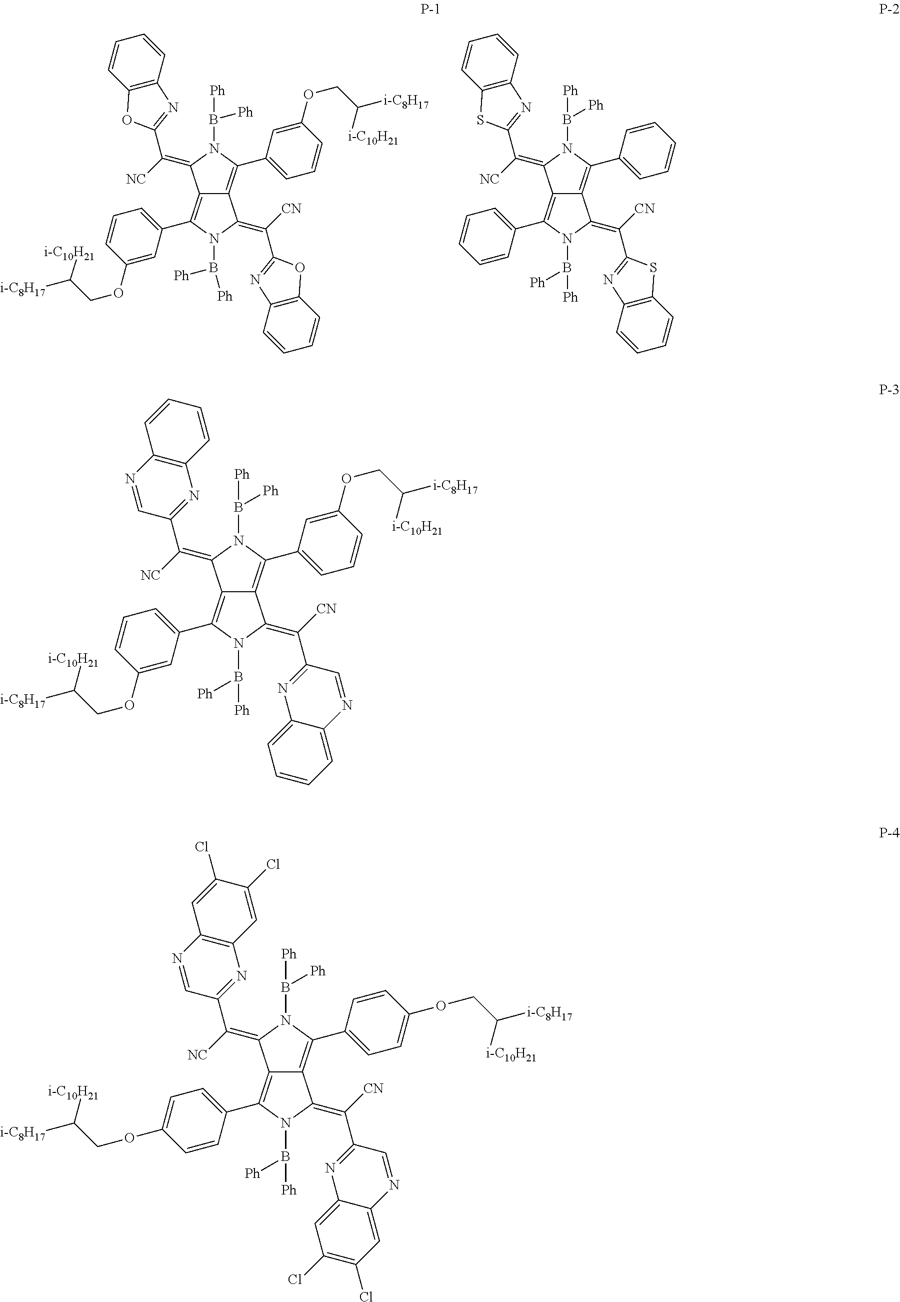

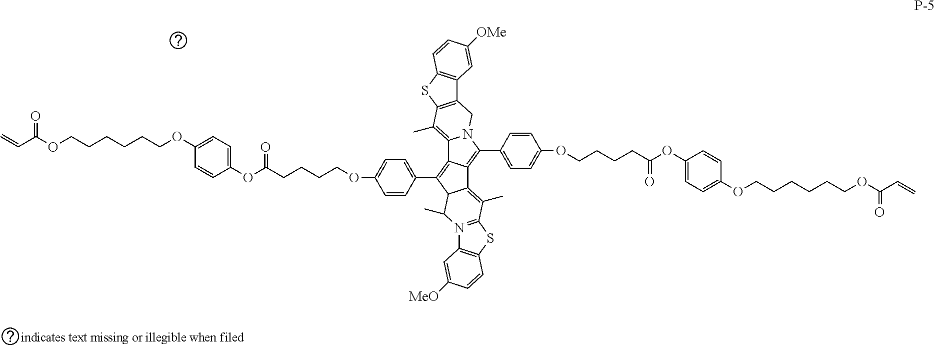

(Phthalocyanine)

Specific examples of the phthalocyanine used in the present invention are shown below. However, the present invention is not limited thereto.

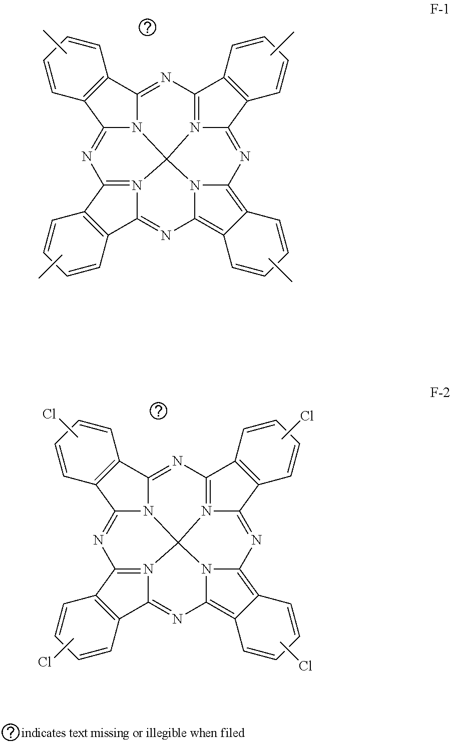

As the dichroic coloring agent, a dichroic coloring agent having an absorption axis which is not parallel to an alignment axis of the liquid crystal can also be used. By using the above-described coloring agent, for example, in a case where the coloring agent is used in combination with a dichroic coloring agent having another maximal wavelength in the same layer, it is possible to make a design in which the direction of the absorption axis is intentionally changed depending on the wavelength. Specific examples of the dichroic coloring agent having an absorption axis which is not parallel to an alignment axis of the liquid crystal are shown below, but the dichroic coloring agent used in the present invention is not limited thereto.

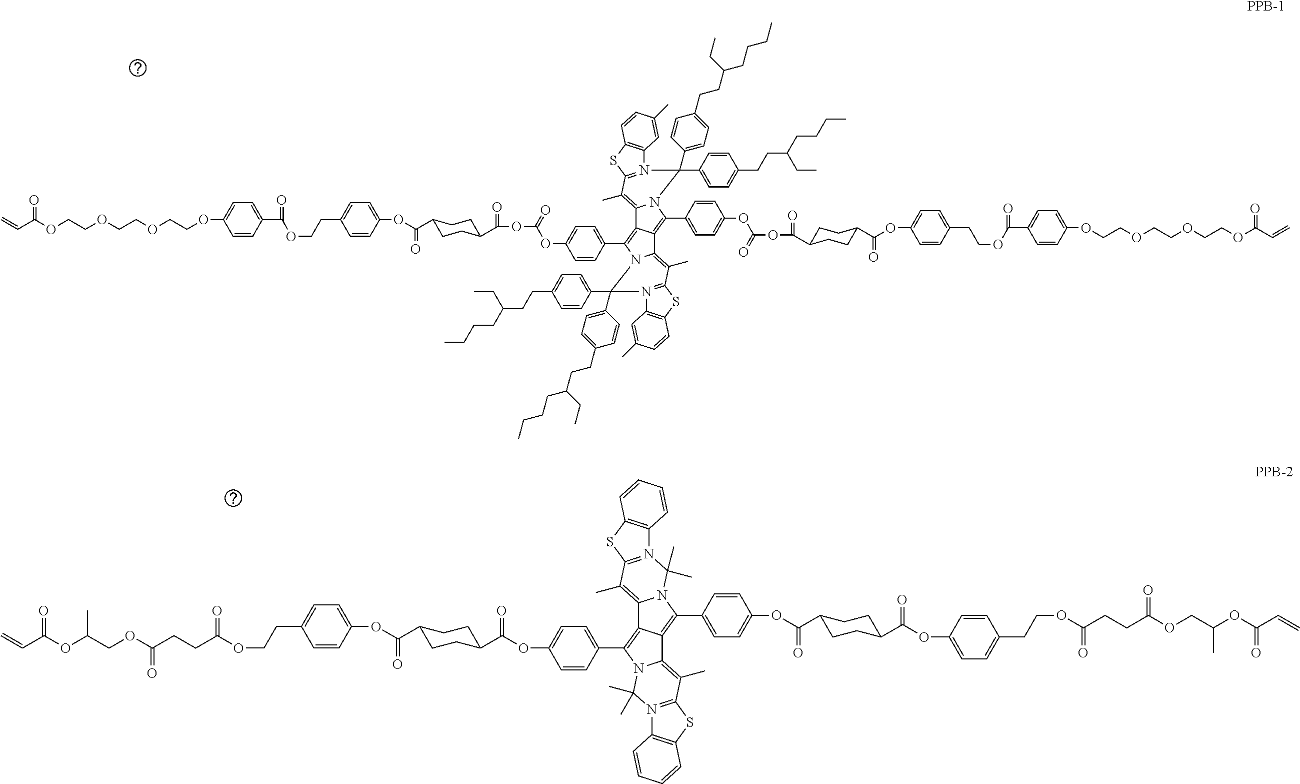

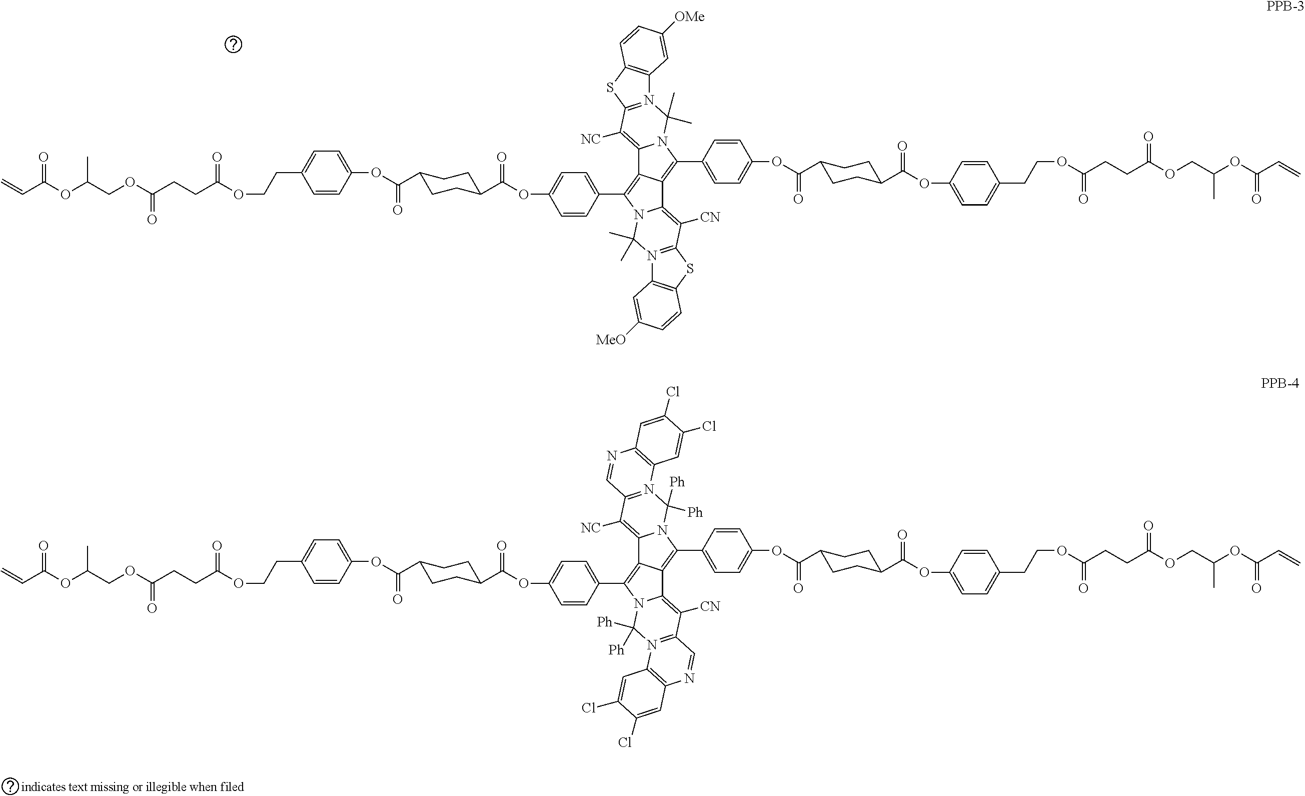

Since the dichroic coloring agent corresponds to a wide infrared wavelength region, it is also preferable to use two or more kinds of coloring agents having different maximal absorption wavelengths in combination. An amount of the dichroic coloring agent used is preferably 3% to 40% by mass and more preferably 5% to 35% by mass with respect to the total weight of the liquid crystalline compound.

(Thermotropic Liquid Crystalline Compound)

The composition used for forming the light absorption anisotropic layer A preferably contains a liquid crystalline compound (preferably, a thermotropic liquid crystalline compound). In a case where the composition contains a liquid crystalline compound (preferably, a thermotropic liquid crystalline compound), the dichroic coloring agent can be aligned with a high alignment degree while suppressing precipitation of the dichroic coloring agent.

The liquid crystalline compound is a liquid crystalline compound which does not exhibit dichroism, and is a compound different from the above-described dichroic coloring agent. In a case where the composition contains the liquid crystalline compound (preferably, the thermotropic liquid crystalline compound), the light absorption anisotropic layer A contains the liquid crystalline compound.

A thermotropic liquid crystal is a liquid crystal which shows transition to a liquid crystal phase due to a change in temperature.

The thermotropic liquid crystal may exhibit any of a nematic phase or a smectic phase, but from the viewpoint that the alignment degree of the light absorption anisotropic layer A is further increased and haze is unlikely to be observed (haze is better), it is preferable that the thermotropic liquid crystal exhibits at least a nematic phase.

A temperature range showing the nematic phase is preferably room temperature (23° C.) to 450° C. from the viewpoint that the alignment degree of the light absorption anisotropic layer A is further increased and the haze is unlikely to be observed, and more preferably 40° C. to 400° C. from the viewpoint of handleability and manufacturing suitability.

Generally, the liquid crystalline compound can be classified into a rod-like type (rod-like liquid crystalline compound) and a disk-like type (disk-like liquid crystalline compound) depending on the shape thereof.

As the rod-like liquid crystalline compound, a liquid crystalline compound which does not exhibit dichroism in the visible light region is preferable.

As the rod-like liquid crystalline compound, both a low-molecular-weight liquid crystalline compound and a high-molecular-weight liquid crystalline compound can be used, but from the viewpoint of increasing the alignment degree of the dichroic coloring agent, a high-molecular-weight liquid crystal is preferable. Here, the “low-molecular-weight liquid crystalline compound” refers to a liquid crystalline compound having no repeating unit in the chemical structure. In addition, the “high-molecular-weight liquid crystalline compound” refers to a liquid crystalline compound having a repeating unit in the chemical structure.

Examples of the low-molecular-weight liquid crystalline compound include liquid crystalline compounds described in JP2013-228706A.

Examples of the high-molecular-weight liquid crystalline compound include thermotropic liquid crystalline polymers described in JP2011-237513A. In addition, the high-molecular-weight liquid crystalline compound may contain a crosslinkable group (such as an acryloyl group and a methacryloyl group) at a terminal.

The rod-like liquid crystalline compound may be used alone or in combination of two or more kinds thereof.

From the viewpoint that the effect of the present invention is more excellent, the rod-like liquid crystalline compound preferably includes the high-molecular-weight liquid crystalline compound, and particularly preferably includes both the high-molecular-weight liquid crystalline compound and the low-molecular-weight liquid crystalline compound.

It is preferable that the rod-like liquid crystalline compound includes a liquid crystalline compound represented by Formula (LC), or a polymer thereof. The liquid crystalline compound represented by Formula (LC) or the polymer thereof is a compound exhibiting liquid crystallinity. The liquid crystal phase exhibited by the rod-like liquid crystalline compound may be a nematic phase or a smectic phase, or the rod-like liquid crystalline compound may exhibit both the nematic phase and the smectic phase, and it is preferable to exhibit at least the nematic phase.

The smectic phase may be a high-order smectic phase. The high-order smectic phase here denotes a smectic B phase, a smectic D phase, a smectic E phase, a smectic F phase, a smectic G phase, a smectic H phase, a smectic I phase, a smectic J phase, a smectic K phase, or a smectic L phase. Among these, a smectic B phase, a smectic F phase, or a smectic I phase is preferable.

In a case where the smectic liquid crystal phase exhibited by the liquid crystalline compound is any of these high-order smectic liquid crystal phases, the light absorption anisotropic layer A with a higher alignment degree order can be produced. In addition, the light absorption anisotropic layer A with a high alignment degree order, produced from such a high-order smectic liquid crystal phase, is a layer in which a Bragg peak (peak derived from Bragg reflection) derived from a high-order structure such as a hexatic phase or a crystal phase in X-ray diffraction measurement is obtained. The above-described Bragg peak is a peak derived from a surface periodic structure of molecular alignment, and a light absorption anisotropic layer A having a periodic interval of 3.0 to 5.0 Å is preferable.

Q1-S1-MG-S2-Q2 (LC)

In Formula (LC), Q1 and Q2 each independently represent a hydrogen atom, a halogen atom, a linear, branched, or cyclic alkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group (also referred to as a hetero ring group), a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—B(OH)₂), a phosphate group (—OPO(OH)₂), a sulfate group (—OSO₃H), or a crosslinkable group represented by any of Formulae (P-1) to (P-30), and it is preferable that at least one of Q1 or Q2 represents a crosslinkable group represented by any of the following formulae.

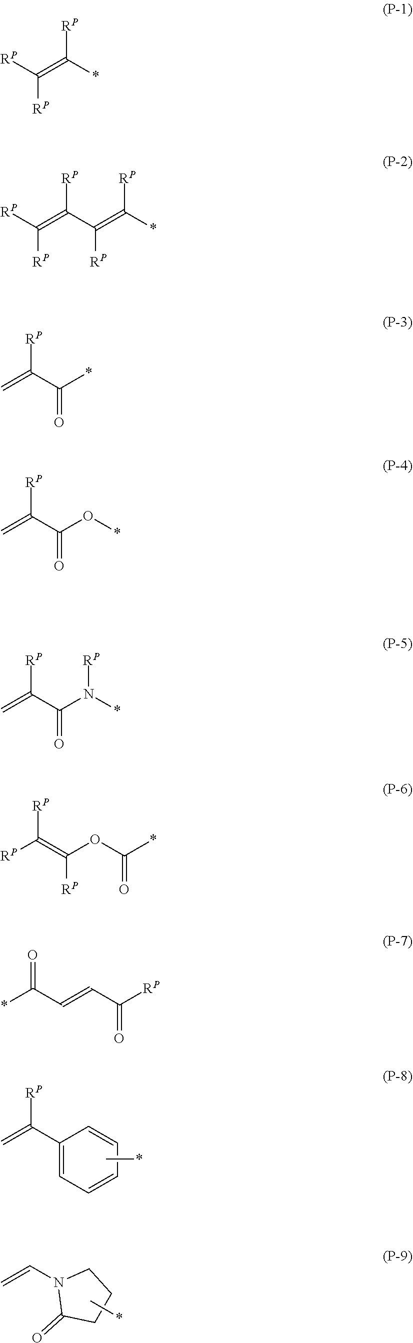

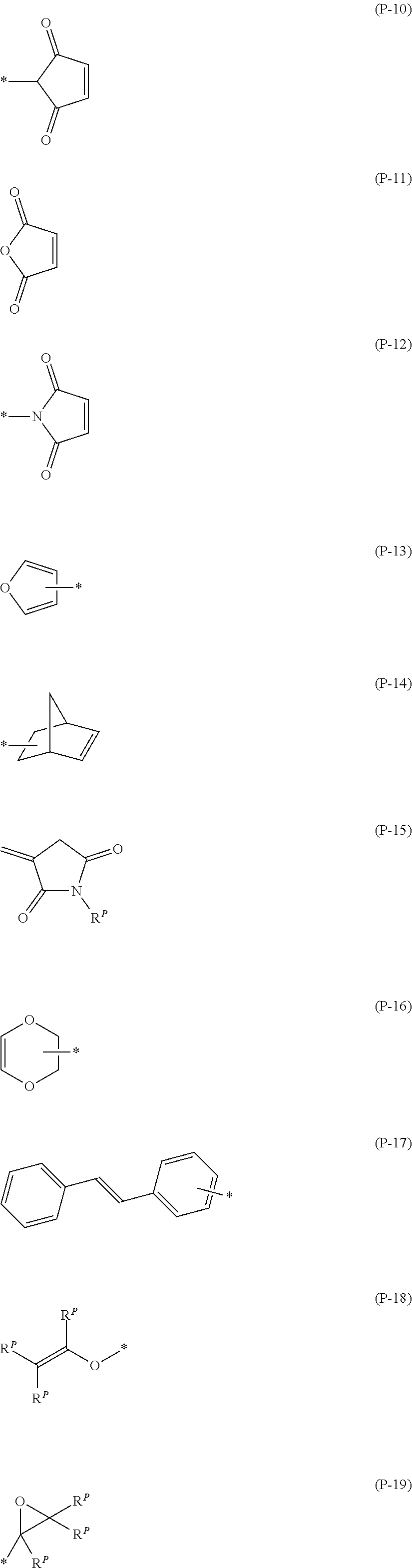

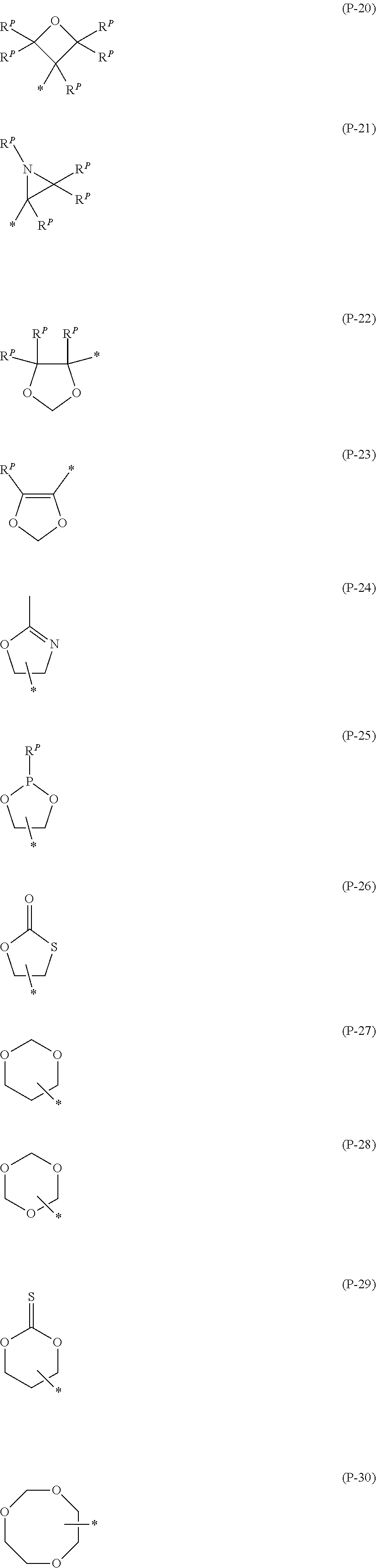

In Formulae (P-1) to (P-30), R^{P} represents a hydrogen atom, a halogen atom, a linear, branched, or cyclic alkyl group having 1 to 10 carbon atoms, a halogenated alkyl group having 1 to 20 carbon atoms, an alkoxy group having 1 to 20 carbon atoms, an alkenyl group having 1 to 20 carbon atoms, an alkynyl group having 1 to 20 carbon atoms, an aryl group having 1 to 20 carbon atoms, a heterocyclic group, a cyano group, a hydroxy group, a nitro group, a carboxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryl oxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a phosphono group, a silyl group, a hydrazino group, a ureido group, a boronic acid group (—N(OH)₂), a phosphate group (—OPO(OH)₂), or a sulfate group (—OSO₃H), and a plurality of R^{P}'s may be the same or different from each other.

Examples of a preferred aspect of the crosslinkable group include a radically polymerizable group and a cationically polymerizable group. As the radically polymerizable group, a vinyl group represented by Formula (P-1), a butadiene group represented by Formula (P-2), a (meth)acryloyl group represented by Formula (P-4), a (meth)acrylamide group represented by Formula (P-5), a vinyl acetate group represented by Formula (P-6), a fumaric acid ester group represented by Formula (P-7), a styryl group represented by Formula (P-8), a vinylpyrrolidone group represented by Formula (P-9), a maleic acid anhydride represented by Formula (P-11), or a maleimide group represented by Formula (P-12) is preferable. As the cationically polymerizable group, a vinyl ether group represented by Formula (P-18), an epoxy group represented by Formula (P-19), or an oxetanyl group represented by Formula (P-20) is preferable.

In Formula (LC), S1 and S2 each independently represent a divalent spacer group, and suitable aspects of S1 and S2 include the same structures as those for SPW in Formula (W1), and thus the description thereof will not be repeated.

In Formula (LC), MG represents a mesogen group described below. The mesogen group represented by MG is a group representing a main skeleton of a liquid crystal molecule which contributes to liquid crystal formation. A liquid crystal molecule exhibits liquid crystallinity which is in an intermediate state (mesophase) between a crystal state and an isotropic liquid state. The mesogen group is not particularly limited, and for example, particularly description on pages 7 to 16 of “Flussige Kristalle in Tabellen II” (VEB Deutsche Verlag fur Grundstoff Industrie, Leipzig, 1984) and particularly description in Chapter 3 of “Liquid Crystal Handbook” (Maruzen, 2000) edited by Liquid Crystal Handbook Editing Committee can be referred to.

The mesogen group represented by MG preferably has 2 to 10 cyclic structures and more preferably has 3 to 7 cyclic structures.

Specific examples of the cyclic structure include an aromatic hydrocarbon group, a heterocyclic group, and an alicyclic group.

As the mesogen group represented by MG, from the viewpoint of expressing the liquid crystallinity, adjusting a liquid crystal phase transition temperature, availability of raw materials, and synthetic suitability, and from the viewpoint that the effect of the present invention is more excellent, a group represented by Formula (MG-A) or Formula (MG-B) is preferable, and a group represented by Formula (MG-B) is more preferable.

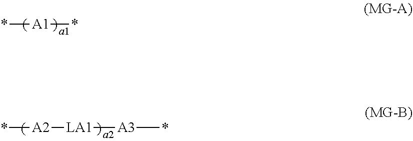

In Formula (MG-A), A1 represents a divalent group selected from the group consisting of an aromatic hydrocarbon group, a heterocyclic group, and an alicyclic group. These groups may be substituted with a substituent such as the substituent W.

It is preferable that the divalent group represented by A1 is a 4- to 15-membered ring. In addition, the divalent group represented by A1 may be a monocyclic ring or a fused ring.

In addition, * represents a bonding position to S1 or S2.

Examples of the divalent aromatic hydrocarbon group represented by A1 include a phenylene group, a naphthylene group, a fluorene-diyl group, an anthracene-diyl group, and a tetracene-diyl group. From the viewpoint of design diversity of the mesogenic skeleton and the availability of raw materials, a phenylene group or a naphthylene group is preferable.

The divalent heterocyclic group represented by A1 may be any of aromatic or non-aromatic, but from the viewpoint of further improving the alignment degree, a divalent aromatic heterocyclic group is preferable.

Examples of atoms other than carbon, constituting the divalent aromatic heterocyclic group, include a nitrogen atom, a sulfur atom, and an oxygen atom. In a case where the aromatic heterocyclic group has a plurality of atoms other than carbon, constituting a ring, these atoms may be the same or different from each other.

Specific examples of the divalent aromatic heterocyclic group include a pyridylene group (pyridine-diyl group), a pyridazine-diyl group, an imidazole-diyl group, a thienylene group (thiophene-diyl group), a quinolylene group (quinoline-diyl group), an isoquinolylene group (isoquinoline-diyl group), an oxazole-diyl group, a thiazole-diyl group, an oxadiazole-diyl group, a benzothiazole-diyl group, a benzothiadiazole-diyl group, a phthalimido-diyl group, a thienothiazole-diyl group, a thiazolothiazole-diyl group, a thienothiophene-diyl group, a thienooxazole-diyl group, and the following structures (II-1) to (II-4).

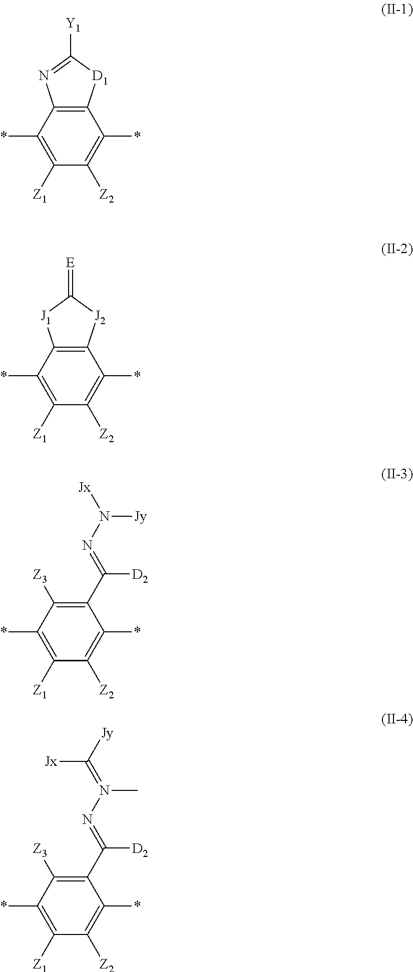

In Formulae (II-1) to (II-4), D₁ represents —S—, —O—, or —NR¹¹—, in which R¹¹ represents a hydrogen atom or an alkyl group having 1 to 6 carbon atoms; Yi represents an aromatic hydrocarbon group having 6 to 12 carbon atoms or an aromatic heterocyclic group having 3 to 12 carbon atoms; Z₁, Z₂, and Z₃ each independently represent a hydrogen atom, an aliphatic hydrocarbon group having 1 to 20 carbon atoms, an alicyclic hydrocarbon group having 3 to 20 carbon atoms, a monovalent aromatic hydrocarbon group having 6 to 20 carbon atoms, a halogen atom, a cyano group, a nitro group, —NR¹²R¹³, or SR¹², in which Z₁ and Z₂ may be bonded to each other to form an aromatic ring or an aromatic heterocyclic ring, and R¹² and R¹³ each independently represent a hydrogen atom or an alkyl group having 1 to 6 carbon atoms; J₁ and J₂ each independently represent a group selected from the group consisting of —O—, —NR²¹— (R²¹ represents a hydrogen atom or a substituent), —S—, and —C(O)—; E represents a hydrogen atom or a non-metal atom of Group 14 to Group 16, to which a substituent may be bonded; Jx represents an organic group having 2 to 30 carbon atoms, which has at least one aromatic ring selected from the group consisting of an aromatic hydrocarbon ring and an aromatic heterocyclic ring; Jy represents a hydrogen atom, an alkyl group having 1 to 6 carbon atoms, which may have a substituent, or an organic group having 2 to 30 carbon atoms, which has at least one aromatic ring selected from the group consisting of an aromatic hydrocarbon ring and an aromatic heterocyclic ring; the aromatic ring of Jx and Jy may have a substituent, Jx and Jy may be bonded to each other to form a ring; and D₂ represents a hydrogen atom or an alkyl group having 1 to 6 carbon atoms, which may have a substituent.

In Formula (II-2), in a case where Yi represents an aromatic hydrocarbon group having 6 to 12 carbon atoms, the aromatic hydrocarbon group may be monocyclic or polycyclic. In a case where Yi represents an aromatic heterocyclic group having 3 to 12 carbon atoms, the aromatic heterocyclic group may be monocyclic or polycyclic.

In Formula (II-2), in a case where J₁ and J₂ represent —NR²¹—, the substituent as R²¹ can refer to, for example, description in paragraphs to of JP2008-107767A, and the content thereof is incorporated in the present specification.

In Formula (II-2), in a case where E represents a non-metal atom of Group 14 to Group 16, to which a substituent may be bonded, ═O, ═S, ═NR′, or ═C(R′)R′ is preferable. R′ represents a substituent, and as the substituent, for example, description in paragraphs to [0035] [0045] of JP2008-107767A can be referred to, and —NZ^{A1}Z^{A2} (Z^{A}1 and Z^{A2} each independently represent a hydrogen atom, an alkyl group, or an aryl group) is preferable.

Specific examples of the divalent alicyclic group represented by A1 include a cyclopentylene group and a cyclohexylene group, and the carbon atoms thereof may be substituted with —O—, —Si(CH₃)₂—, —N(Z)— (Z represents hydrogen, an alkyl group having 1 to 4 carbon atoms, a cycloalkyl group, an aryl group, a cyano group, or a halogen atom), —C(O)—, —S—, —C(S)—, —S(O)—, SO₂—, or a group obtained by combining two or more of these groups.

In Formula (MG-A), a1 represents an integer of 2 to 10 (preferably, an integer of 2 to 4). A plurality of A1's may be the same or different from each other.

In Formula (MG-B), A2 and A3 each independently represent a divalent group selected from the group consisting of an aromatic hydrocarbon group, a heterocyclic group, and an alicyclic group. Specific examples and suitable aspects of A2 and A3 are the same as those for A1 in Formula (MG-A), and thus the description thereof will not be repeated.

In Formula (MG-B), a2 represents an integer of 1 to 10 (preferably, an integer of 1 to 3), a plurality of A2's may be the same or different from each other, and a plurality of LA1's may be the same or different from each other. From the viewpoint that the effect of the present invention is more excellent, it is more preferable that a2 is 2 or more.

In Formula (MG-B), LA1 represents a single bond or a divalent linking group. Here, in a case where a2 is 1, LA1 is a divalent linking group, and in a case where a2 is 2 or more, at least one of a plurality of LA1's is a divalent linking group.

In Formula (MG-B), the divalent linking group represented by LA1 is the same as LW, and thus the description thereof will not be repeated.

Specific examples of MG include the following structures, and the hydrogen atoms on the aromatic hydrocarbon group, the heterocyclic group, and the alicyclic group in the following structures may be substituted with the substituent W described above.

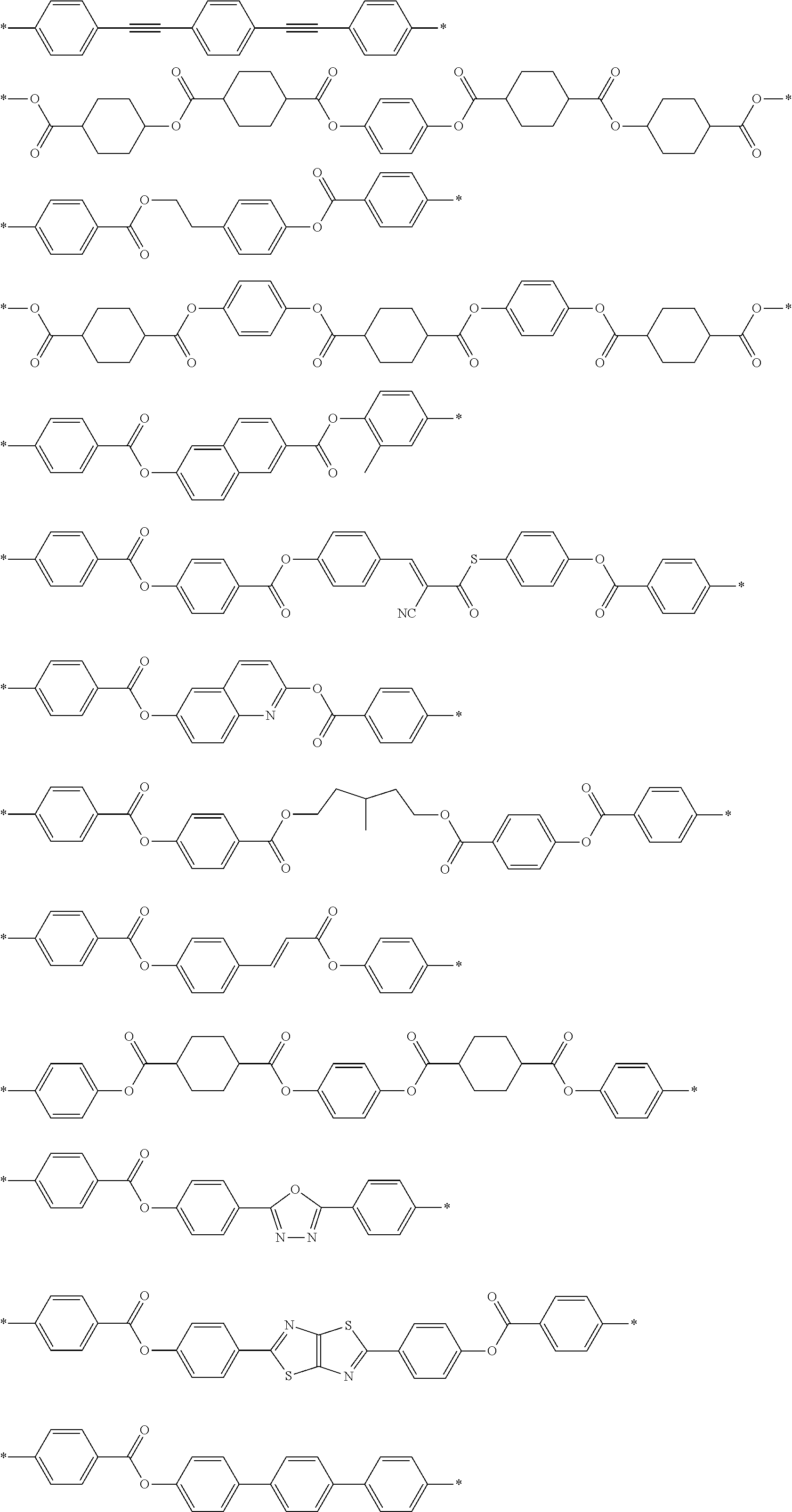

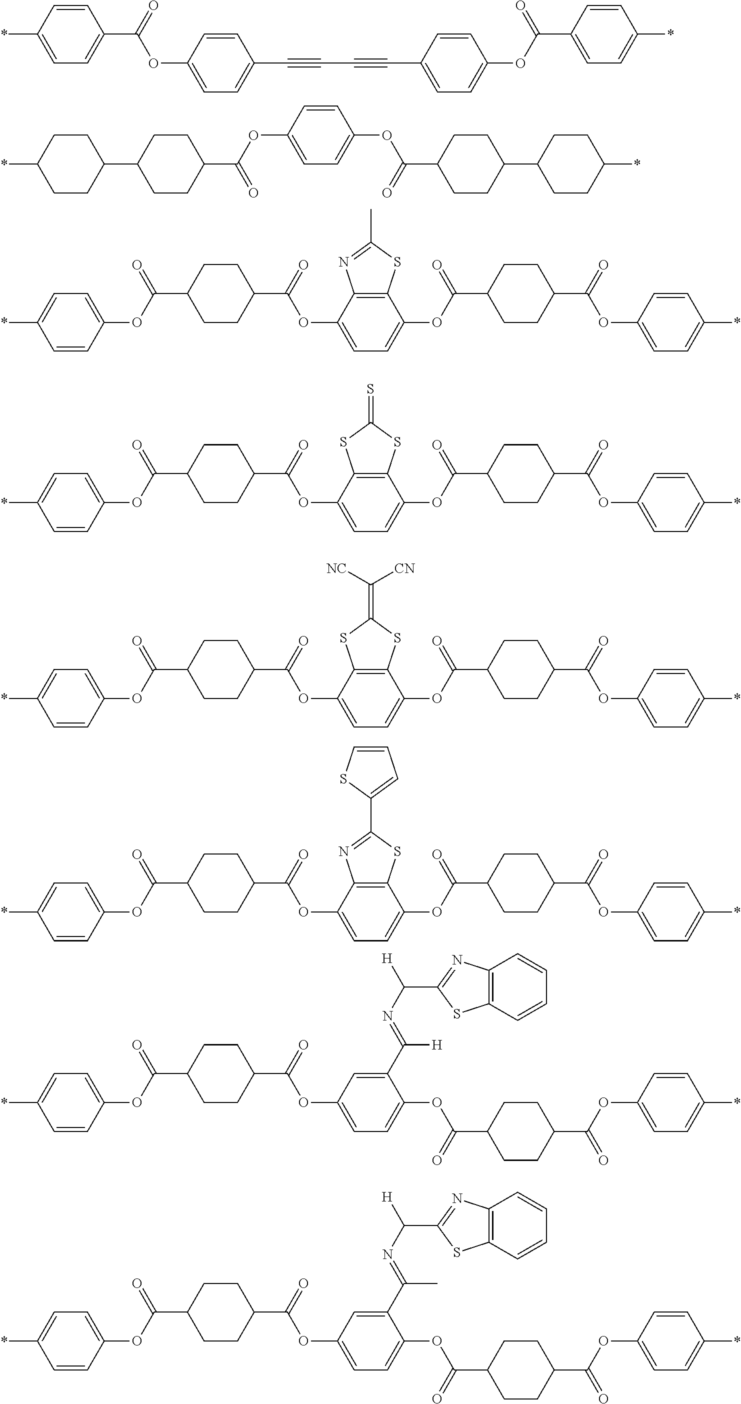

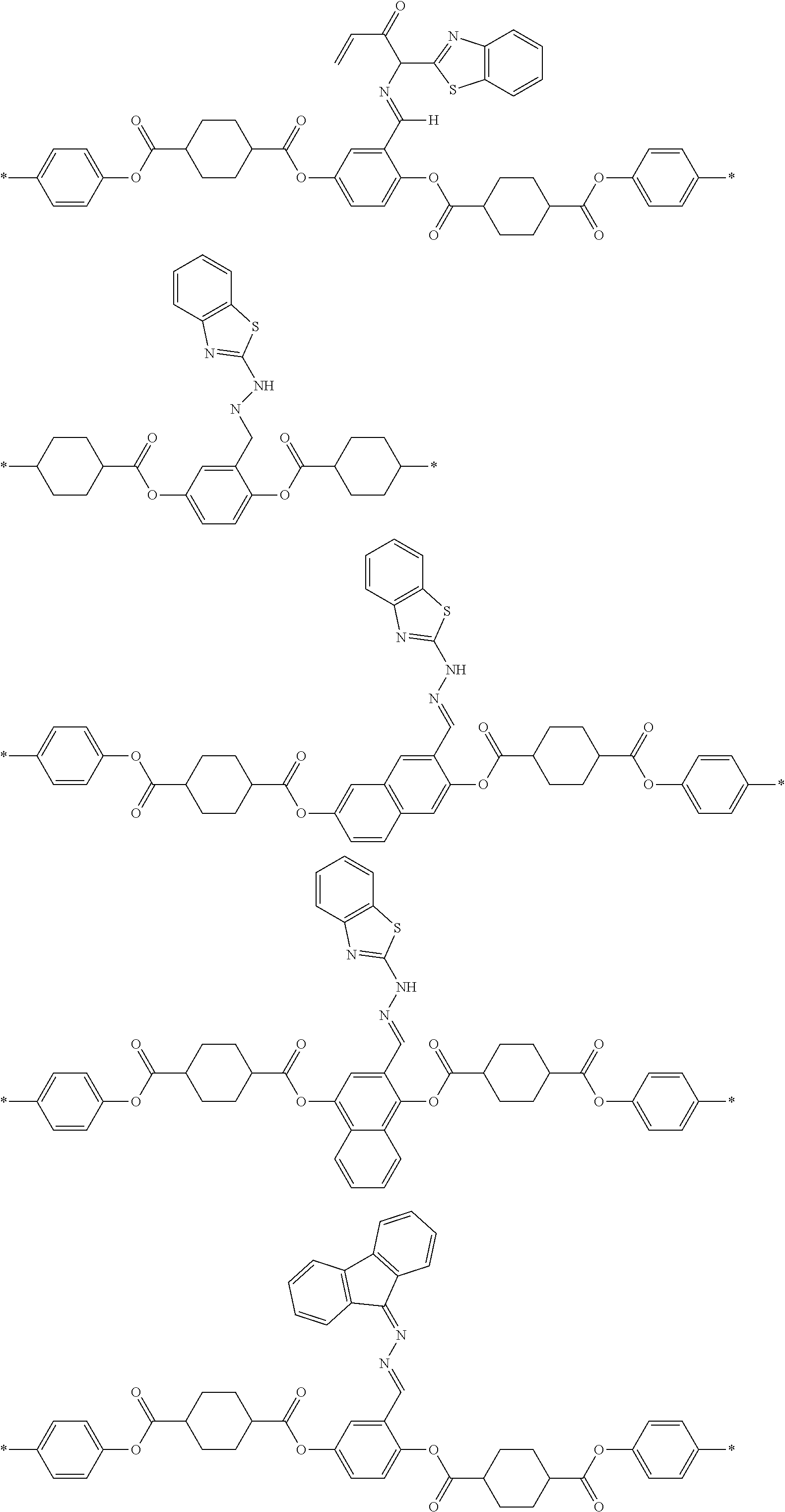

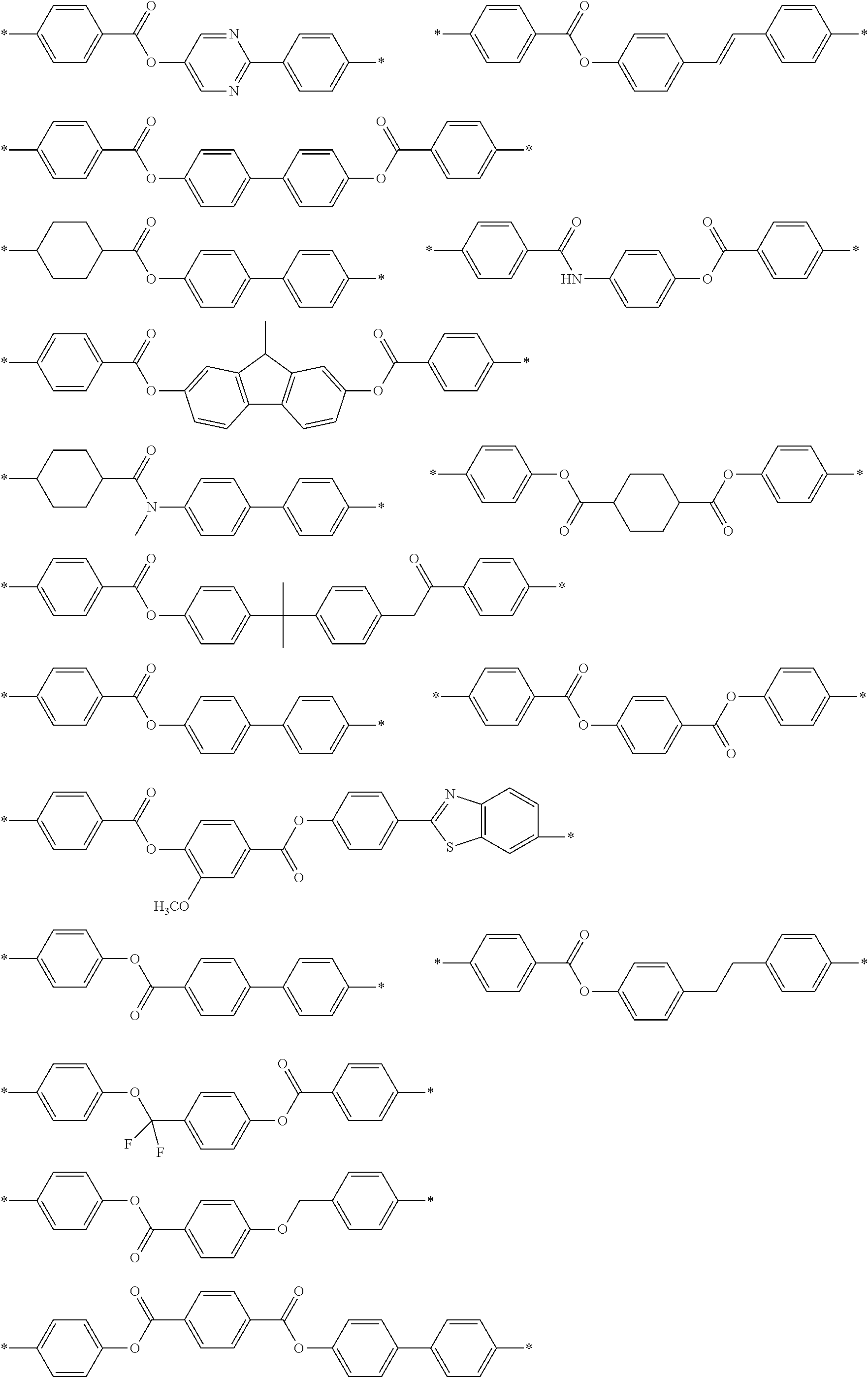

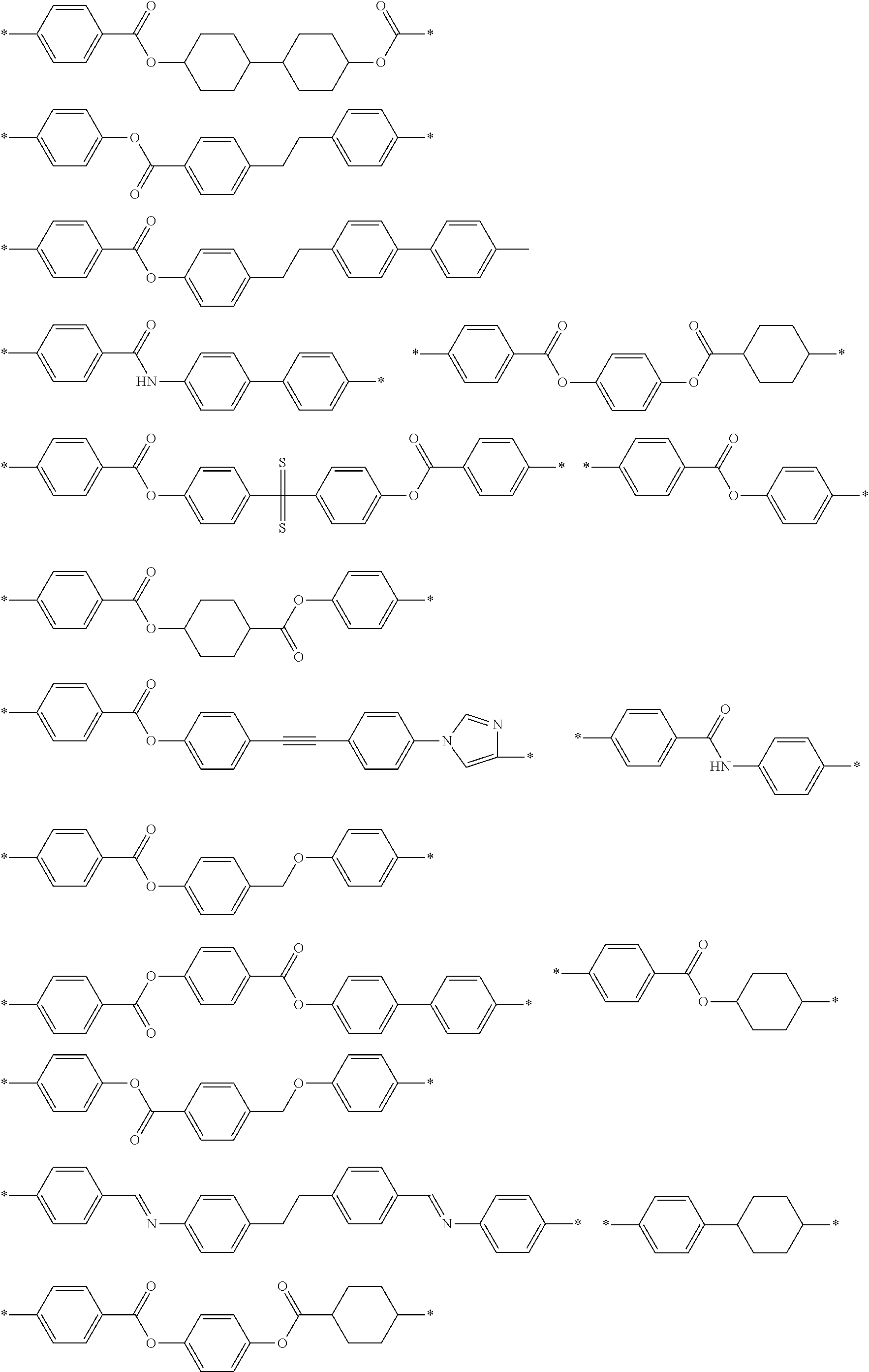

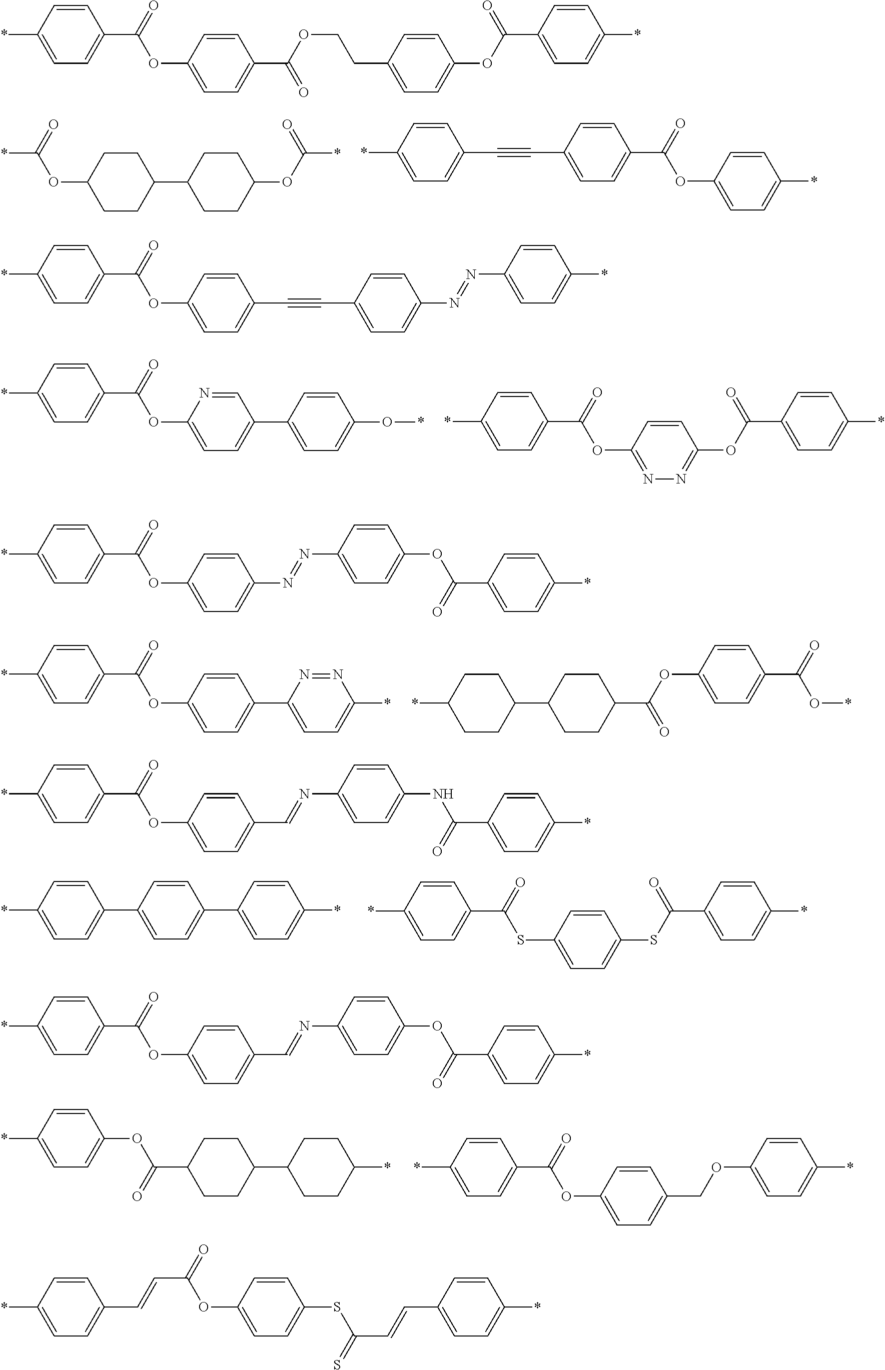

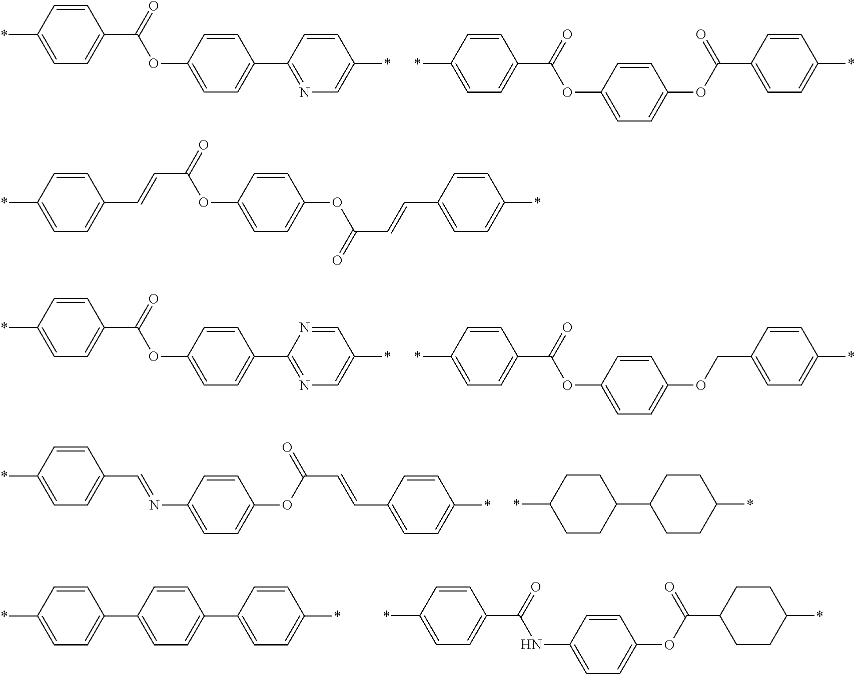

In a case where the liquid crystalline compound represented by Formula (LC) is the low-molecular-weight liquid crystalline compound, examples of preferred aspects of the cyclic structure of the mesogen group MG include a cyclohexylene group, a cyclopentylene group, a phenylene group, a naphthylene group, a fluorene-diyl group, a pyridine-diyl group, a pyridazine-diyl group, a thiophene-diyl group, an oxazole-diyl group, a thiazole-diyl group, and a thienothiophene-diyl group, and the number of cycle structures is preferably 2 to 10 and more preferably 3 to 7.

Examples of preferred aspects of the substituent W in the mesogen structure include a halogen atom, a halogenated alkyl group, a cyano group, a hydroxy group, a nitro group, a carboxy group, an alkoxy group having 1 to 10 carbon atoms, an alkylcarbonyl group having 1 to 10 carbon atoms, an alkyloxycarbonyl group having 1 to 10 carbon atoms, an alkylcarbonyloxy group having 1 to 10 carbon atoms, an amino group, an alkylamino group having 1 to 10 carbon atoms, an alkylaminocarbonyl group, and a group in which LW in Formula (W1) represents a single bond, SPW represents a divalent spacer group, and Q represents a crosslinkable group represented by any of Formulae (P-1) to (P-30); and as the crosslinkable group, a vinyl group, a butadiene group, a (meth)acryloyl group, a (meth)acrylamide group, a vinyl acetate group, a fumaric acid ester group, a styryl group, a vinylpyrrolidone group, a maleic acid anhydride, a maleimide group, a vinyl ether group, an epoxy group, or an oxetanyl group is preferable.

Preferred aspects of the divalent spacer groups S1 and S2 are the same as those for SPW described above, and thus the description thereof will not be repeated.

In a case where a low-molecular-weight liquid crystalline compound exhibiting smectic properties is used, the number of carbon atoms of the spacer group (the number of atoms in a case where the carbon atoms are substituted with “SP-C”) is preferably 6 or more and more preferably 8 or more.

In a case where the liquid crystalline compound represented by Formula (LC) is the low-molecular-weight liquid crystalline compound, a plurality of low-molecular-weight liquid crystalline compounds may be used in combination, and it is preferable that 2 to 6 kinds of low-molecular-weight liquid crystalline compounds are used in combination, and it is more preferable that 2 to 4 kinds of low-molecular-weight liquid crystalline compounds are used in combination. By using the low-molecular-weight liquid crystalline compounds in combination, solubility can be improved, and the phase transition temperature of the liquid crystalline composition can be adjusted.

Specific examples of the low-molecular-weight liquid crystalline compound include compounds represented by Formulae (LC-1) to (LC-77), but the low-molecular-weight liquid crystalline compound is not limited thereto.

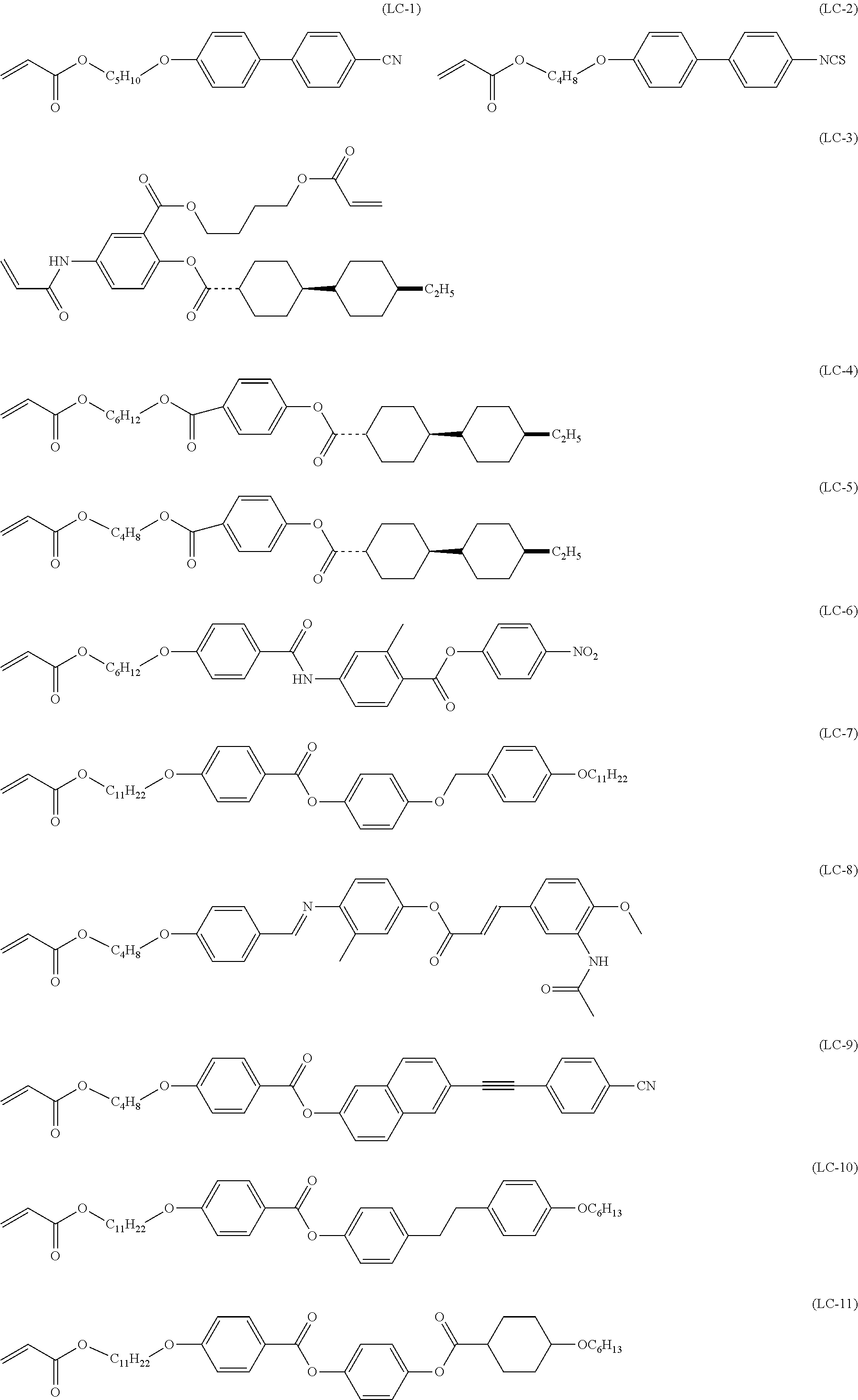

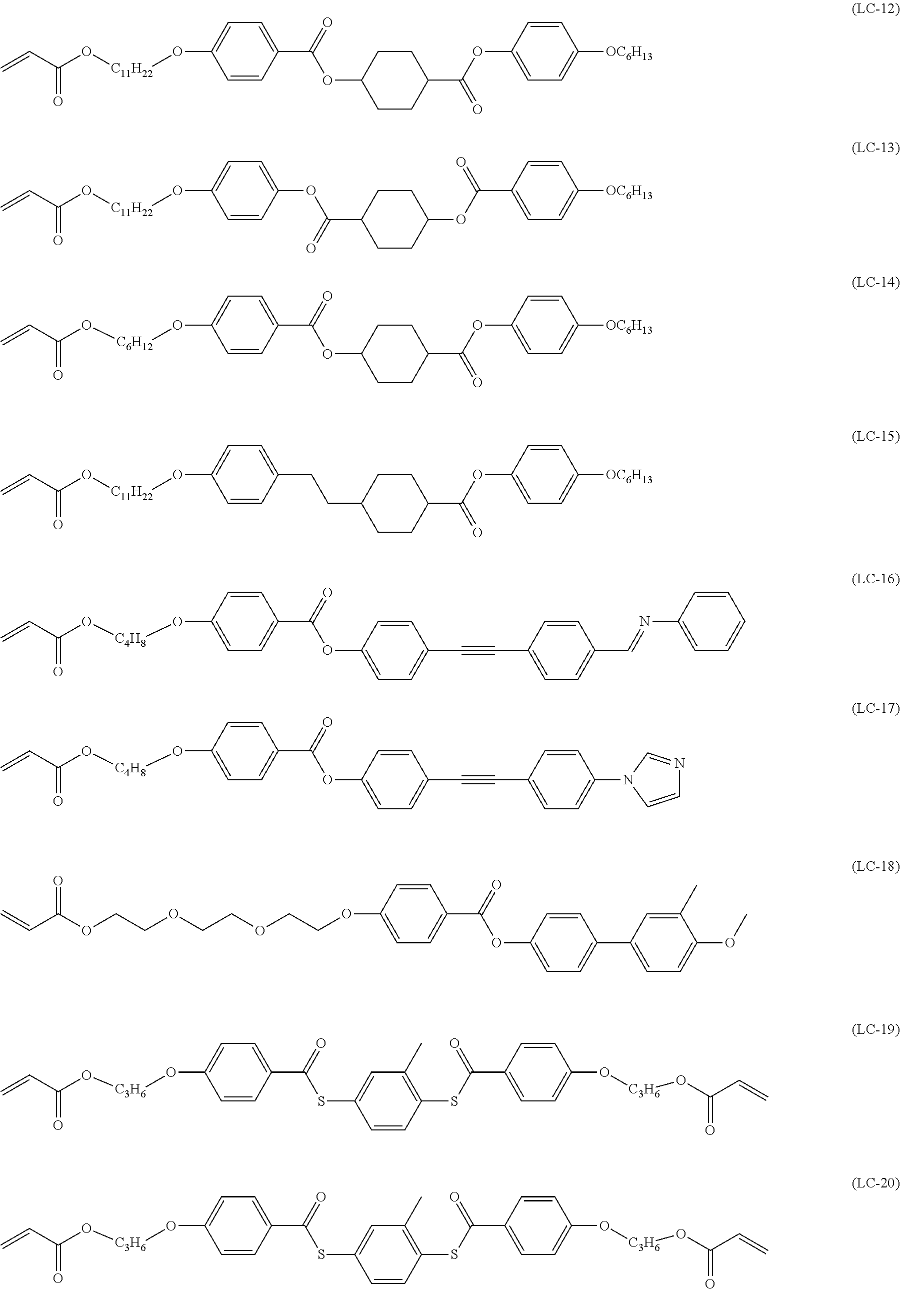

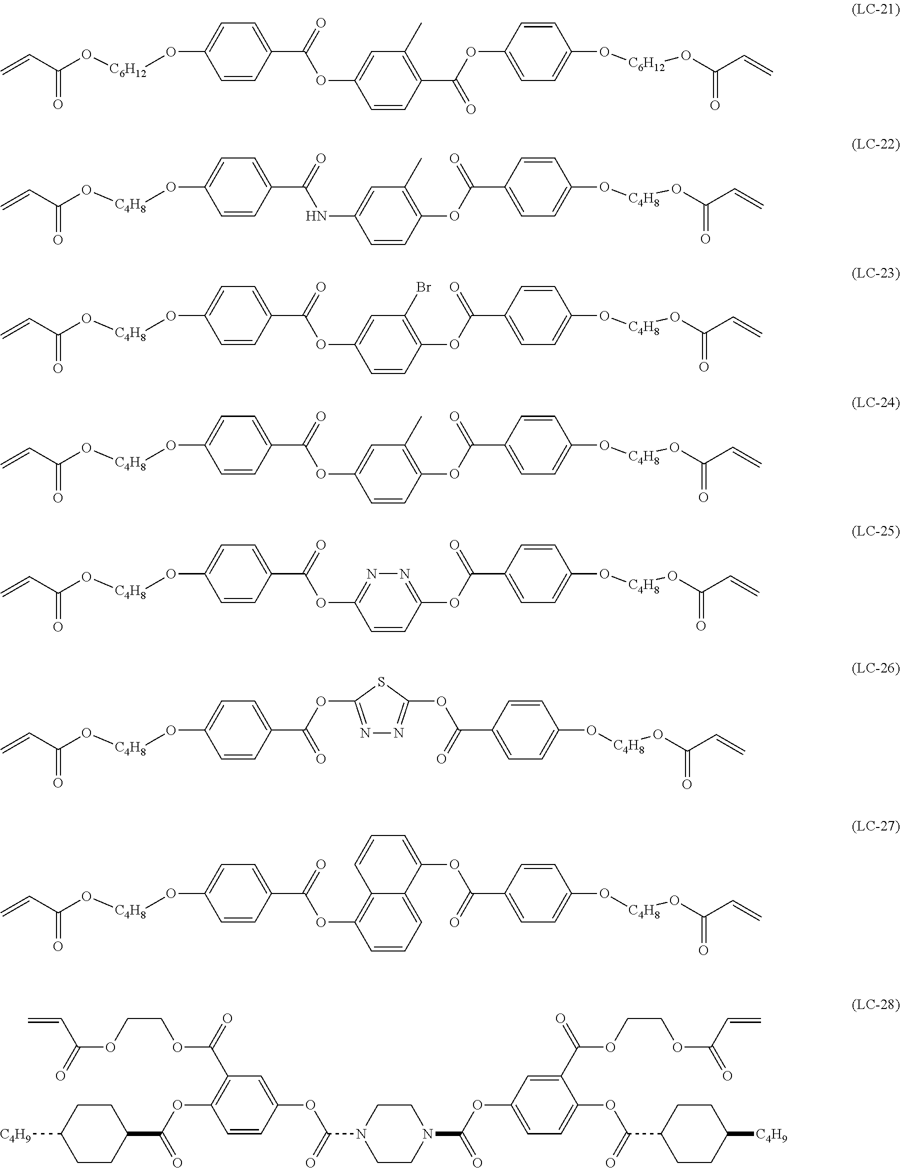

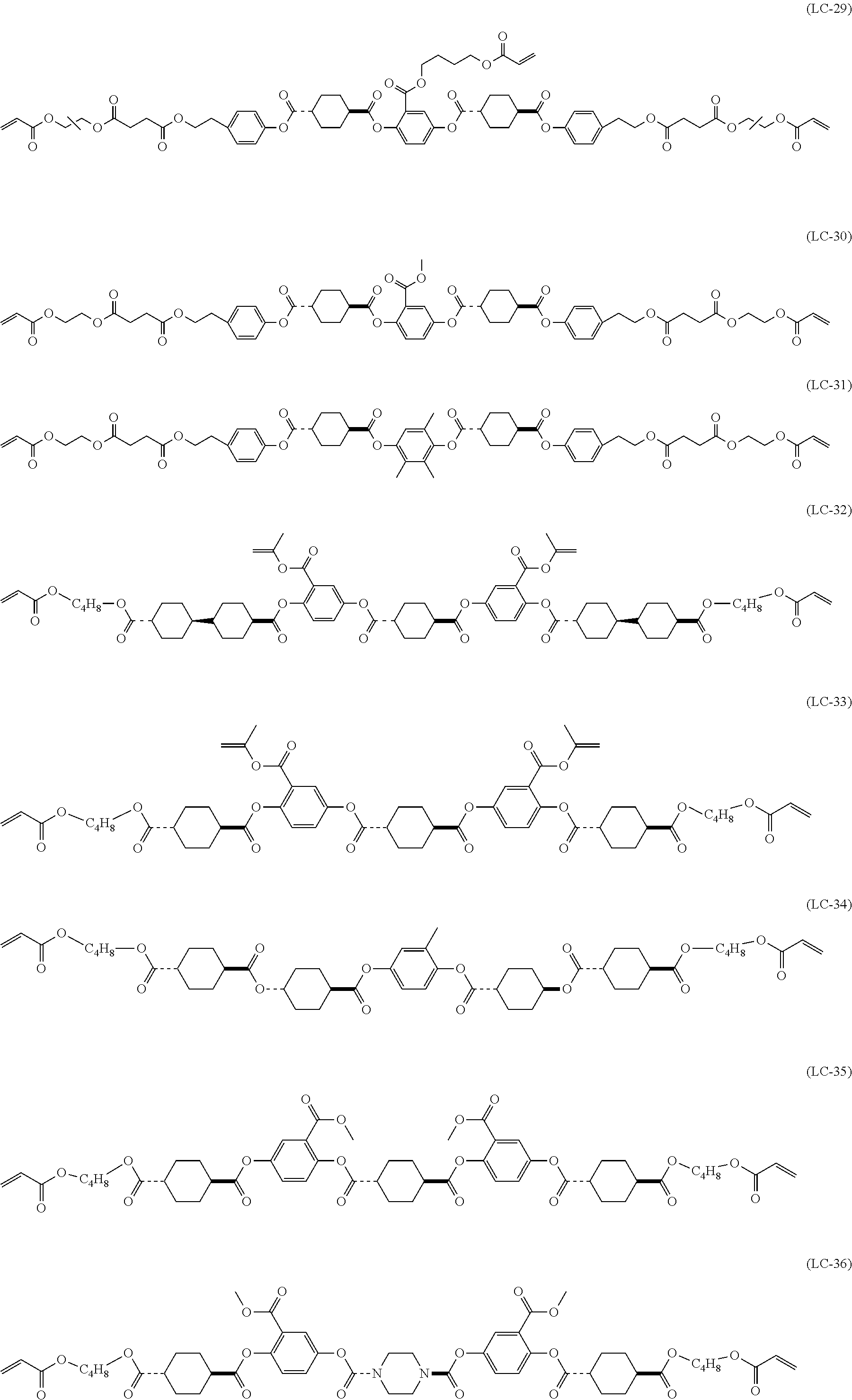

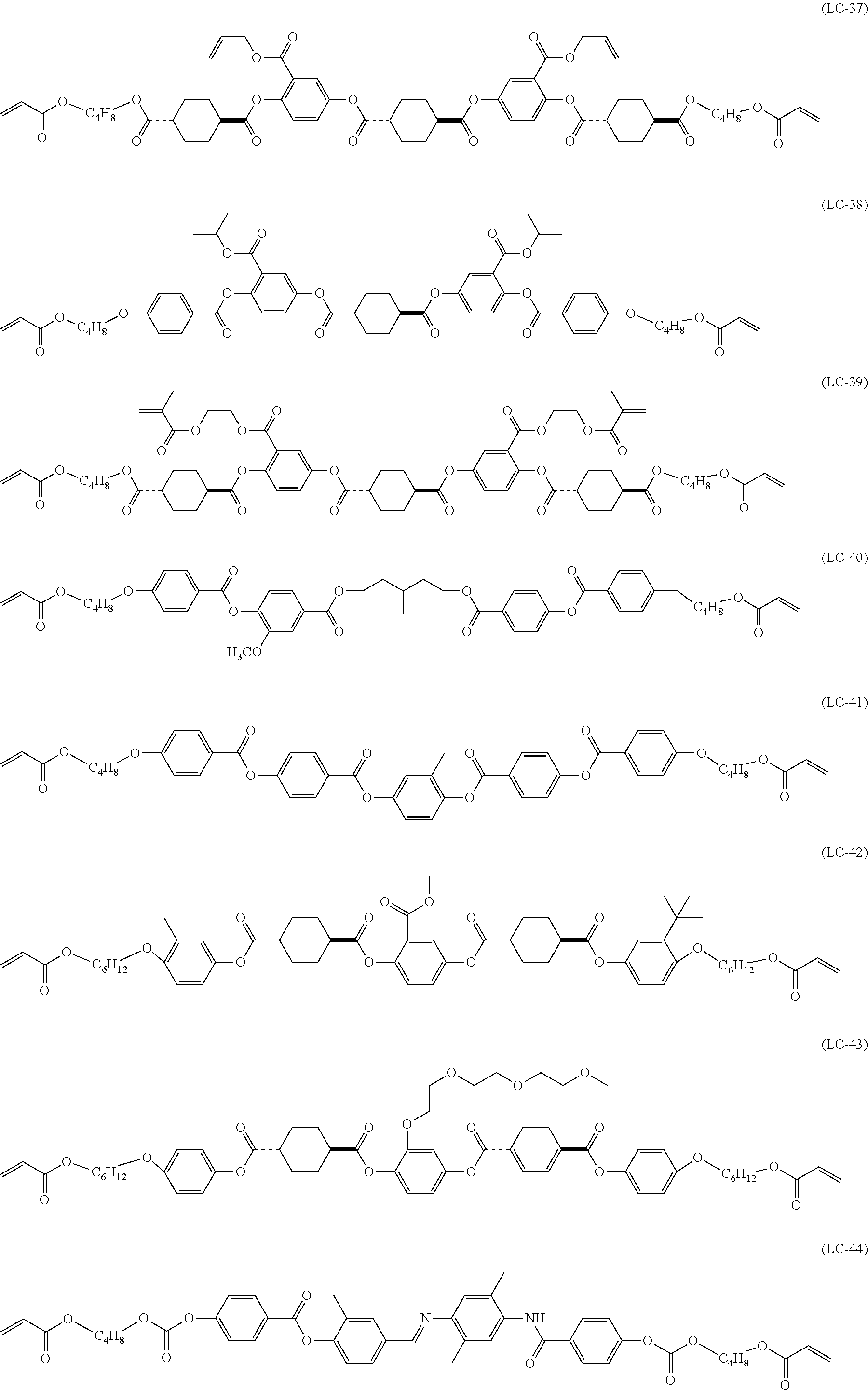

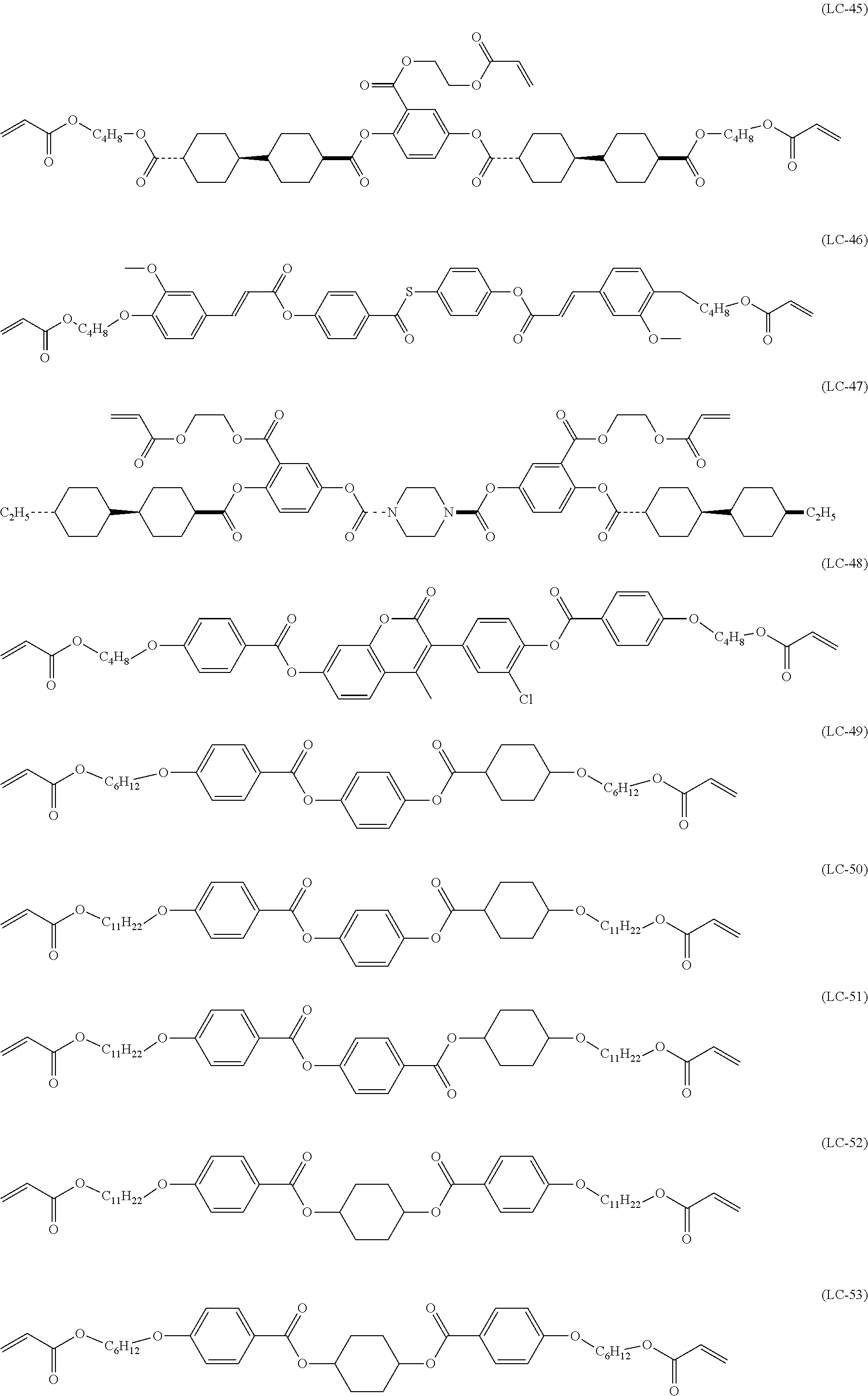

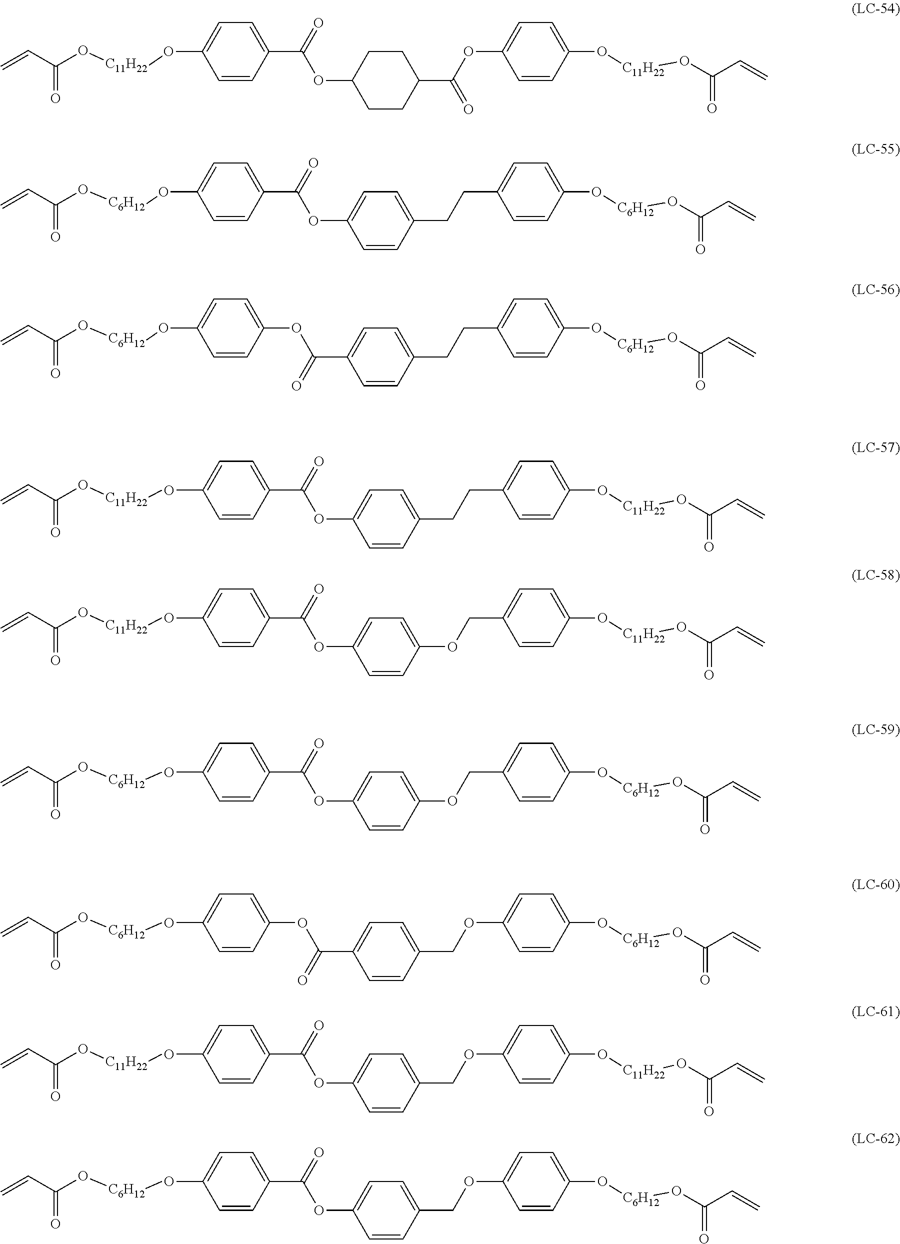

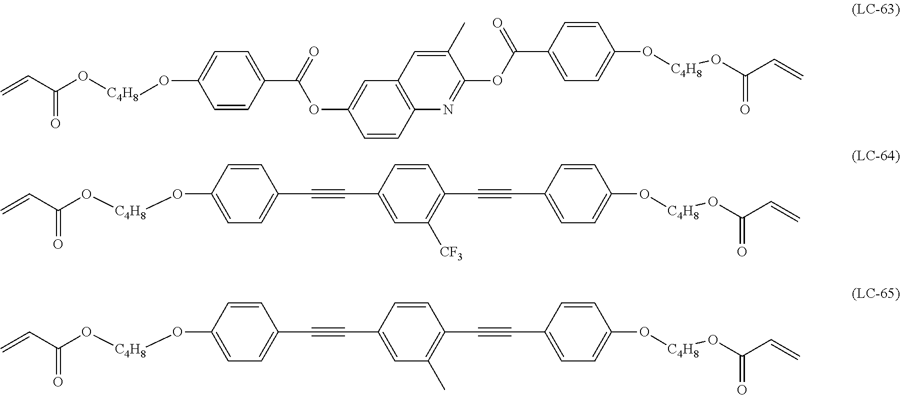

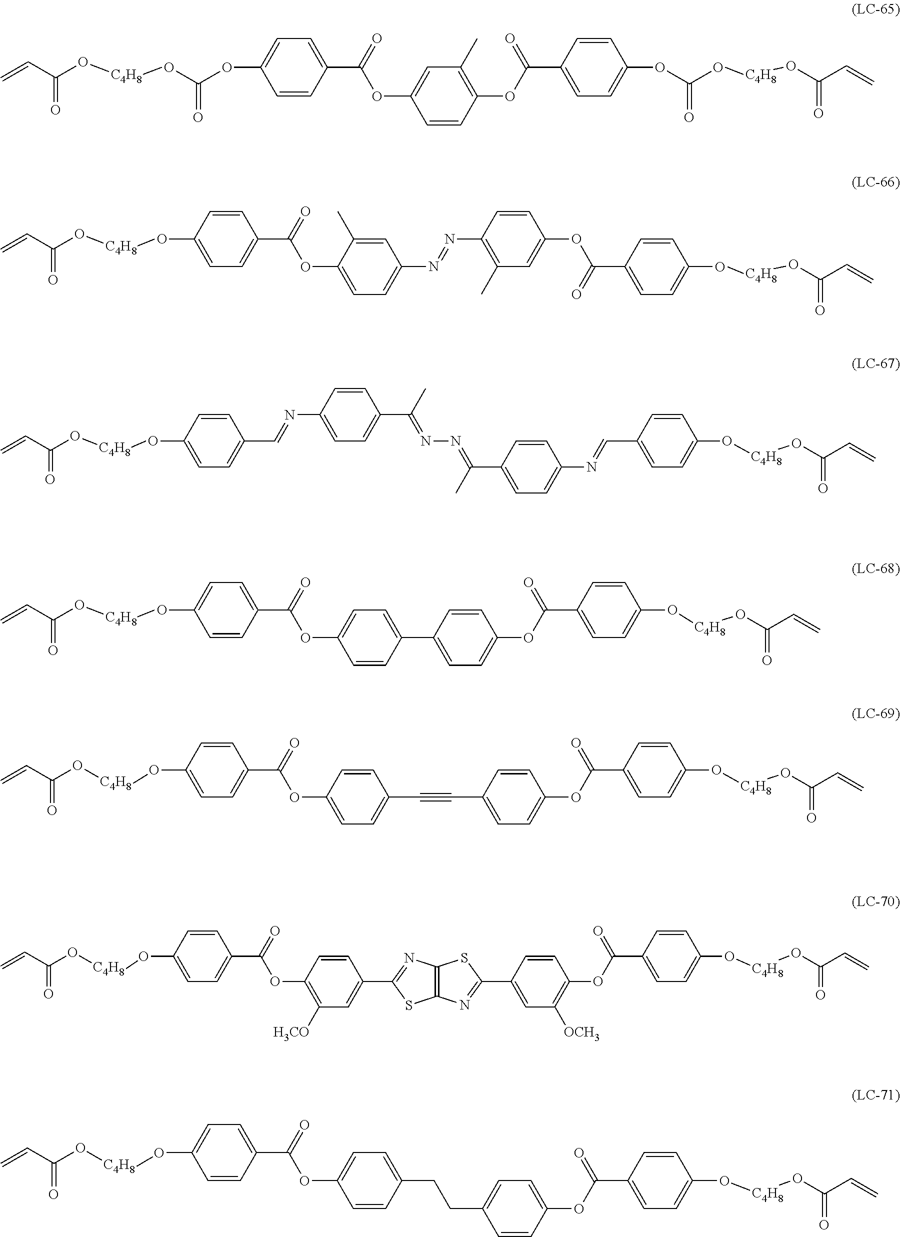

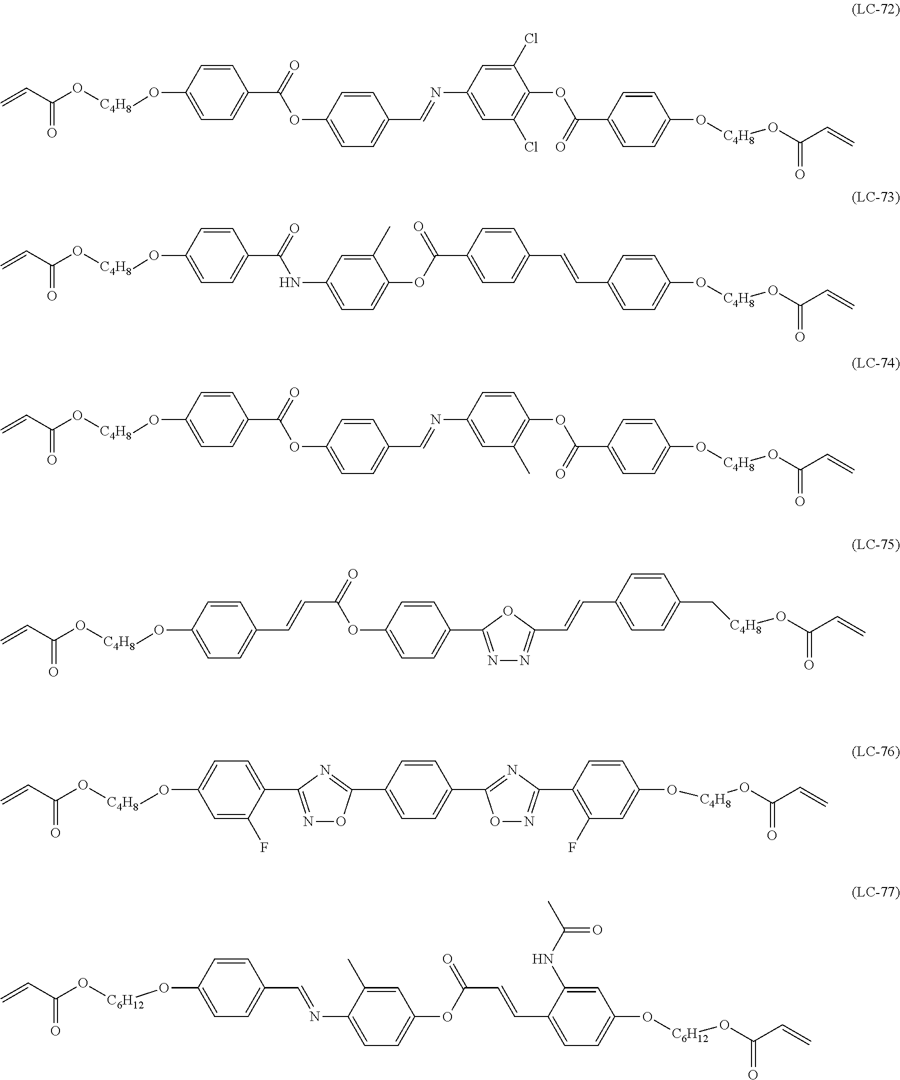

The high-molecular-weight liquid crystalline compound is preferably a homopolymer or a copolymer, including a repeating unit described below, and may be any of a random polymer, a block polymer, a graft polymer or a star polymer.

(Repeating Unit (1))

It is preferable that the high-molecular-weight liquid crystalline compound includes a repeating unit represented by Formula (1) (hereinafter, also referred to as “repeating unit (1)”).

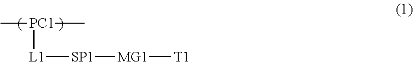

In Formula (1), PC1 represents a main chain of the repeating unit, L1 represents a single bond or a divalent linking group, SP1 represents a spacer group, MG1 represents the mesogen group MG in Formula (LC) described above, and T1 represents a terminal group.

Examples of the main chain of the repeating unit, represented by PC1, include groups represented by Formulae (P1-A) to (P1-D). Among these, from the viewpoint of diversity and handleability of a monomer serving as a raw material, a group represented by Formula (P1-A) is preferable.

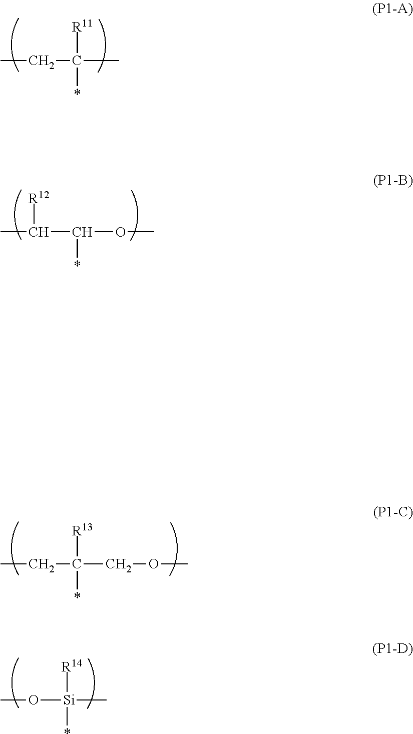

In Formulae (P1-A) to (P1-D), “*” represents a bonding position to L1 in Formula (1). In Formulae (P1-A) to (P1-D), R¹¹, R¹², R¹³, and R¹⁴ each independently represent a hydrogen atom, a halogen atom, a cyano group, an alkyl group having 1 to 10 carbon atoms, or an alkoxy group having 1 to 10 carbon atoms. The above-described alkyl group may be a linear or branched alkyl group, or an alkyl group having a cyclic structure (cycloalkyl group). In addition, the number of carbon atoms in the above-described alkyl group is preferably 1 to 5.

It is preferable that the group represented by Formula (P1-A) is one unit of a partial structure of poly(meth)acrylic acid ester, which is obtained by polymerization of (meth)acrylic acid ester.

It is preferable that the group represented by Formula (P1-B) is an ethylene glycol unit formed by ring-opening polymerization of an epoxy group of a compound having the epoxy group.

It is preferable that the group represented by Formula (P1-C) is a propylene glycol unit formed by ring-opening polymerization of an oxetane group of a compound having the oxetane group.

It is preferable that the group represented by Formula (P1-D) is a siloxane unit of a polysiloxane obtained by polycondensation of a compound having at least one of an alkoxysilyl group or a silanol group. Here, examples of the compound having at least one of an alkoxysilyl group or a silanol group include a compound having a group represented by Formula SiR¹⁴(OR¹⁵)₂—. In the formula, R¹⁴ has the same definition as that for R¹⁴ in Formula (P1-D), and a plurality of R¹⁵'s each independently represent a hydrogen atom or an alkyl group having 1 to 10 carbon atoms.

The divalent linking group represented by L1 is the same divalent linking group as LW in Formula (W1) described above, and examples of preferred aspects thereof include —C(O)O—, —OC(O)—, —O—, —S—, —C(O)NR¹⁶—, —NR¹⁶C(O)—, —S(O)₂—, and —NR¹⁷—. In the formulae, R¹⁶ and R¹⁷ each independently represent a hydrogen atom or an alkyl group having 1 to 6 carbon atoms, which may have a substituent (for example, the substituent W described above). In the specific examples of the divalent linking group, the bonding site on the left side is bonded to PC1 and the bonding site on the right side is bonded to SP1.

In a case where PC1 represents the group represented by Formula (P1-A), it is preferable that L1 is a group represented by —C(O)O— or —C(O)NR¹⁶—.

In a case where PC1 represents the group represented by any of Formulae (P1-B) to (P1-D), it is preferable that L1 is a single bond.

The spacer group represented by SP1 represents the same groups as S1 and S2 in Formula (LC) described above, and from the viewpoint of the alignment degree, a group having at least one structure selected from the group consisting of an oxyethylene structure, an oxypropylene structure, a polysiloxane structure, and an alkylene fluoride structure, or a linear or branched alkylene group having 2 to 20 carbon atoms is preferable. However, the above-described alkylene group may include —O—, —S—, —O—CO—, —CO—O—, —O—CO—O—, —CO—NR— (R represents an alkyl group having 1 to 10 carbon atoms), or —S(O)₂—.

From the viewpoint of easily expressing liquid crystallinity and availability of raw materials, it is more preferable that the spacer group represented by SP1 is a group having at least one structure selected from the group consisting of an oxyethylene structure, an oxypropylene structure, a polysiloxane structure, and an alkylene fluoride structure.

Here, the oxyethylene structure represented by SP1 is preferably a group represented by *—(CH₂—CH₂O)ₙ₁—* is preferable. In the formula, n1 represents an integer of 1 to 20, and * represents a bonding position to L1 or MG1. From the viewpoint that the effect of the present invention is more excellent, n1 is preferably an integer of 2 to 10, more preferably an integer of 2 to 6, and most preferably an integer of 2 to 4.

In addition, the oxypropylene structure represented by SP1 is preferably a group represented by *—(CH(CH₃)—CH₂O)ₙ₂—*. In the formula, n2 represents an integer of 1 to 3, and * represents a bonding position to L1 or MG1.

In addition, the polysiloxane structure represented by SP1 is preferably a group represented by *—(Si(CH₃)₂—O)ₙ₃—*. In the formula, n3 represents an integer of 6 to 10, and * represents a bonding position to L1 or MG1.

In addition, the alkylene fluoride structure represented by SP1 is preferably a group represented by *—(CF₂—CF₂)ₙ₄—*. In the formula, n4 represents an integer of 6 to 10, and * represents a bonding position to L1 or MG1.

Examples of the terminal group represented by T1 include a hydrogen atom, a halogen atom, a cyano group, a nitro group, a hydroxy group, —SH, a carboxyl group, a boronic acid group, —SO₃H, —PO₃H₂, —NR¹¹R¹² (R¹¹ and R¹² each independently represent a hydrogen atom, a substituted or unsubstituted alkyl group having 1 to 10 carbon atoms, a cycloalkyl group, or an aryl group), an alkyl group having 1 to 10 carbon atoms, an alkoxy group having 1 to 10 carbon atoms, an alkylthio group having 1 to 10 carbon atoms, an alkoxycarbonyloxy group having 1 to 10 carbon atoms, an acyloxy group having 1 to 10 carbon atoms, an acylamino group having 1 to 10 carbon atoms, an alkoxycarbonyl group having 1 to 10 carbon atoms, an alkoxycarbonylamino group having 1 to 10 carbon atoms, a sulfonylamino group having 1 to 10 carbon atoms, a sulfamoyl group having 1 to 10 carbon atoms, a carbamoyl group having 1 to 10 carbon atoms, a sulfinyl group having 1 to 10 carbon atoms, a ureido group having 1 to 10 carbon atoms, and a crosslinkable group-containing group.

Examples of the above-described crosslinkable group-containing group include -L-CL described above. L represents a single bond or a divalent linking group. Specific examples of the linking group are the same as those for LW and SPW described above. CL represents a crosslinkable group, examples thereof include the group represented by Q1 or Q2 described above, and the above-described crosslinkable group represented by any of Formulae (P-1) to (P-30) is preferable. In addition, T1 may be a group obtained by combining two or more of these groups.

From the viewpoint that the effect of the present invention is more excellent, T1 is preferably an alkoxy group having 1 to 10 carbon atoms, more preferably an alkoxy group having 1 to 5 carbon atoms, and still more preferably a methoxy group. These terminal groups may be further substituted with the groups or polymerizable groups described in JP2010-244038A.

From the viewpoint that the effect of the present invention is more excellent, the number of atoms in the main chain of T1 is preferably 1 to 20, more preferably 1 to 15, still more preferably 1 to 10, and particularly preferably 1 to 7. In a case where the number of atoms in the main chain of T1 is 20 or less, the alignment degree of the light absorption anisotropic layer is further improved. Here, the “main chain” of T1 means the longest molecular chain bonded to M1, and the number of hydrogen atoms is not included in the number of atoms in the main chain of T1. For example, in a case where T1 is an n-butyl group, the number of atoms in the main chain is 4, and in a case where T1 is an sec-butyl group, the number of atoms in the main chain is 3.

A content of the repeating unit (1) is preferably 40% to 100% by mass and more preferably 50% to 95% by mass with respect to all repeating units (100% by mass) of the high-molecular-weight liquid crystalline compound.

In a case where the content of the repeating unit (1) is 40% by mass or more, an excellent light absorption anisotropic layer A can be obtained due to favorable aligning properties. In addition, in a case where the content of the repeating unit (1) is 100% by mass or less, an excellent light absorption anisotropic layer A can be obtained due to favorable aligning properties.

The high-molecular-weight liquid crystalline compound may include only one of the repeating unit (1), or two or more kinds of the repeating units (1). In a case where the high-molecular-weight liquid crystalline compound includes two or more kinds of repeating units (1), the content of the repeating unit (1) indicates the total content of the repeating units (1).

In Formula (1), a difference (|log P₁−log P₂|) between a log P value of PC1, L1, and SP1 (hereinafter, also referred to as “log P₁”) and a log P value of MG1 (hereinafter, also referred to as “log P₂”) is preferably 4 or more, and from the viewpoint of further improving the alignment degree of the light absorption anisotropic layer A, it is more preferably 4.25 or more and still more preferably 4.5 or more.

In addition, from the viewpoint of adjusting the liquid crystal phase transition temperature and the synthetic suitability, the upper limit value of the above-described difference is preferably 15 or less, more preferably 12 or less, and still more preferably 10 or less.

Here, the log P value is an index for expressing properties of hydrophilicity and hydrophobicity of a chemical structure, and is also referred to as a hydrophilic-hydrophobic parameter. The log P value can be calculated using software such as ChemBioDraw Ultra or HSP1P (Ver. 4.1.07). In addition, the log P value can be acquired experimentally by the method of the OECD Guidelines for the Testing of Chemicals, Sections 1, Test No. 117, or the like. In the present invention, a value calculated by inputting the structural formula of a compound to HSP1P (Ver. 4.1.07) is adopted as the log P value unless otherwise specified.

The above-described log P₁ indicates the log P value of PC1, L1, and SP1 as described above. The expression “log P value of PC1, L1, and SP1” indicates the log P value of a structure in which PC1, L1, and SP1 are integrated, which is not the sum of the log P values of PC1, L1, and SP1. Specifically, the log P₁ is calculated by inputting a series of structural formulae of PC1 to SP1 in Formula (1) into the above-described software.

However, in the calculation of the log P1, with regard to a part of the group represented by PC1 in the series of structural formulae of PC1 to SP1, the structure of the group represented by PC1 itself (for example, Formulae (P1-A) to (P1-D) described above) may be used, or a structure of a group which can be PC1 after polymerization of a monomer used to obtain the repeating unit represented by Formula (1) may be used.

Here, specific examples of the latter (the group which can be PC1) are as follows. In a case where PC1 is obtained by polymerization of (meth)acrylic acid ester, PC1 is a group represented by CH₂═C(R¹)— (R¹ represents a hydrogen atom or a methyl group). In addition, in a case where PC1 is obtained by polymerization of ethylene glycol, PC1 is ethylene glycol, and in a case where PC1 is obtained by polymerization of propylene glycol, PC1 is propylene glycol. In addition, in a case where PC1 is obtained by condensation polymerization of silanol, PC1 is silanol (a compound represented by Formula Si(R²)₃(OH); a plurality of R²'s each independently represent a hydrogen atom or an alkyl group, and at least one of the plurality of R²'s represents an alkyl group).

The above-described difference between log P₁ and log P₂ is preferably 4 or more, and the log P₁ may be less than the log P₂ or may be more than the log P₂.

Here, the log P value of a general mesogen group (the log P₂ described above) tends to be in a range of 4 to 6. In a case where the log P₁ is less than the log P₂, the value of log P₁ is preferably 1 or less and more preferably 0 or less. On the other hand, in a case where the log P₁ is more than the log P₂, the value of log P₁ is preferably 8 or more and more preferably 9 or more.

In a case where PC1 in Formula (1) is obtained by polymerization of (meth)acrylic acid ester and the log P₁ is less than the log P₂, the log P value of SP1 in Formula (1) is preferably 0.7 or less and more preferably 0.5 or less. On the other hand, in a case where PC1 in Formula (1) is obtained by polymerization of (meth)acrylic acid ester and the log P₁ is more than the log P₂, the log P value of SP1 in Formula (1) is preferably 3.7 or more and more preferably 4.2 or more.

Examples of the structure having a log P value of 1 or less include an oxyethylene structure and an oxypropylene structure. Examples of the structure having a log P value of 6 or more include a polysiloxane structure and an alkylene fluoride structure.

From the viewpoint of improving the alignment degree, it is preferable that the high-molecular-weight liquid crystalline compound has a repeating unit having an electron-donating property and/or an electron-withdrawing property at a terminal. More specifically, it is more preferable that the high-molecular-weight liquid crystalline compound includes a repeating unit (21) having a mesogen group and an electron-withdrawing group which is present at the terminal of the mesogen group and has a σp value of more than 0, and a repeating unit (22) having a mesogen group and a group which is present at the terminal of the mesogen group and has a σp value of 0 or less. As described above, in a case where the high-molecular-weight liquid crystalline compound includes the repeating unit (21) and the repeating unit (22), the alignment degree of the light absorption anisotropic layer A to be formed using the high-molecular-weight liquid crystalline compound is further improved as compared with a case where the high-molecular-weight liquid crystalline compound has only one of the repeating unit (21) or the repeating unit (22). The details of the reason for this are not clear, but it is presumed as follows.

That is, it is presumed that, since opposite dipole moments generated in the repeating unit (21) and the repeating unit (22) cause intermolecular interactions, an interaction between the mesogen groups in a minor axis direction is strengthened, and an orientation in which the liquid crystals are aligned is more uniform, and as a result, the degree of order of the liquid crystals is considered to be high. Accordingly, it is presumed that the aligning properties of the dichroic coloring agent are enhanced, and thus the alignment degree of the light absorption anisotropic layer A to be formed increases.

The repeating units (21) and (22) described above may be the repeating unit represented by Formula (1) described above.

The repeating unit (21) has a mesogen group and an electron-withdrawing group which is present at the terminal of the mesogen group and has a σp value of more than 0.

The above-described electron-withdrawing group is a group which is positioned at the terminal of the mesogen group and has a σp value of more than 0. Examples of the electron-withdrawing group (group having a σp value of more than 0) include a group represented by EWG in Formula (LCP-21) described below, and specific examples thereof are also the same as those described below.

The σp value of the above-described electron-withdrawing group is more than 0, and from the viewpoint of further increasing the alignment degree of the light absorption anisotropic layer A, it is preferably 0.3 or more and more preferably 0.4 or more. From the viewpoint that the uniformity of alignment is excellent, the upper limit of the σp value of the above-described electron-withdrawing group is preferably 1.2 or less and more preferably 1.0 or less.

The σp value is a Hammett's substituent constant σp value (also simply referred to as “σp value”) and is a parameter showing the intensity of the electron-withdrawing property and the electron-donating property of a substituent, which numerically expresses the effect of the substituent on the acid dissociation equilibrium constant of substituted benzoic acid. The Hammett's substituent constant σp value in the present specification indicates the substituent constant σ in a case where the substituent is positioned at the para-position of benzoic acid.

As the Hammett's substituent constant σp value of each group in the present specification, a value described in the document “Hansch et al., Chemical Reviews, 1991, Vol, 91, No. 2, pp. 165 to 195” are adopted. With regard to a group in which the Hammett's substituent constant σp value is not described in the document above, the Hammett's substituent constant σp value can be calculated using software “ACD/Chem Sketch (ACD/Labs 8.00 Release Product Version: 8.08)” based on a difference between the pKa of benzoic acid and the pKa of a benzoic acid derivative having a substituent at the para-position.

The repeating unit (21) is not particularly limited as long as it has, at a side chain thereof, the mesogen group and the electron-withdrawing group which present at the terminal of the mesogen group and has a σp value of more than 0, but from the viewpoint of further increasing the alignment degree of the light absorption anisotropic layer A, a repeating unit represented by Formula (LCP-21) is preferable.

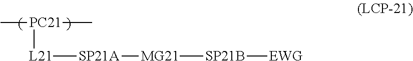

In Formula (LCP-21), PC21 represents a main chain of a repeating unit, and more specifically represents the same structure as that for PC1 in Formula (1) described above; L21 represents a single bond or a divalent linking group, and more specifically represents the same structure as that for L1 in Formula (1) described above; SP21A and SP21B each independently represent a single bond or a spacer group, and more specifically represent the same structure as that for SP1 in Formula (1) described above; MG21 represents a mesogen structure, and more specifically represents the mesogen group MG in Formula (LC) described above; and EWG represents an electron-withdrawing group having a σp value of more than 0.

The spacer group represented by SP21A and SP21B represent the same groups as Formulae S1 and S2 described above, and a group having at least one structure selected from the group consisting of an oxyethylene structure, an oxypropylene structure, a polysiloxane structure, and an alkylene fluoride structure, or a linear or branched alkylene group having 2 to 20 carbon atoms is preferable. However, the above-described alkylene group may include —O—, —O—CO—, —CO—O—, or —O—CO—O—.

From the viewpoint of easily expressing liquid crystallinity and availability of raw materials, it is preferable that the spacer group represented by SP1 has at least one structure selected from the group consisting of an oxyethylene structure, an oxypropylene structure, a polysiloxane structure, and an alkylene fluoride structure.

It is preferable that SP21B is a single bond or a linear or branched alkylene group having 2 to 20 carbon atoms. However, the above-described alkylene group may include —O—, —O—CO—, —CO—O—, or —O—CO—O—.

Among these, from the viewpoint of further increasing the alignment degree of the light absorption anisotropic layer A, the spacer group represented by SP21B is preferably a single bond. In other words, it is preferable that the repeating unit 21 has a structure in which EWG which the electron-withdrawing group in Formula (LCP-21) is directly linked to MG21 which is the mesogen group in Formula (LCP-21). In this manner, it is presumed that, in a case where the electron-withdrawing group is directly linked to the mesogen group, the intermolecular interaction due to an appropriate dipole moment works more effectively in the high-molecular-weight liquid crystalline compound, and the orientation in which the liquid crystals are aligned is more uniform, and as a result, the degree of order of the liquid crystals and the alignment degree are considered to be high.

EWG represents an electron-withdrawing group having a σp value of more than 0. Examples of the electron-withdrawing group having a σp value of more than 0 include an ester group (specifically, a group represented by *—C(O)O—R^{E}), a (meth)acryloyl group, a (meth)acryloyloxy group, a carboxy group, a cyano group, a nitro group, a sulfo group, —S(O)(O)—OR^{E}, —S(O)(O)—R^{E}, —O—S(O)(O)—R^{E}, an acyl group (specifically, a group represented by *—C(O)R^{E}), an acyloxy group (specifically, a group represented by *—OC(O)R^{E}), an isocyanate group (—N═C(O)), *—C(O)N(R^{F})₂, a halogen atom, and an alkyl group substituted with any of these groups (preferably having 1 to 20 carbon atoms). In each of the above-described groups, * represents a bonding position to SP21B. R^{E} represents an alkyl group having 1 to 20 carbon atoms (preferably 1 to 4 carbon atoms and more preferably 1 or 2 carbon atoms). R^{F}'s each independently represents a hydrogen atom or an alkyl group having 1 to 20 carbon atoms (preferably 1 to 4 carbon atoms and more preferably 1 or 2 carbon atoms).

Among the above-described groups, from the viewpoint of further exhibiting the effect of the present invention, it is preferable that EWG is a group represented by *—C(O)O—R^{E} a (meth)acryloyloxy group, a cyano group, or a nitro group.

From the viewpoint that the high-molecular-weight liquid crystalline compound and the dichroic coloring agent can be uniformly aligned while maintaining a high alignment degree of the light absorption anisotropic layer A, a content of the repeating unit (21) is preferably 60% by mass or less, more preferably 50% by mass or less, and still more preferably 45% by mass or less with respect to all repeating units (100% by mass) of the high-molecular-weight liquid crystalline compound.

From the viewpoint of further exhibiting the effect of the present invention, the lower limit of the content of the repeating unit (21) is preferably 1% by mass or more and more preferably 3% by mass or more with respect to all repeating units (100% by mass) of the high-molecular-weight liquid crystalline compound.

In the present invention, the content of each repeating unit included in the high-molecular-weight liquid crystalline compound is calculated based on the charged amount (mass) of each monomer used for obtaining each repeating unit.

The high-molecular-weight liquid crystalline compound may include only one of the repeating unit (21), or two or more kinds of the repeating units (21). In a case where the high-molecular-weight liquid crystalline compound includes two or more kinds of repeating units (21), there is an advantage in that solubility of the high-molecular-weight liquid crystalline compound in a solvent is improved and the liquid crystal phase transition temperature is easily adjusted. In the case where the high-molecular-weight liquid crystalline compound includes two or more kinds of repeating units (21), it is preferable that the total amount thereof is within the above-described range.

In the case where the high-molecular-weight liquid crystalline compound includes two or more kinds of repeating units (21), a repeating unit (21) which does not include a crosslinkable group in EWG and a repeating unit (21) which includes a polymerizable group in EWG may be used in combination. In this manner, curing properties of the light absorption anisotropic layer A are further improved. As the crosslinkable group, a vinyl group, a butadiene group, a (meth)acryloyl group, a (meth)acrylamide group, a vinyl acetate group, a fumaric acid ester group, a styryl group, a vinylpyrrolidone group, a maleic acid anhydride, a maleimide group, a vinyl ether group, an epoxy group, or an oxetanyl group is preferable.

In this case, from the viewpoint of balance between the curing properties and the alignment degree of the light absorption anisotropic layer A, a content of the repeating unit (21) including a polymerizable group in EWG is preferably 1% to 30% by mass with respect to all repeating units (100% by mass) of the high-molecular-weight liquid crystalline compound.

Hereinafter, examples of the repeating unit (21) are shown below, but the repeating unit (21) is not limited to the following repeating units.

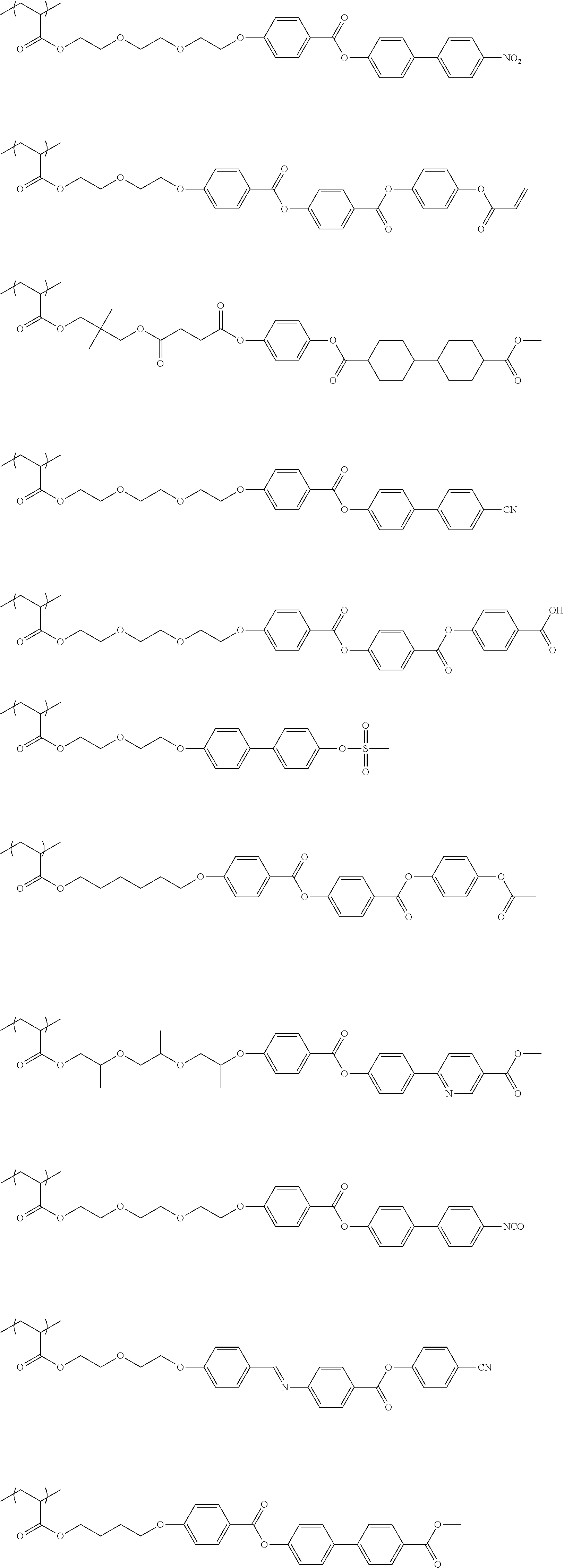

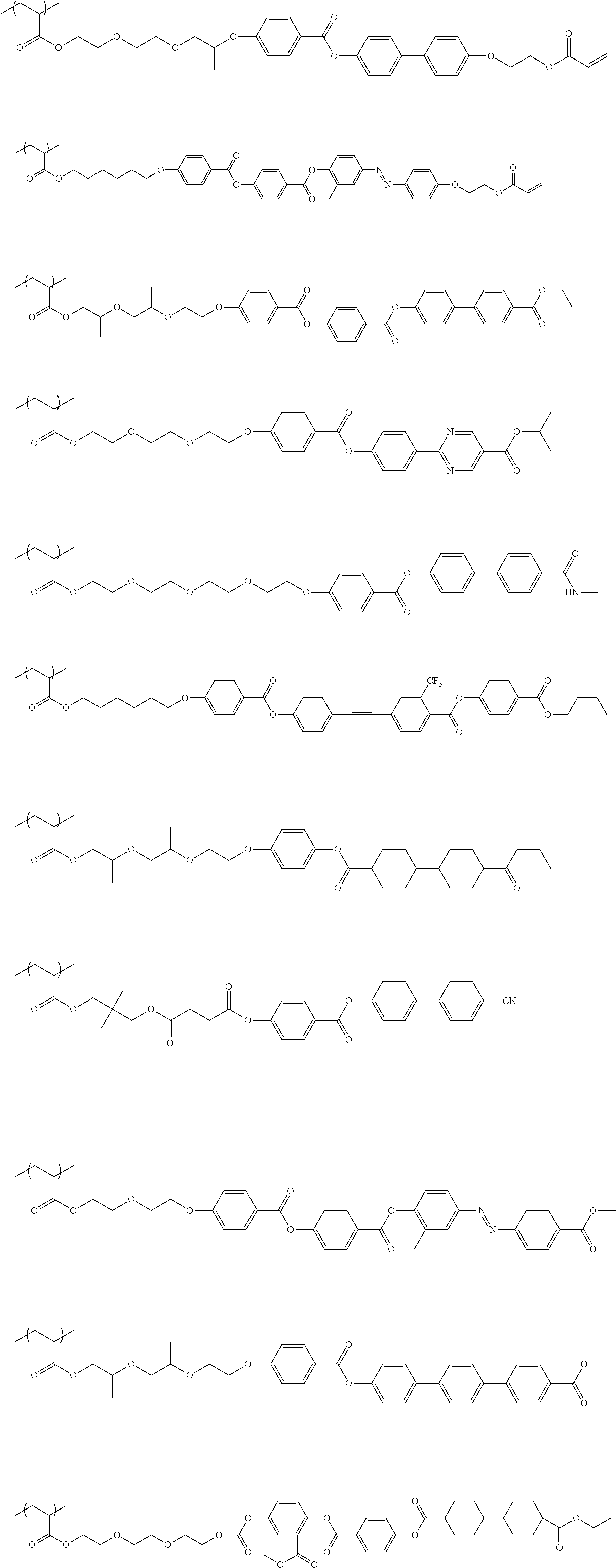

As a result of intensive studies on composition (content ratio) and electron-donating property and electron-withdrawing property of the terminal groups in the repeating unit (21) and the repeating unit (22), the present inventors have found that the alignment degree of the light absorption anisotropic layer A is further increased by decreasing the content ratio of the repeating unit (21) in a case where the electron-withdrawing property of the electron-withdrawing group of the repeating unit (21) is high (that is, in a case where the op value is large) and that the alignment degree of the light absorption anisotropic layer A is further increased by increasing the content ratio of the repeating unit (21) in a case where the electron-withdrawing property of the electron-withdrawing group of the repeating unit (21) is low (that is, in a case where the σp value is close to 0).

The details of the reason for this are not clear, but it is presumed as follows. That is, it is presumed that, since the intermolecular interaction due to an appropriate dipole moment works in the high-molecular-weight liquid crystalline compound, the orientation in which the liquid crystals are aligned is more uniform, and as a result, the degree of order of the liquid crystals and the alignment degree of the light absorption anisotropic layer A are considered to be high.

Specifically, the product of the σp value of the above-described electron-withdrawing group (EWG in Formula (LCP-21)) in the repeating unit (21) and the content ratio (on a mass basis) of the repeating unit (21) to the high-molecular-weight liquid crystalline compound is preferably 0.020 to 0.150, more preferably 0.050 to 0.130, and still more preferably 0.055 to 0.125. In a case where the above-described product is within the above-described range, the alignment degree of the light absorption anisotropic layer A is further increased.

The repeating unit (22) has a mesogen group and a group which is present at the terminal of the mesogen group and has a σp value of 0 or less. In a case where the high-molecular-weight liquid crystalline compound has the repeating unit (22), the high-molecular-weight liquid crystalline compound and the dichroic coloring agent can be uniformly aligned.

The mesogen group is a group representing a main skeleton of a liquid crystal molecule which contributes to liquid crystal formation, the details thereof are as described in MG of Formula (LCP-22) described below, and specific examples thereof are also the same as described below.

The above-described group is positioned at the terminal of the mesogen group and has a σp value of 0 or less. Examples of the above-described group (a group having a σp value of 0 or less) include a hydrogen atom having a σp value of 0, and a group (electron-donating group) which has a σp value of less than 0 and is represented by T22 in Formula (LCP-22) described below. Among the above-described groups, specific examples of the group (electron-donating group) having a σp value of less than 0 are the same as those for T22 in Formula (LCP-22) described below.

The σp value of the above-described group is 0 or less, and from the viewpoint that the uniformity of alignment is more excellent, it is preferably less than 0, more preferably −0.1 or less, and still more preferably −0.2 or less. The lower limit value of the σp value of the above-described group is preferably −0.9 or more and more preferably −0.7 or more.

The repeating unit (22) is not particularly limited as long as it has, at a side chain thereof, the mesogen group and the group which is present at the terminal of the mesogen group and has a σp value of 0 or less, and from the viewpoint of further increasing the uniformity of alignment of liquid crystal, a repeating unit represented by Formula (PCP-22), which does not correspond to the above-described repeating unit represented by Formula (LCP-21), is preferable.

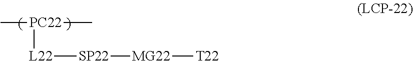

In Formula (LCP-22), PC22 represents a main chain of the repeating unit, and more specifically represents the same structure as that for PC1 in Formula (1) described above; L22 represents a single bond or a divalent linking group, and more specifically represents the same structure as that for L1 in Formula (1) described above; SP22 represents a spacer group, and more specifically represents the same structure as that for SP1 in Formula (1) described above; MG22 represents a mesogen structure, and more specifically represents the same structure as the mesogen group MG in Formula (LC) described above; and T22 represents an electron-donating group having a Hammett's substituent constant σp value of less than 0.

T22 represents an electron-donating group having a σp value of less than 0. Examples of the electron-donating group having a σp value of less than 0 include a hydroxy group, an alkyl group having 1 to 10 carbon atoms, an alkoxy group having 1 to 10 carbon atoms, and an alkylamino group having 1 to 10 carbon atoms.

In a case where the number of atoms in the main chain of T22 is 20 or less, the alignment degree of the light absorption anisotropic layer A is further improved. Here, the “main chain” of T22 means the longest molecular chain bonded to MG22, and the number of hydrogen atoms is not included in the number of atoms in the main chain of T22. For example, in a case where T22 is an n-butyl group, the number of atoms in the main chain is 4, and in a case where T22 is an sec-butyl group, the number of atoms in the main chain is 3.

Hereinafter, examples of the repeating unit (22) are shown below, but the repeating unit (22) is not limited to the following repeating units.

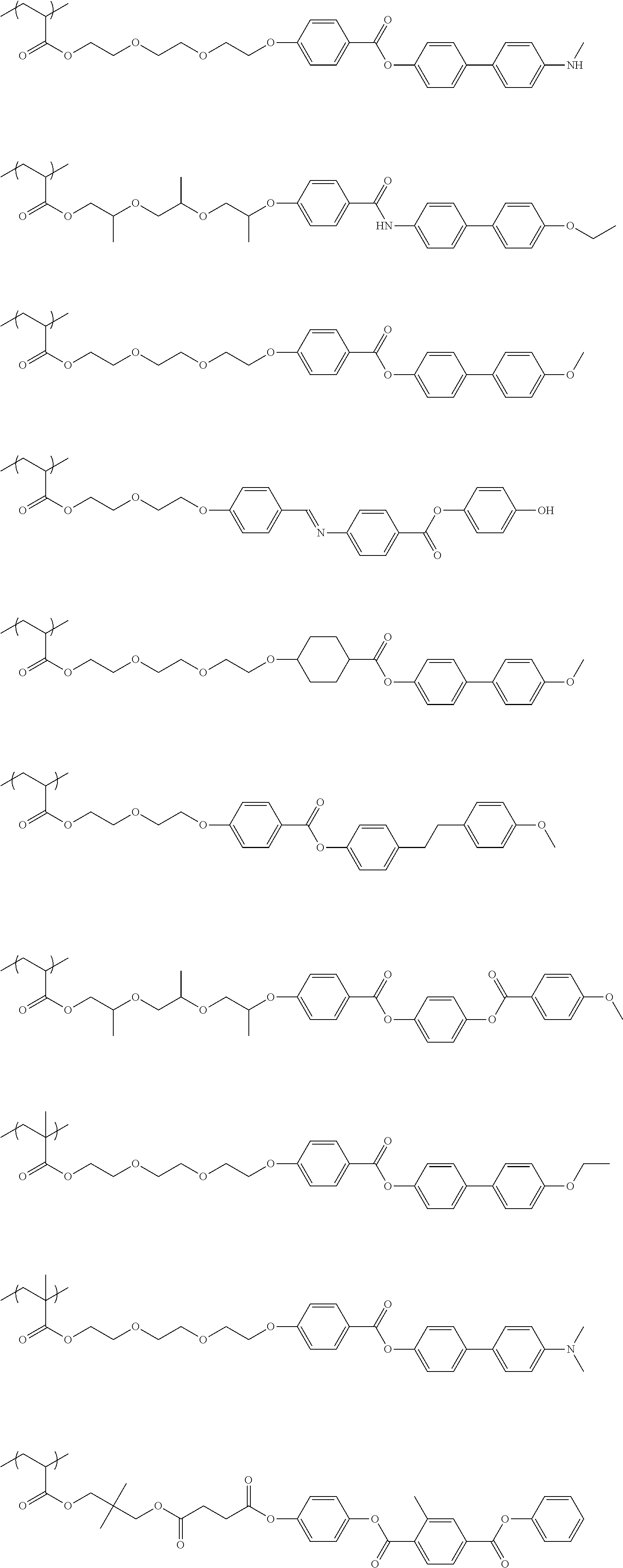

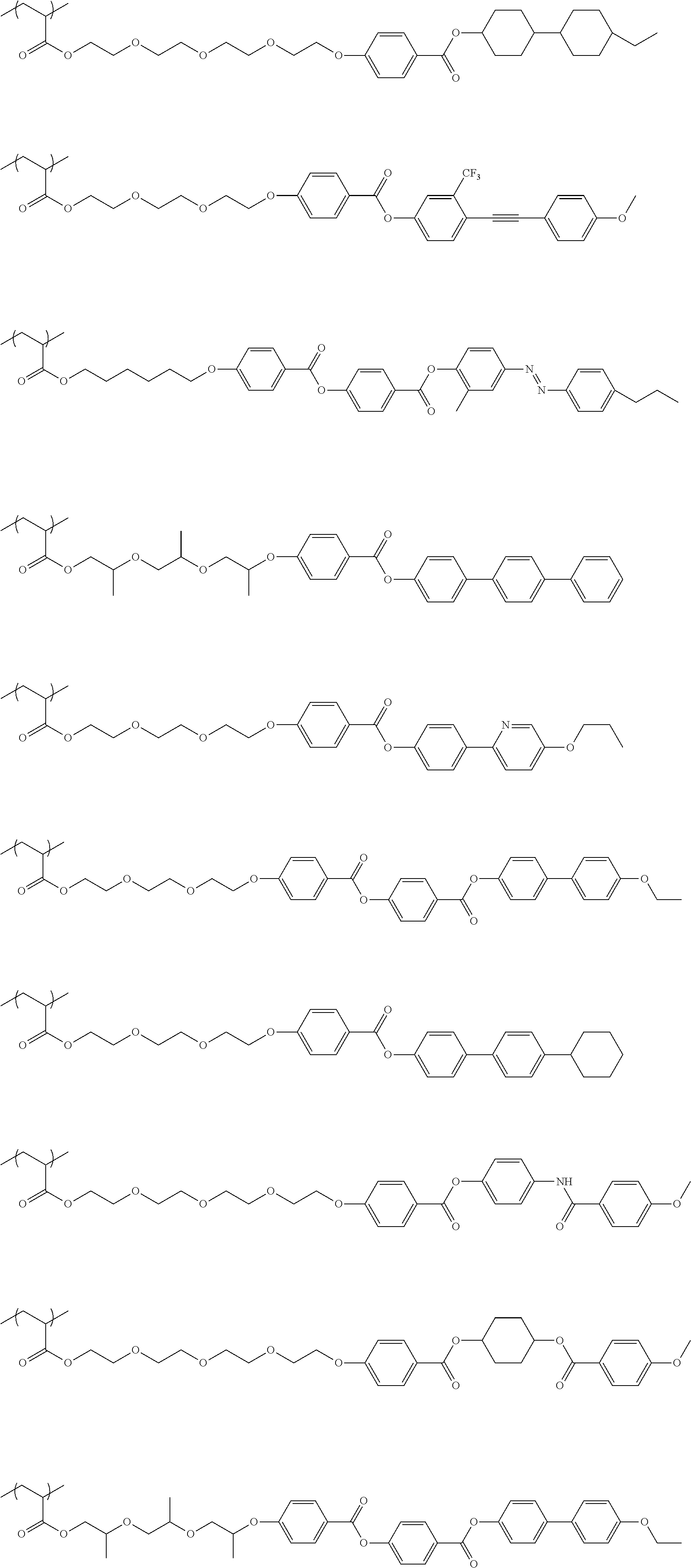

It is preferable that the structures of the repeating unit (21) and the repeating unit (22) have a part in common. It is presumed that the liquid crystals are uniformly aligned as the structures of repeating units are more similar to each other. In this manner, the alignment degree of the light absorption anisotropic layer A is further improved.

Specifically, from the viewpoint of further increasing the alignment degree of the light absorption anisotropic layer A, it is preferable to satisfy at least one of a condition that SP21A of Formula (LCP-21) has the same structure as that for SP22 of Formula (LCP-22), a condition that MG21 of Formula (LCP-21) has the same structure as that for MG22 of Formula (LCP-22), or a condition that L21 of Formula (LCP-21) has the same structure as that for L22 of Formula (LCP-22); more preferable to satisfy two or more of the conditions; and particularly preferable to satisfy all the conditions.

From the viewpoint that the uniformity of alignment is excellent, a content of the repeating unit (22) is preferably 500% by mass or more preferably 55% or more, and still more preferably 600% or more with respect to all repeating units (100% by mass) of the high-molecular-weight liquid crystalline compound.

From the viewpoint of improving the alignment degree, the upper limit value of the content of the repeating unit (22) is preferably 990 by mass or less and more preferably 9700 by mass or less with respect to all repeating units (100% by mass) of the high-molecular-weight liquid crystalline compound.

The high-molecular-weight liquid crystalline compound may include only one of the repeating unit (22), or two or more kinds of the repeating units (22). In a case where the high-molecular-weight liquid crystalline compound includes two or more kinds of repeating units (22), there is an advantage in that solubility of the high-molecular-weight liquid crystalline compound in a solvent is improved and the liquid crystal phase transition temperature is easily adjusted. In the case where the high-molecular-weight liquid crystalline compound includes two or more kinds of repeating units (22), it is preferable that the total amount thereof is within the above-described range.

From the viewpoint of improving solubility in a general-purpose solvent, the high-molecular-weight liquid crystalline compound can include a repeating unit (3) not containing a mesogen. Particularly, in order to improve the solubility while suppressing a decrease in alignment degree, it is preferable that the repeating unit (3) not containing a mesogen is a repeating unit having a molecular weight of 280 or less. As described above, the reason why the solubility is improved while a decrease in alignment degree is suppressed by including the repeating unit having a molecular weight of 280 or less, which does not contain a mesogen, is presumed as follows.

That is, it is considered that, in a case where the high-molecular-weight liquid crystalline compound includes the repeating unit (3) not containing a mesogen in a molecular chain thereof, since a solvent is likely to enter the high-molecular-weight liquid crystalline compound, the solubility is improved, but the alignment degree is decreased due to the non-mesogenic repeating unit (3). However, it is presumed that, since the molecular weight of the above-described repeating unit is small, the alignment of the repeating unit (1), the repeating unit (21), or the repeating unit (22) described above, which contains the mesogen group, is unlikely to be disturbed, and thus the decrease in the alignment degree is suppressed.

It is preferable that the above-described repeating unit (3) is a repeating unit having a molecular weight of 280 or less.

The molecular weight of the repeating unit (3) does not indicate a molecular weight of a monomer used to obtain the repeating unit (3), but indicates the molecular weight of the repeating unit (3) in a state of being incorporated into the high-molecular-weight liquid crystalline compound by polymerization of the monomer.

The molecular weight of the repeating unit (3) is preferably 280 or less, more preferably 180 or less, and still more preferably 100 or less. The lower limit value of the molecular weight of the repeating unit (3) is commonly 40 or more, and preferably 50 or more. In a case where the molecular weight of the repeating unit (3) is 280 or less, a light absorption anisotropic layer A having more excellent solubility of the high-molecular-weight liquid crystalline compound and having a higher alignment degree can be obtained.

Specific examples of the repeating unit (3) include a repeating unit which does not include a crosslinkable group (for example, an ethylenically unsaturated group) (hereinafter, also referred to as “repeating unit (3-1)”), and a repeating unit which includes the crosslinkable group (hereinafter, also referred to as “repeating unit (3-2)”).

Specific examples of a monomer used for polymerization of the repeating unit (3-1) include acrylic acid [72.1], α-alkylacrylic acids (such as methacrylic acid [86.1] and itaconic acid [130.1]), esters and amides derived from these acids (such as N-i-propylacrylamide [113.2], N-n-butylacrylamide [127.2], N-t-butylacrylamide [127.2], N,N-dimethylacrylamide [99.1], N-methylmethacrylamide [99.1], acrylamide [71.1], methacrylamide [85.1], diacetoneacrylamide [169.2], acryloylmorpholine [141.2], N-methylol acrylamide [101.1], N-methylol methacrylamide [115.1], methyl acrylate [86.0], ethyl acrylate [100.1], hydroxyethyl acrylate [116.1], n-propyl acrylate [114.1], i-propyl acrylate [114.2], 2-hydroxypropyl acrylate [130.1], 2-methyl-2-nitropropyl acrylate [173.2], n-butyl acrylate [128.2], i-butyl acrylate [128.2], t-butyl acrylate [128.2], t-pentyl acrylate [142.2], 2-methoxyethyl acrylate [130.1], 2-ethoxyethyl acrylate [144.2], 2-ethoxyethoxyethyl acrylate [188.2], 2,2,2-trifluoroethyl acrylate [154.1], 2,2-dimethylbutyl acrylate [156.2], 3-methoxybutyl acrylate [158.2], ethyl carbitol acrylate [188.2], phenoxyethyl acrylate [192.2], n-pentyl acrylate [142.2], n-hexyl acrylate [156.2], cyclohexyl acrylate [154.2], cyclopentyl acrylate [140.2], benzyl acrylate [162.2], n-octyl acrylate [184.3], 2-ethylhexyl acrylate [184.3], 4-methyl-2-propylpentyl acrylate [198.3], methyl methacrylate [100.1], 2,2,2-trifluoroethyl methacrylate [168.1], hydroxyethyl methacrylate [130.1], 2-hydroxypropyl methacrylate [144.2], n-butyl methacrylate [142.2], i-butyl methacrylate [142.2], sec-butyl methacrylate [142.2], n-octyl methacrylate [198.3], 2-ethylhexyl methacrylate [198.3], 2-methoxyethyl methacrylate [144.2], 2-ethoxyethyl methacrylate [158.2], benzyl methacrylate [176.2], 2-norbornyl methyl methacrylate [194.3], 5-norbornen-2-ylmethyl methacrylate [194.3], and dimethylaminoethyl methacrylate [157.2]), vinyl esters (such as vinyl acetate [86.1]), esters derived from maleic acid or fumaric acid (such as dimethyl maleate [144.1] and diethyl fumarate [172.2]), maleimides (such as N-phenylmaleimide [173.2]), maleic acid [116.1], fumaric acid [116.1], p-styrenesulfonic acid [184.1], acrylonitrile [53.1], methacrylonitrile [67.1], dienes (such as butadiene [54.1], cyclopentadiene [66.1], and isoprene [68.1]), aromatic vinyl compounds (such as styrene [104.2], p-chlorostyrene [138.6], t-butylstyrene [160.3], and α-methylstyrene [118.2]), N-vinylpyrrolidone [111.1], N-vinyloxazolidone [113.1], N-vinyl succinimide [125.1], N-vinylformamide [71.1], N-vinyl-N-methylformamide [85.1], N-vinylacetamide [85.1], N-vinyl-N-methylacetamide [99.1], 1-vinylimidazole [94.1], 4-vinylpyridine [105.2], vinylsulfonic acid [108.1], sodium vinyl sulfonate [130.2], sodium allyl sulfonate [144.1], sodium methallyl sulfonate [158.2], vinylidene chloride [96.9], vinyl alkyl ethers (such as methyl vinyl ether [58.1]), ethylene [28.0], propylene [42.1], 1-butene [56.1], and isobutene [56.1]. The numerical value in [ ] indicates the molecular weight of the monomer.

The above-described monomer may be used alone, or in combination of two or more kinds thereof.

Among the above-described monomers, acrylic acid, α-alkylacrylic acids, esters and amides derived from these acids, acrylonitrile, methacrylonitrile, or aromatic vinyl compounds are preferable.

As monomers other than the above-described monomers, compounds described in Research Disclosure No. 1955 (July, 1980) can be used.

Hereinafter, specific examples of the repeating unit (3-1) and molecular weights thereof are shown below, but the present invention is not limited to these specific examples.

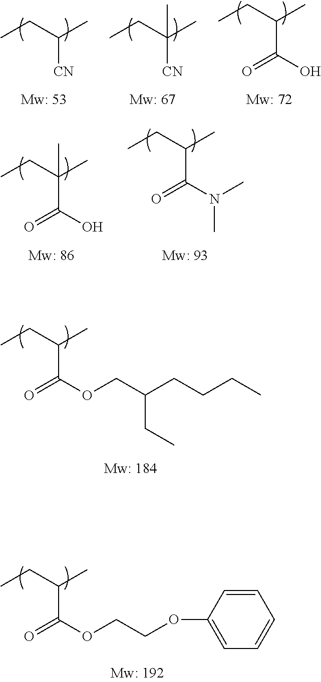

Specific examples of the crosslinkable group in the repeating unit (3-2) include the crosslinkable groups represented by Formulae (P-1) to (P-30) described above. Among these, a vinyl group, a butadiene group, a (meth)acryloyl group, a (meth)acrylamide group, a vinyl acetate group, a fumaric acid ester group, a styryl group, a vinylpyrrolidone group, a maleic acid anhydride, a maleimide group, a vinyl ether group, an epoxy group, or an oxetanyl group is more preferable.

From the viewpoint of easily carrying out the polymerization, it is preferable that the repeating unit (3-2) is a repeating unit represented by Formula (3).

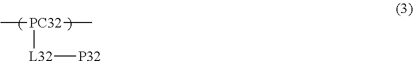

In Formula (3), PC32 represents a main chain of a repeating unit, and more specifically represents the same structure as that for PC1 in Formula (1) described above; L32 represents a single bond or a divalent linking group, and more specifically represents the same structure as that for L1 in Formula (1) described above; and P32 represents a crosslinkable group represented by any of Formulae (P-1) to (P-30).

Hereinafter, specific examples of the repeating unit (3-2) and weight-average molecular weights (Mw) thereof are shown below, but the present invention is not limited to these specific examples.

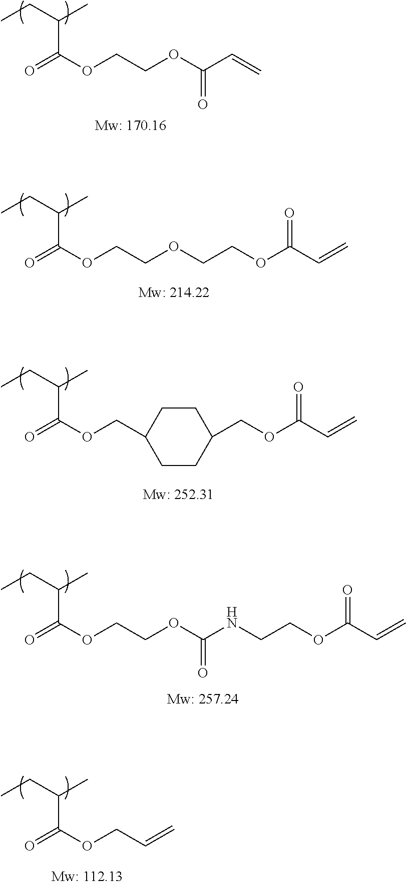

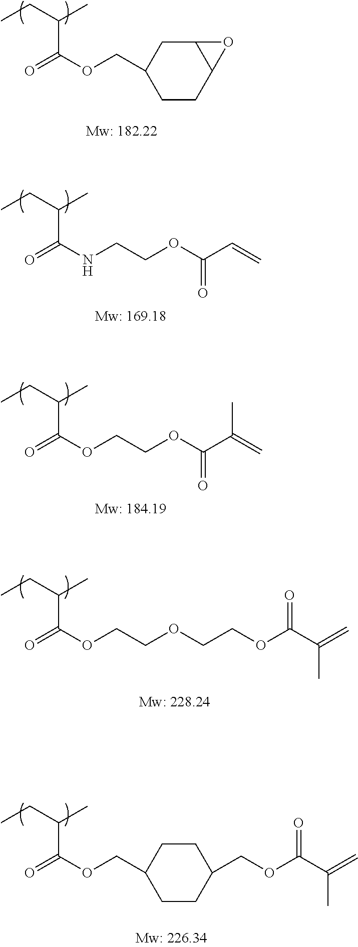

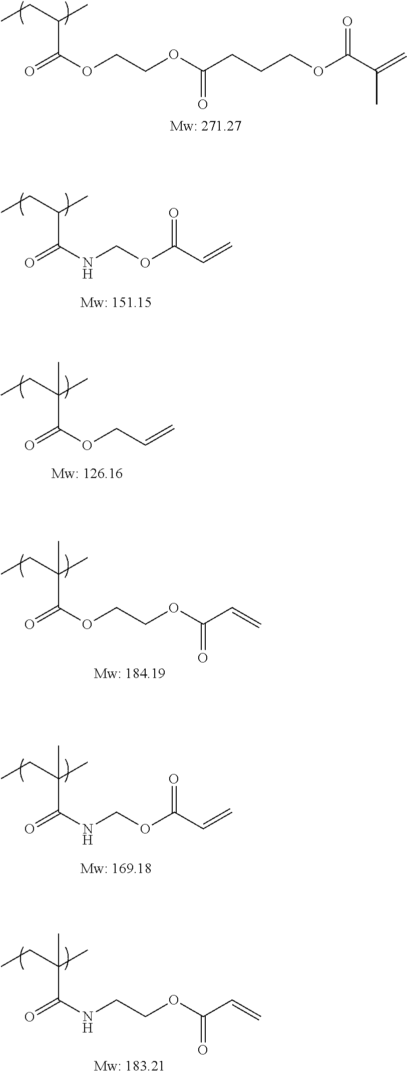

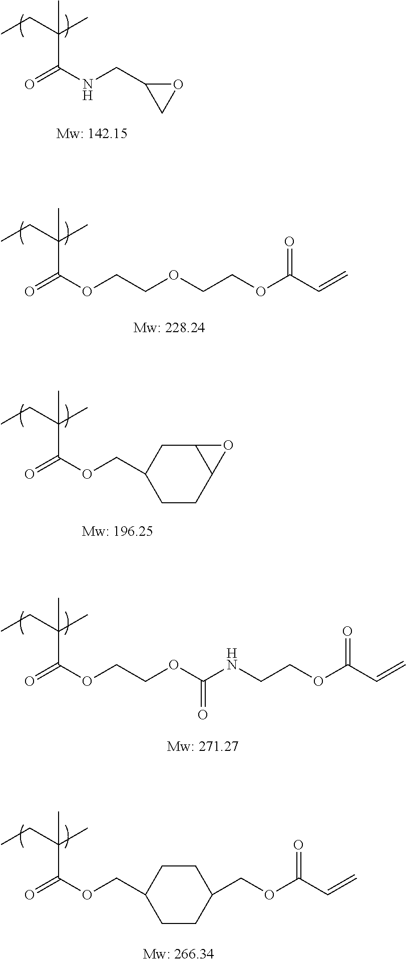

A content of the repeating unit (3) is preferably less than 14% by mass, more preferably 7% by mass or less, and still more preferably 5% by mass or less with respect to all repeating units (100% by mass) of the high-molecular-weight liquid crystalline compound. The lower limit value of the content of the repeating unit (3) is preferably 2% by mass or more and more preferably 3% by mass or more with respect to all repeating units (100% by mass) of the high-molecular-weight liquid crystalline compound. In a case where the content of the repeating unit (3) is less than 14% by mass, the alignment degree of the light absorption anisotropic layer A is further improved. In a case where the content of the repeating unit (3) is 2% by mass or more, the solubility of the high-molecular-weight liquid crystalline compound is further improved.

The high-molecular-weight liquid crystalline compound may include only one of the repeating unit (3), or two or more kinds of the repeating units (3). In the case where the high-molecular-weight liquid crystalline compound includes two or more kinds of repeating units (3), it is preferable that the total amount thereof is within the above-described range.

From the viewpoint of improving adhesiveness and planar uniformity, the high-molecular-weight liquid crystalline compound may include a repeating unit (4) having a flexible structure with a long molecular chain (SP4 in Formula (4) described below). The reason for this is presumed as follows.

That is, in a case where the high-molecular-weight liquid crystalline compound has such a flexible structure with a long molecular chain, entanglement of the molecular chains constituting the high-molecular-weight liquid crystalline compound is likely to occur, and aggregation destruction of the light absorption anisotropic layer A (specifically, destruction of the light absorption anisotropic layer A itself) is suppressed. As a result, it is presumed that adhesiveness between the light absorption anisotropic layer A and an underlayer (for example, a base material or an alignment film) is improved. In addition, it is considered that a decrease in planar uniformity occurs due to low compatibility between the dichroic coloring agent and the high-molecular-weight liquid crystalline compound. That is, it is considered that, in a case where the compatibility between the dichroic coloring agent and the high-molecular-weight liquid crystalline compound is not sufficient, a planar defect (alignment defect) having the dichroic coloring agent to be precipitated as a nucleus occurs. On the other hand, it is presumed that, in the case where the high-molecular-weight liquid crystalline compound has such a flexible structure with a long molecular chain, a light absorption anisotropic layer A in which precipitation of the dichroic coloring agent is suppressed and the planar uniformity is excellent is obtained. Here, the expression “planar uniformity is excellent” denotes that the alignment defect occurring in a case where the liquid crystalline composition containing the high-molecular-weight liquid crystalline compound is repelled on the underlayer (for example, the base material or the alignment film) is less likely to occur.

The above-described repeating unit (4) is a repeating unit represented by Formula (4).

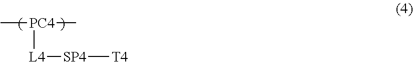

In Formula (4), PC4 represents a main chain of a repeating unit, and more specifically represents the same structure as that for PC1 in Formula (1) described above; L4 represents a single bond or a divalent linking group, and more specifically represents the same structure as that for L1 in Formula (1) described above (preferably a single bond); SP4 represents an alkylene group having 10 or more atoms in the main chain; and T4 represents a terminal group, and more specifically represents the same structure as that for T1 in Formula (1) described above.

Specific examples and suitable aspects of PC4 are the same as those for PC1 in Formula (1), and thus the description thereof will not be repeated.

From the viewpoint of further exhibiting the effect of the present invention, L4 is preferably a single bond.

In Formula (4), SP4 represents an alkylene group having 10 or more atoms in the main chain. Here, one or more of —CH₂—'s constituting the alkylene group represented by SP4 may be replaced with “SP-C” described above, and particularly preferably replaced with at least one group selected from the group consisting of —O—, —S—, —N(R²¹)—, —C(═O)—, —C(═S)—, —C(R²²)═C(R²³)—, an alkynylene group, —Si(R²⁴)(R²⁵)—, —N═N—, —C(R²⁶)═N—N═C(R²⁷)—, —C(R²⁸)═N—, and —S(═O)₂—. In addition, R²¹ to R²⁸ each independently represent a hydrogen atom, a halogen atom, a cyano group, a nitro group, or a linear or branched alkyl group having 1 to 10 carbon atoms. In addition, the hydrogen atoms included in one or more of —CH₂—'s constituting the alkylene group represented by SP4 may be replaced with “SP-H” described above.

The number of atoms in the main chain of SP4 is 10 or more, and from the viewpoint of obtaining a light absorption anisotropic layer A in which at least one of the adhesiveness or the planar uniformity is more excellent, the number of atoms thereof is preferably 15 or more and more preferably 19 or more. In addition, from the viewpoint of obtaining a light absorption anisotropic layer A with a more excellent alignment degree, the upper limit of the number of atoms in the main chain of SP4 is preferably 70 or less, more preferably 60 or less, and still more preferably 50 or less.

Here, the “main chain” of SP4 means a partial structure required for directly linking L4 and T4 to each other, and the “number of atoms in the main chain” means the number of atoms constituting the partial structure.

In other words, the “main chain” of SP4 is a partial structure in which the number of atoms linking L4 and T4 to each other is the smallest. For example, in a case where SP4 is a 3,7-dimethyldecanyl group, the number of atoms in the main chain is 10, and in a case where SP4 is a 4,6-dimethyldodecanyl group, the number of atoms in the main chain is 12. In addition, in Formula (4-1), the inside of the frame shown by the dotted quadrangle corresponds to SP4, and the number of atoms in the main chain of SP4 (corresponding to the total number of atoms circled by the dotted line) is 11.

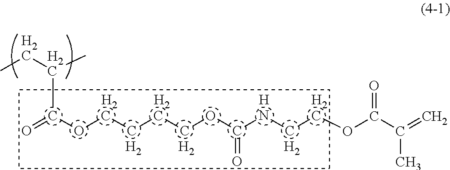

The alkylene group represented by SP4 may be linear or branched.

From the viewpoint of obtaining a light absorption anisotropic layer A with a more excellent alignment degree, the number of carbon atoms in the alkylene group represented by SP4 is preferably 8 to 80, more preferably 15 to 80, still more preferably 25 to 70, and particularly preferably 25 to 60.

From the viewpoint of obtaining a light absorption anisotropic layer A with more excellent adhesiveness and planar uniformity, it is preferable that one or more of —CH₂—'s constituting the alkylene group represented by SP4 are replaced with “SP-C” described above.

In addition, in a case of a plurality of —CH₂—'s constituting the alkylene group represented by SP4, from the viewpoint of obtaining a light absorption anisotropic layer A with more excellent adhesiveness and planar uniformity, it is more preferable that only some of the plurality of —CH₂—'s are replaced with “SP-C” described above.

Among “SP-C”, at least one group selected from the group consisting of —O—, —S—, —N(R²¹)—, —C(═O)—, —C(═S)—, —C(R²²)═C(R²³)—, an alkynylene group, —Si(R²⁴)(R²⁵)—, —N═N—, —C(R²⁶)═N—N═C(R²⁷)—, —C(R²⁸)═N—, and —S(═O)₂— is preferable; and from the viewpoint of obtaining a light absorption anisotropic layer A with more excellent adhesiveness and planar uniformity, at least one group selected from the group consisting of —O—, —N(R²¹)—, —C(═O)—, and —S(═O)₂— is more preferable, and at least one group selected from the group consisting of —O—, —N(R²¹)—, and —C(═O)— is particularly preferable. R²¹ to R²⁸ each independently represent a hydrogen atom, a halogen atom, a cyano group, a nitro group, or a linear or branched alkyl group having 1 to 10 carbon atoms.

Particularly, it is preferable that SP4 is a group having at least one selected from the group consisting of an oxyalkylene structure in which one or more of —CH₂—'s constituting an alkylene group are replaced with —O—, an ester structure in which one or more of —CH₂—CH₂—'s constituting an alkylene group are replaced with —O— or —C(═O)—, and a urethane bond in which one or more of —CH₂—CH₂—CH₂—'s constituting an alkylene group are replaced with —O—, —C(═O)—, or —NH—.

The hydrogen atoms included in one or more of —CH₂—'s constituting the alkylene group represented by SP4 may be replaced with “SP-H” described above. In this case, one or more hydrogen atoms included in —CH₂— may be replaced with “SP-H”. That is, only one hydrogen atom included in —CH₂— may be replaced with “SP-H”, or all (two) hydrogen atoms included in —CH₂— may be replaced with “SP-H”.

Among “SP-H”, at least one group selected from the group consisting of a halogen atom, a cyano group, a nitro group, a hydroxy group, a linear alkyl group having 1 to 10 carbon atoms, a branched alkyl group having 1 to 10 carbon atoms, and a halogenated alkyl group having 1 to 10 carbon atoms is preferable; and at least one group selected from the group consisting of a hydroxy group, a linear alkyl group having 1 to 10 carbon atoms, and a branched alkyl group having 1 to 10 carbon atoms is more preferable.

As described above, T4 represents the same terminal group as that for T1, and is preferably a hydrogen atom, a methyl group, a hydroxy group, a carboxy group, a sulfonic acid group, a phosphoric acid group, a boronic acid group, an amino group, a cyano group, a nitro group, a phenyl group which may have a substituent, or -L-CL (L represents a single bond or a divalent linking group, and specific examples of the divalent linking group are the same as those for LW and SPW described above; CL represents a crosslinkable group, examples thereof include the group represented by Q1 or Q2 described above, and a crosslinkable group represented by any of Formulae (P-1) to (P-30) is preferable), in which CL is preferably a vinyl group, a butadiene group, a (meth)acryloyl group, a (meth)acrylamide group, a vinyl acetate group, a fumaric acid ester group, a styryl group, a vinylpyrrolidone group, a maleic acid anhydride, a maleimide group, a vinyl ether group, an epoxy group, or an oxetanyl group.

The epoxy group may be an epoxycycloalkyl group, and from the viewpoint that the effect of the present invention is more excellent, the number of carbon atoms in a cycloalkyl group moiety of the epoxycycloalkyl group is preferably 3 to 15, more preferably 5 to 12, and still more preferably 6 (that is, it is still more preferable that the epoxycycloalkyl group is an epoxycyclohexyl group).

Examples of a substituent of the oxetanyl group include an alkyl group having 1 to 10 carbon atoms, and from the viewpoint that the effect of the present invention is more excellent, an alkyl group having 1 to 5 carbon is preferable. The alkyl group as the substituent of the oxetanyl group may be linear or branched, but is preferably linear from the viewpoint that the effect of the present invention is more excellent.

Examples of a substituent of the phenyl group include a boronic acid group, a sulfonic acid group, a vinyl group, and an amino group, and from the viewpoint that the effect of the present invention is more excellent, a boronic acid group is preferable.

Specific examples of the repeating unit (4) include the following structures, but the present invention is not limited thereto. In the following specific examples, n1 represents an integer of 2 or more, and n2 represents an integer of 1 or more.

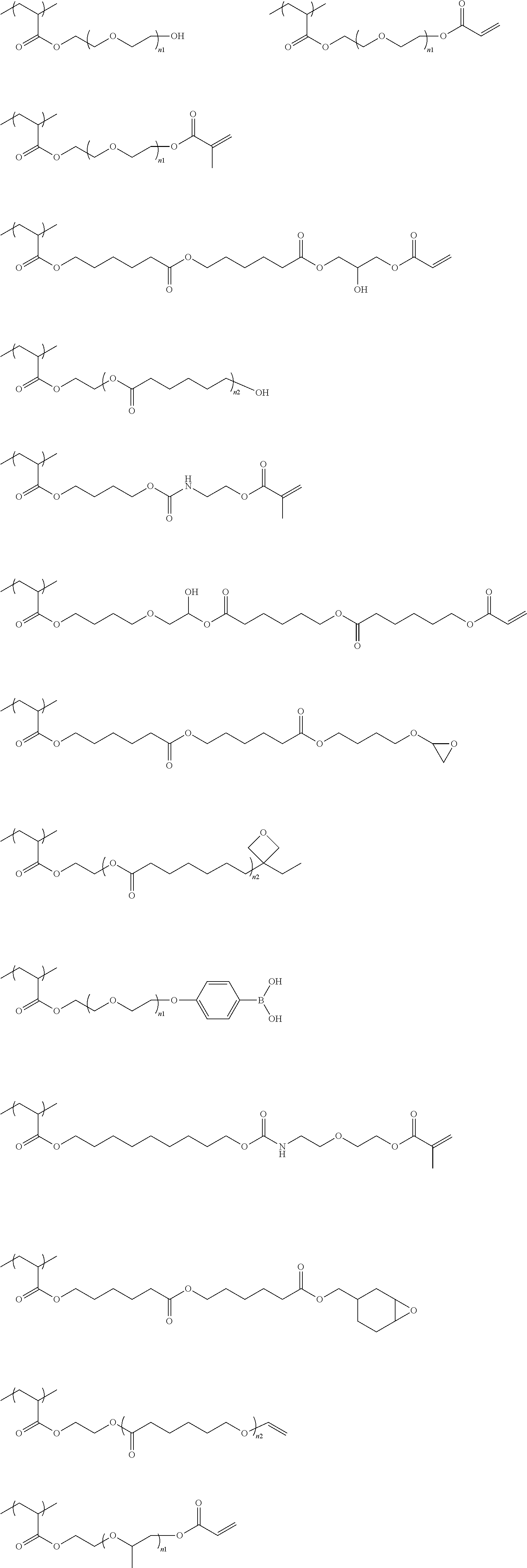

A content of the repeating unit (4) is preferably 2% to 20% by mass and more preferably 3% to 18% by mass with respect to all repeating units (100% by mass) of the high-molecular-weight liquid crystalline compound. In a case where the content of the repeating unit (4) is 2% by mass or more, a light absorption anisotropic layer A having more excellent adhesiveness is obtained. In addition, in a case where the content of the repeating unit (4) is 20% by mass or less, a light absorption anisotropic layer A having more excellent planar uniformity is obtained.

The high-molecular-weight liquid crystalline compound may include only one of the repeating unit (4), or two or more kinds of the repeating units (4). In a case where the high-molecular-weight liquid crystalline compound includes two or more kinds of repeating units (4), the content of the repeating unit (4) indicates the total content of the repeating units (4).

From the viewpoint of the planar uniformity, the high-molecular-weight liquid crystalline compound can include a repeating unit (5) to be introduced by polymerizing a polyfunctional monomer. Particularly, in order to improve the planar uniformity while suppressing a decrease in alignment degree, it is preferable that the high-molecular-weight liquid crystalline compound includes 10% by mass or less of the repeating unit (5) to be introduced by polymerizing a polyfunctional monomer with respect to all repeating units (100% by mass) of the high-molecular-weight liquid crystalline compound. As described above, the reason why the planar uniformity can be improved while a decrease in alignment degree is suppressed by including 10% by mass or less of the repeating unit (5) is presumed as follows.

The repeating unit (5) is a unit to be introduced to the high-molecular-weight liquid crystalline compound by polymerizing a polyfunctional monomer. Therefore, it is considered that the high-molecular-weight liquid crystalline compound includes a high-molecular-weight body in which a three-dimensional crosslinking structure is formed by the repeating unit (5). Here, since the content of the repeating unit (5) is small, the content of the high-molecular-weight body including the repeating unit (5) is considered to be very small.

It is presumed that a light absorption anisotropic layer A in which cissing of a composition for forming the light absorption anisotropic layer A is suppressed and the planar uniformity is excellent is obtained due to the presence of a very small amount of the high-molecular-weight body with the three-dimensional crosslinking structure formed as described above.

In addition, it is presumed that the effect of suppressing a decrease in alignment degree can be maintained because the content of the high-molecular-weight body is very small.

It is preferable that the above-described repeating unit (5) to be introduced by polymerizing a polyfunctional monomer is a repeating unit represented by Formula (5).

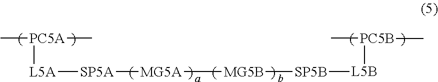

In Formula (5), PC5A and PC5B represent the main chain of the repeating unit, and more specifically represent the same structure as that for PC1 in Formula (1) described above; L5A and L5B represent a single bond or a divalent linking group, and more specifically represents the same structure as that for L1 in Formula (1) described above; SP5A and SP5B represent a spacer group, and more specifically represents the same structure as that for SP1 in Formula (1) described above; MG5A and MG5B represent a mesogen structure, and more specifically represent the same structure as that for the mesogen group MG in Formula (LC) described above; and a and b represent an integer of 0 or 1.

PC5A and PC5B may be the same group or groups different from each other, but from the viewpoint of further improving the alignment degree of the light absorption anisotropic layer A, it is preferable that PC5A and PC5B are the same group.

Both L5A and L5B may be a single bond, the same group, or groups different from each other, but from the viewpoint of further improving the alignment degree of the light absorption anisotropic layer A, both L5A and L5B are preferably a single bond or the same group, and more preferably the same group.

Both SP5A and SP5B may be a single bond, the same group, or groups different from each other, but from the viewpoint of further improving the alignment degree of the light absorption anisotropic layer A, both SP5A and SP5B are preferably a single bond or the same group, and more preferably the same group.

Here, the same group in Formula (5) means that the chemical structures thereof are the same regardless of the orientation in which each group is bonded. For example, even in a case where SP5A is *—CH₂—CH₂—O—** (* represents a bonding position to L5A, and ** represents a bonding position to MG5A) and SP5B is *—O—CH₂—CH₂—** (* represents a bonding position to MG5B, and ** represents a bonding position to L5B), SP5A and SP5B are the same group.
a and b are each independently an integer of 0 or 1, and preferably 1 from the viewpoint of further improving the alignment degree of the light absorption anisotropic layer A.

a and b may be the same or different from each other, but from the viewpoint of further improving the alignment degree of the light absorption anisotropic layer A, it is preferable that both a and b are 1.

From the viewpoint of further improving the alignment degree of the light absorption anisotropic layer A, the sum of a and b is preferably 1 or 2 (that is, the repeating unit represented by Formula (5) has a mesogen group), and more preferably 2.

From the viewpoint of further improving the alignment degree of the light absorption anisotropic layer A, it is preferable that the partial structure represented by -(MG5A)ₐ-(MG5B)_{b}- has a cyclic structure. In this case, from the viewpoint of further improving the alignment degree of the light absorption anisotropic layer A, the number of cyclic structures in the partial structure represented by -(MG5A2)ₐ-(MG5B)_{b}- is preferably 2 or more, more preferably 2 to 8, still more preferably 2 to 6, and particularly preferably 2 to 4.

From the viewpoint of further improving the alignment degree of the light absorption anisotropic layer A, the mesogen groups represented by MG5A and MG5B each independently preferably include one or more cyclic structures, more preferably include 2 to 4 cyclic structures, still more preferably include 2 or 3 cyclic structures, and particularly preferably include 2 cyclic structures.

Specific examples of the cyclic structure include an aromatic hydrocarbon group, a heterocyclic group, and an alicyclic group, and among these, an aromatic hydrocarbon group or an alicyclic group is preferable.

MG5A and MG5B may be the same group or groups different from each other, but from the viewpoint of further improving the alignment degree of the light absorption anisotropic layer A, it is preferable that MG5A and MG5B are the same group.

As the mesogen group represented by MG5A and MG5B, from the viewpoint of expressing the liquid crystallinity, adjusting a liquid crystal phase transition temperature, availability of raw materials, and synthetic suitability, and from the viewpoint that the effect of the present invention is more excellent, the mesogen group MG in Formula (LC) described above is preferable.

Particularly, in the repeating unit (5), it is preferable that PC5A and PC5B are the same group, both L5A and L5B are a single bond or the same group, both SP5A and SP5B are a single bond or the same group, and MG5A and MG5B are the same group. In this manner, the alignment degree of the light absorption anisotropic layer A is further improved.

A content of the repeating unit (5) is preferably 10% by mass or less, more preferably 0.001% to 5% by mass, and still more preferably 0.05% to 3% by mass with respect to the content (100% by mass) of all repeating units of the high-molecular-weight liquid crystalline compound.

The high-molecular-weight liquid crystalline compound may include only one of the repeating unit (5), or two or more kinds of the repeating units (5). In the case where the high-molecular-weight liquid crystalline compound includes two or more kinds of repeating units (5), it is preferable that the total amount thereof is within the above-described range.

The high-molecular-weight liquid crystalline compound may be a star-shaped polymer. The star-shaped polymer in the present invention means a polymer having three or more polymer chains extending from the nucleus, and is specifically a polymer represented by Formula (6).

The star-shaped polymer represented by Formula (6) as the high-molecular-weight liquid crystalline compound can form a light absorption anisotropic layer A having a high alignment degree while having high solubility (excellent solubility in a solvent).

A [symbol] PI)ₙ_{_{A}} (6)

In Formula (6), n_{A} represents an integer of 3 or greater, and preferably an integer of 4 or more. The upper limit value of n_{A} is not limited thereto, but is commonly 12 or less and preferably 6 or less.

A plurality of PI's each independently represent a polymer chain having any of the repeating units represented by Formulae (1), (21), (22), (3), (4), and (5) described above. However, at least one of the plurality of PI's represents a polymer chain having the repeating unit represented by Formula (1) described above.

A represents an atomic group which is the nucleus of the star-shaped polymer. Specific examples of A include structures obtained by removing hydrogen atoms from thiol groups of a polyfunctional thiol compound, described in paragraphs to of JP2011-074280A, paragraphs to of JP2012-189847A, paragraphs to of JP2013-031986A, and paragraphs to of JP2014-104631A. In this case, A and PI are bonded to each other through a sulfide bond.

The number of thiol groups in the above-described polyfunctional thiol compound from which A is derived is preferably 3 or more and more preferably 4 or more. The upper limit value of the number of thiol groups in the polyfunctional thiol compound is commonly 12 or less and preferably 6 or less.

Specific examples of the polyfunctional thiol compound are shown below.

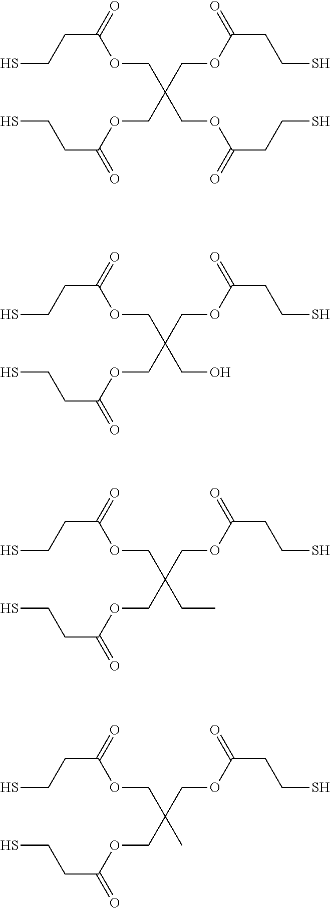 [SMILES: O=C(CCS)OCC(COC(=O)CCS)(COC(=O)CCS)COC(=O)CCS ; O=C(CCS)OCC(CO)(COC(=O)CCS)COC(=O)CCS ; CCC(COC(=O)CCS)(COC(=O)CCS)COC(=O)CCS ; CC(COC(=O)CCS)(COC(=O)CCS)COC(=O)CCS]

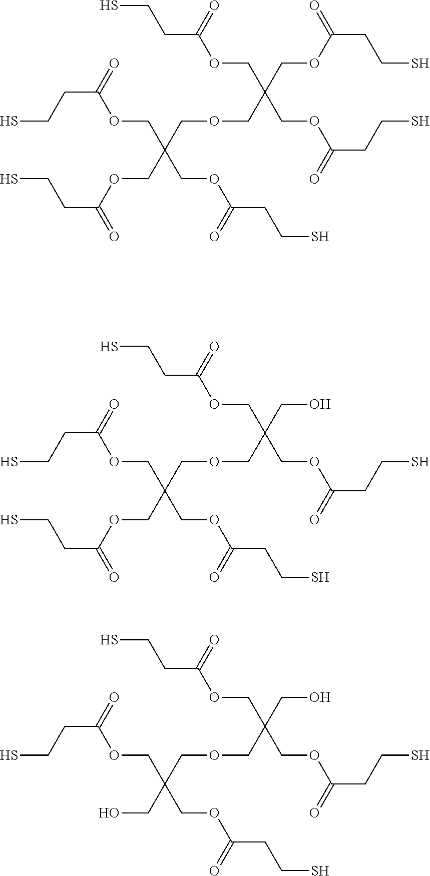 [SMILES: O=C(CCS)OCC(COCC(COC(=O)CCS)(COC(=O)CCS)COC(=O)CCS)(COC(=O)CCS)COC(=O)CCS ; O=C(CCS)OCC(CO)(COCC(COC(=O)CCS)(COC(=O)CCS)COC(=O)CCS)COC(=O)CCS ; O=C(CCS)OCC(CO)(COCC(CO)(COC(=O)CCS)COC(=O)CCS)COC(=O)CCS]

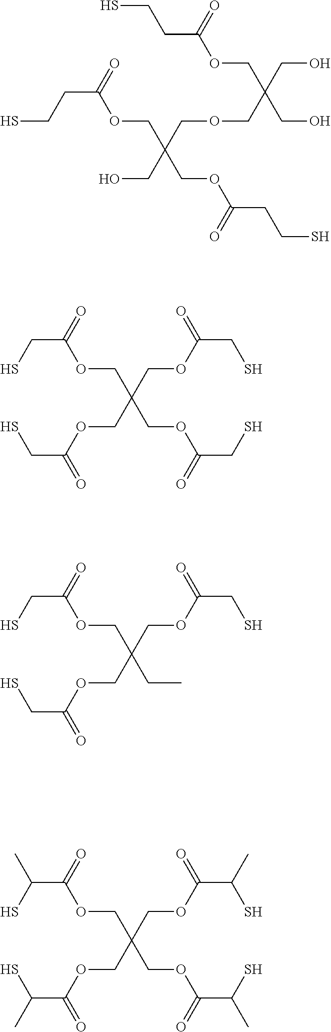 [SMILES: O=C(CCS)OCC(CO)(CO)COCC(CO)(COC(=O)CCS)COC(=O)CCS ; O=C(CS)OCC(COC(=O)CS)(COC(=O)CS)COC(=O)CS ; CCC(COC(=O)CS)(COC(=O)CS)COC(=O)CS ; CC(S)C(=O)OCC(COC(=O)C(C)S)(COC(=O)C(C)S)COC(=O)C(C)S]

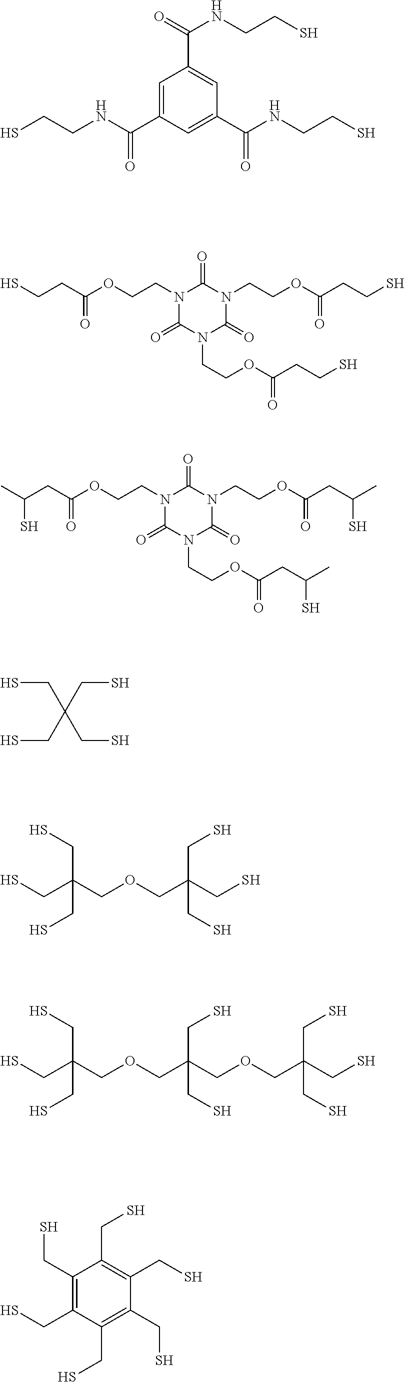

From the viewpoint of improving the alignment degree, the high-molecular-weight liquid crystalline compound may be a thermotropic liquid crystal and a crystalline polymer.

The thermotropic liquid crystal is a liquid crystal which shows transition to a liquid crystal phase due to a change in temperature, and preferred aspects thereof are the same as described above.

The crystalline polymer is a polymer showing a transition to a crystal layer due to a change in temperature. The crystalline polymer may show a glass transition other than the transition to the crystal layer.

From the viewpoint that the alignment degree of the light absorption anisotropic layer A is further increased and the haze is unlikely to be observed, it is preferable that the crystalline polymer is a high-molecular-weight liquid crystalline compound which has a transition from a crystal phase to a liquid crystal phase in a case of being heated (glass transition may be present in the middle of the transition), or a high-molecular-weight liquid crystalline compound which has a transition to a crystal phase in a case where the temperature is lowered after entering a liquid crystal state by being heated (glass transition may be present in the middle of the transition).

The presence or absence of crystallinity of the high-molecular-weight liquid crystalline compound is evaluated as follows.

Two light absorption anisotropic layers A of an optical microscope (ECLIPSE E600 POL, manufactured by Nikon Corporation) are arranged to be orthogonal to each other, and a sample table is set between the two light absorption anisotropic layers. A small amount of the high-molecular-weight liquid crystalline compound is placed on slide glass, and the slide glass is set on a hot stage placed on the sample table. While the state of the sample is observed, the temperature of the hot stage is increased to a temperature at which the high-molecular-weight liquid crystalline compound exhibits liquid crystallinity, and the high-molecular-weight liquid crystalline compound is allowed to enter a liquid crystal state. After the high-molecular-weight liquid crystalline compound enters the liquid crystal state, the behavior of the liquid crystal phase transition is observed while the temperature of the hot stage is gradually lowered, and the temperature of the liquid crystal phase transition is recorded. In a case where the high-molecular-weight liquid crystalline compound exhibits a plurality of liquid crystal phases (for example, a nematic phase and a smectic phase), all the transition temperatures are also recorded.

Next, approximately 5 mg of a sample of the high-molecular-weight liquid crystalline compound is put into an aluminum pan, and the pan is covered and set on a differential scanning calorimeter (DSC) (an empty aluminum pan is used as a reference). The high-molecular-weight liquid crystalline compound measured in the above-described manner is heated to a temperature at which the compound exhibits a liquid crystal phase, and the temperature is maintained for 1 minute. Thereafter, the calorific value is measured while the temperature is lowered at a rate of 10° C./min. An exothermic peak is confirmed from the obtained calorific value spectrum.

As a result, in a case where an exothermic peak is observed at a temperature other than the liquid crystal phase transition temperature, it can be said that the exothermic peak is a peak due to crystallization and the high-molecular-weight liquid crystalline compound has crystallinity.

On the other hand, in a case where an exothermic peak is not observed at a temperature other than the liquid crystal phase transition temperature, it can be said that the high-molecular-weight liquid crystalline compound does not have crystallinity.

A method of obtaining the crystalline polymer is not particularly limited, but as a specific example, a method of using a high-molecular-weight liquid crystalline compound including the above-described repeating unit (1) is preferable, and a method of using a suitable aspect among high-molecular-weight liquid crystalline compounds having the described above repeating unit (1) is more preferable.

From the viewpoint that the alignment degree of the light absorption anisotropic layer A is further increased and the haze is unlikely to be observed, the crystallization temperature of the high-molecular-weight liquid crystalline compound is preferably −50° C. or higher and lower than 150° C., more preferably 120° C. or lower, still more preferably −20° C. or higher and lower than 120° C., and particularly preferably 95° C. or lower. From the viewpoint of reducing haze, the above-described crystallization temperature of the high-molecular-weight liquid crystalline compound is preferably lower than 150° C.

The crystallization temperature is a temperature of an exothermic peak due to crystallization in the above-described DSC.

From the viewpoint that the effect of the present invention is more excellent, a weight-average molecular weight (Mw) of the high-molecular-weight liquid crystalline compound is preferably 1000 to 500,000 and more preferably 2,000 to 300,000. In a case where the Mw of the high-molecular-weight liquid crystalline compound is within the above-described range, the high-molecular-weight liquid crystalline compound is easily handled.

In particular, from the viewpoint of suppressing cracking during coating, the weight-average molecular weight (Mw) of the high-molecular-weight liquid crystalline compound is preferably 10,000 or more and more preferably 10,000 to 300,000.

In addition, from the viewpoint of temperature latitude of the alignment degree, the weight-average molecular weight (Mw) of the high-molecular-weight liquid crystalline compound is preferably less than 10,000 and preferably 2,000 or more and less than 10,000.

Here, the weight-average molecular weight and the number-average molecular weight in the present invention are values measured by a gel permeation chromatography (GPC) method.
Solvent (eluent): N-methylpyrrolidone
Device name: TOSOH HLC-8220GPC
Column: using three columns of TOSOH TSKgel Super AWM-H (6 mm×15 cm) connected
Column temperature: 25° C.
Sample concentration: 0.1% by mass
Flow rate: 0.35 mL/min
Calibration curve: TSK standard polystyrene (manufactured by TOSOH Corporation), calibration curves of 7 samples with Mw of 2,800,000 to 1,050 (Mw/Mn=1.03 to 1.06) are used

From the viewpoint that the effect of the present invention is more excellent, a content of the rod-like liquid crystal compound is preferably 10 to 97 parts by mass, more preferably 40 to 95 parts by mass, and still more preferably 60 to 95 parts by mass with respect to the total mass (100 parts by mass) of the light absorption anisotropic layer A.

In a case where the rod-like liquid crystal compound includes a high-molecular-weight liquid crystalline compound, a content of the high-molecular-weight liquid crystalline compound is preferably 10 to 99 parts by mass, more preferably 30 to 95 parts by mass, and still more preferably 40 to 90 parts by mass with respect to the total mass (100 parts by mass) of the rod-like liquid crystal compound.

In a case where the rod-like liquid crystal compound includes a low-molecular-weight liquid crystalline compound, a content of the low-molecular-weight liquid crystalline compound is preferably 1 to 90 parts by mass, more preferably 5% to 70% by mass, and still more preferably 10 to 60 parts by mass with respect to the total mass (100 parts by mass) of the rod-like liquid crystal compound.

In a case where the rod-like liquid crystal compound includes both the high-molecular-weight liquid crystalline compound and the low-molecular-weight liquid crystalline compound, from the viewpoint that the effect of the present invention is more excellent, a mass ratio (low-molecular-weight liquid crystalline compound/high-molecular-weight liquid crystalline compound) of the content of the low-molecular-weight liquid crystalline compound to the content of the high-molecular-weight liquid crystalline compound is preferably 5/95 to 70/30 and more preferably 10/90 to 50/50.

A content of the liquid crystalline compound is preferably 25 to 2000 parts by mass, more preferably 100 to 1300 parts by mass, still more preferably 200 to 1000, and particularly preferably 200 to 900 parts by mass with respect to 100 parts by mass of the content of the dichroic coloring agent in the total mass of the light absorption anisotropic layer A. That is, the content of the dichroic coloring agent is particularly preferably 1% to 50% by mass with respect to the content of the liquid crystalline compound. In a case where the content of the liquid crystalline compound is within the above-described ranges, the alignment degree of the light absorption anisotropic layer A is further improved.

The liquid crystalline compound may be contained only one kind or two or more kinds. In a case of containing two or more kinds of liquid crystalline compounds, the above-described content of the liquid crystalline compounds means the total content of the liquid crystalline compounds.

(Other Dichroic Substances)

In the present invention, it is also preferable to use other dichroic substances in combination with the dichroic coloring agent having a maximal absorption at a wavelength of 700 to 1500 nm. The dichroic substance contained in the composition for forming the light absorption anisotropic layer A is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, known dichroic substances (dichroic coloring agents) of the related art can be used. In particular, it is preferable to use a dichroic coloring agent having absorption to visible light (for example, a dichroic coloring agent having a maximal absorption at a wavelength of 400 to 700 nm) in combination. In this manner, it is possible to obtain a light absorption anisotropic layer A which corresponds to a wide wavelength range from the visible light region to the infrared region.

Examples of the other dichroic substances include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, and paragraphs [0014] to [0034] of WO2018/164252A.

In the present invention, two or more kinds of dichroic substances may be used in combination, and for example, from the viewpoint of obtaining a light absorption anisotropic layer A closer to black, it is more preferable to use a first dichroic coloring agent having a maximum absorption wavelength in a range of 560 nm or more and 700 nm or less (more preferably 560 to 650 nm and particularly preferably 560 to 640 nm), a second dichroic coloring agent having a maximum absorption wavelength in a range of 455 nm or more and less than 560 nm (more preferably 455 to 555 nm and particularly preferably 455 to 550 nm), and a third dichroic coloring agent having a maximum absorption wavelength in a range of 380 nm or more and less than 455 nm (more preferably 385 to 454 nm) in combination.

In a case where the above-described dichroic coloring agent having a maximal absorption at a wavelength of 400 to 700 nm, the light absorption anisotropic layer A can be applied to applications having polarization performance from the visible light region to the infrared region. In a case where the above-described dichroic coloring agent having a maximal absorption at a wavelength of 400 to 700 nm, a luminosity corrected single transmittance of the light absorption anisotropic layer A according to the embodiment of the present invention at the wavelength of 400 to 700 nm is preferably 30% to 50%.

The luminosity corrected single transmittance refers to an average transmittance weighted according to luminosity factor of the human eye in unpolarized rays having a wavelength of 400 to 700 nm. The luminosity corrected single transmittance can be obtained by carrying out luminosity correction on the transmittance at each wavelength measured with a spectrophotometer in a two-degree field of view (C light source) of JIS Z 8701.

In addition, it is also possible to use a dichroic coloring agent having an absorption axis which is not parallel to an alignment axis of the liquid crystal, as shown in the above-described water-insoluble dichroic coloring agent, and the dichroic coloring agent having a maximal absorption at a wavelength of 400 to 700 nm in combination. In this case, it is possible to obtain a light absorption anisotropic layer in which an angle between an absorption axis of the light absorption anisotropic layer A at the maximal absorption wavelength of the dichroic coloring agent having a maximal absorption at a wavelength of 400 to 700 nm and an absorption axis of the light absorption anisotropic layer A at the maximal absorption wavelength of the dichroic coloring agent having a maximal absorption at a wavelength of 700 to 1500 nm is 10° to 90°. The above-described angle will be described later.

The above-described dichroic substance may have a crosslinkable group.

Specific examples of the above-described crosslinkable group include a (meth)acryloyl group, an epoxy group, an oxetanyl group, and a styryl group, and among these, a (meth)acryloyl group is preferable.

(Other Additives)

In the preferred aspect 2 of the light absorption anisotropic layer A according to the embodiment of the present invention, a well-known initiator, leveling agent, or the like in the related art is also used as other additives. For details, the description of WO2019-131943A can be referred to.

(Other Accompanying Layers)

In the preferred aspect 2 of the light absorption anisotropic layer A according to the embodiment of the present invention, as accompanying layers, it is preferable to also have an alignment layer (alignment film), particularly a photo-alignment layer (photo-alignment film), a protective layer, a refractive index-adjusting layer, or the like. For details, the description of WO2019-131943A can be referred to.

<Characteristics of Light Absorption Anisotropic Layer A>

(Maximal Absorption Wavelength)

The light absorption anisotropic layer A preferably has a maximal absorption wavelength in a wavelength range of 700 to 1500 nm. Since the light absorption anisotropic layer A has the maximal absorption wavelength in the above-described range, the light absorption anisotropic layer A can absorb near-infrared rays in the wavelength range of 700 to 1500 nm. As a result, the light absorption anisotropic layer A can be used as a light absorption anisotropic layer having absorption in a near-infrared region. In particular, it is preferable that the light absorption anisotropic layer A according to the embodiment of the present invention is a film having different absorbances depending on directions with respect to light having any one wavelength of 700 to 1500 nm.

It is preferable that the light absorption anisotropic layer A has a first maximal absorption wavelength in a wavelength range of 700 nm or more and less than 900 nm and a second maximal absorption wavelength in a wavelength range of 900 to 1500 nm.

Absorption characteristics of the light absorption anisotropic layer A as described above can be achieved by using the dichroic substance having a maximal absorption wavelength in the above-described wavelength range.

(Alignment State)

In the light absorption anisotropic layer A, the dichroic coloring agent may be in various alignment states.

Examples of the alignment state include a homogeneous alignment and a homeotropic alignment. More specific examples of the alignment state include a nematic alignment (state of forming a nematic phase), a smectic alignment (state of forming a smectic phase), a twisted alignment, a cholesteric alignment (state of forming a cholesteric phase), and a hybrid alignment.

Examples of a method of achieving the alignment state of the dichroic coloring agent as described above include a method using a liquid crystalline compound (for example, the lyotropic liquid crystalline compound described above). That is, in a case where the light absorption anisotropic layer contains a liquid crystalline compound, by aligning the liquid crystalline compound in the predetermined alignment state described above, the dichroic coloring agent can also be aligned in accordance with the alignment state.

The light absorption anisotropic layer A preferably has an absorption axis at the maximal absorption wavelength in an in-plane direction. In such an aspect, this can be achieved by homogeneously aligning the dichroic coloring agent having absorption at the maximal absorption wavelength in the light absorption anisotropic layer (arranging a major axis direction of the dichroic coloring agent horizontally and in the same direction with respect to the surface of the light absorption anisotropic layer).

In addition, the light absorption anisotropic layer A also preferably has an absorption axis at the maximal absorption wavelength along a thickness direction. In such an aspect, this can be achieved by homeotropically aligning the dichroic substance coloring agent having absorption at the maximal absorption wavelength in the light absorption anisotropic layer (arranging a major axis direction of the dichroic substance coloring agent perpendicular to the surface of the light absorption anisotropic layer).

In addition, in a case where the light absorption anisotropic layer A has the above-described absorption axis at the maximal absorption wavelength in the in-plane direction, it is also preferable that an angle between the absorption axis of the light absorption anisotropic layer A at a wavelength of 250 nm and the absorption axis of the light absorption anisotropic layer A at the maximal absorption wavelength of the dichroic coloring agent is 0° to 5°.

The direction of the absorption axis of the light absorption anisotropic layer A at the maximal absorption wavelength of the dichroic coloring agent is obtained by the measurement of the alignment degree in a case where the dichroic coloring agent is homogeneously aligned below. In addition, the absorption axis at a wavelength of 250 nm can also be measured in the same manner as the measurement of the alignment degree described below.

In addition, in a case where the light absorption anisotropic layer A has the absorption axis at the maximal absorption wavelength along the thickness direction, and contains a dichroic coloring agent having a maximal absorption at a wavelength of 400 to 700 nm, it is also preferable that an angle between an absorption axis of the light absorption anisotropic layer A at the maximal absorption wavelength of the dichroic coloring agent having a maximal absorption at a wavelength of 400 to 700 nm and the absorption axis of the light absorption anisotropic layer A at the maximal absorption wavelength of the dichroic coloring agent nm is 10° to 90°.

The direction of the absorption axis at the maximal absorption wavelength of the dichroic coloring agent corresponds to an azimuthal angle and a polar angle with the highest transmittance, obtained in the measurement of the alignment degree in a case where the dichroic coloring agent is homeotropically aligned below. In addition, the absorption axis of the light absorption anisotropic layer A at the maximal absorption wavelength of the dichroic coloring agent having a maximal absorption at a wavelength of 400 to 700 nm can also be measured in the same manner as the measurement of the alignment degree described below.

(Alignment degree) The alignment degree of the dichroic coloring agent in the light absorption anisotropic layer A is not particularly limited, but from the absorption characteristics of the light absorption anisotropic layer A are more excellent, it is preferably 0.80 or more, more preferably 0.85 or more, still more preferably 0.90 or more, and particularly preferably 0.95 or more. The upper limit thereof is not particularly limited, but may be, for example, 1.00.

The above-described alignment degree is an alignment degree measured by the maximal absorption wavelength of the dichroic coloring agent in the light absorption anisotropic layer A.

In a case where the dichroic coloring agent forms a J-aggregate in the light absorption anisotropic layer A, the alignment degree is measured using the maximal absorption wavelength derived from the J-aggregate.

In a case where the dichroic coloring agent is homogeneously aligned in the light absorption anisotropic layer A (in other words, in a case of having an absorption axis in the in-plane direction), the above-described alignment degree is calculated by the following method.

The alignment degree is a value calculated according to the following expression by setting a light absorption anisotropic layer on a sample table in a state where a linear polarizer is inserted into a side of a light source of an optical microscope (manufactured by Nikon Corporation, product name “ECLIPSE E600 POL”), and measuring an absorbance of the light absorption anisotropic layer A using a multi-channel spectrometer (manufactured by Ocean Optics Inc., product name “QE65000”).

Alignment degree: S=[(Az0/Ay0)−1]/[(Az0/Ay0)+2]
Az0: absorbance of the dichroic coloring agent in an absorption axis direction of the light absorption anisotropic layer A with respect to polarized light of the maximal absorption wavelength
Ay0: absorbance of the dichroic coloring agent in a transmission axis direction of the light absorption anisotropic layer with respect to polarized light of the maximal absorption wavelength

The absorption axis direction in the above-described measurement denotes the in-plane direction of the light absorption anisotropic layer A in which the absorbance with respect to the polarized light is maximized in a case where the light absorption anisotropic layer A is irradiated with the polarized light, and the transmission axis direction is a direction in which the absorbance with respect to the polarized light is minimized.

In addition, in a case where the dichroic coloring agent is homeotropically aligned in the light absorption anisotropic layer A (in other words, in a case of having an absorption axis in the thickness direction), the above-described alignment degree is calculated by the following method.

Using AxoScan OPMF-1 (manufactured by Opto Science, Inc.), the transmittance of the light absorption anisotropic layer A for P-polarized light at the maximal absorption wavelength of the dichroic coloring agent is measured. In a case of the measurement, while changing a polar angle, which is an angle of the light absorption anisotropic layer A with respect to a normal direction, from 0° to 60° in 5° increments, the transmittance at the above-described maximal absorption wavelength is measured at all azimuthal angles at each polar angle. Next, after removing influence of surface reflection, a transmittance at the azimuthal angle and the polar angle where the transmittance is the highest is defined as Tm (0), and a transmittance at an angle obtained by tilting the polar angle by 40° from the polar angle of the highest transmittance in the azimuthal direction with the highest transmittance is defined as Tm (40). The absorbance is calculated by the following expression based on the obtained Tm (0) and Tm (40), and A (0) and A (40) are calculated.

A=−log(Tm)

Here, Tm represents a transmittance and A represents an absorbance.

An alignment degree S defined by the following expression is calculated based on the calculated A (0) and A (40).

S=(4.6×A(40)−A(0))/(4.6×A(40)+2×A(0))

A film thickness of the light absorption anisotropic layer A is 5 μm or less, and from the viewpoint of further improving bendability, it is preferably 3 μm or less. The lower limit thereof is not particularly limited, but from the viewpoint of handleability, it is preferably 0.1 m or more and more preferably 0.3 μm or more.

The film thickness of the light absorption anisotropic layer A is an average value obtained by measuring any 10 films of the light absorption anisotropic layer A using ultra-high resolution non-contact 3D surface profile measurement system BW-A501 manufactured by Nikon Corporation, and arithmetically averaging the obtained values.

(X-Ray Diffraction)

In terms of the alignment degree, the light absorption anisotropic layer A preferably has an ordered structure derived from a crystal phase or a high-order liquid crystal phase. The presence of the ordered structure can be confirmed by performing X-ray diffraction measurement using the light absorption anisotropic layer A as a sample, and observing a crystalline Bragg peak (peak derived from Bragg reflection) by X-ray diffraction.

[Laminate]

The light absorption anisotropic layer A according to the embodiment of the present invention may be combined with other members to form a laminate. Examples of the laminate include a laminate including the light absorption anisotropic layer A and a light absorption anisotropic layer B which contains a dichroic coloring agent having a maximal absorption at a wavelength of 400 to 700 nm, in which a luminosity corrected single transmittance at the wavelength of 400 to 700 nm is 30% to 50%.

In the laminate including the above-described light absorption anisotropic layer B and the light absorption anisotropic layer A, it is preferable to laminate such that an absorption axis at the maximal absorption wavelength of the light absorption anisotropic layer B is parallel to an absorption axis at the maximal absorption wavelength of the light absorption anisotropic layer A. In a case where the layers are laminated such that the absorption axes are parallel to each other, the laminate is suitably used in applications where polarized light having the same direction is desired to be obtained in a wide wavelength range from the visible light region to the infrared region.

In addition, the above-described laminate may have an aspect in which the absorption axis at the maximal absorption wavelength of the light absorption anisotropic layer B is not parallel to the absorption axis at the maximal absorption wavelength of the light absorption anisotropic layer A. In a case of a non-parallel aspect, the laminate is suitably used in applications where the polarization directions are desired to be different in the visible light region and the infrared region. In the case of a non-parallel aspect, it is preferable that the layers are laminated such that the angle between the absorption axis of the light absorption anisotropic layer B and the absorption axis of the light absorption anisotropic layer A is 100 to 900.

In addition, the above-described laminate may be a laminate including a circularly polarizing plate including the light absorption anisotropic layer B which absorbs visible light and an optically anisotropic layer which exhibits properties of a λ/4 wavelength plate for visible light, in which the laminate has a function of polarizing infrared light with the light absorption anisotropic layer Awhile satisfying an antireflection function of visible light with the circularly polarizing plate.

Examples of another aspect of the laminate include a laminate including the light absorption anisotropic layer A according to the embodiment of the present invention and an optically anisotropic layer, in which the laminate can generate circularly polarized infrared light.

In the optically anisotropic layer of the laminate capable of generating circularly polarized infrared light, it is preferable that an in-plane retardation of the optically anisotropic layer at a maximal absorption wavelength XA (unit: nm) of the light absorption anisotropic layer A is 10 to λ_{A}/4 nm.

In addition, in a case where the light absorption anisotropic layer A according to the embodiment of the present invention is used in an image display device, it is also preferable to use as a laminate including the light absorption anisotropic layer A and an optically anisotropic layer which is used for the purpose of reducing influence of visible light passing through the light absorption anisotropic layer A.

In a case of the above-described laminate, an in-plane retardation of the entire laminate at a wavelength of 550 nm is preferably 0 to 50 nm. In addition, a sum of out-plane retardations of the respective members of the laminate at a wavelength of 550 nm is preferably −50 to 50 nm. The above-described laminate may include the light absorption anisotropic layer B.

In the present specification, the in-plane retardation Re (λ) and the out-plane retardation Rth (λ) are values measured at a wavelength k in AxoScan (manufactured by Axometrics, Inc.). The retardation is calculated by inputting an average refractive index ((nx+ny+nz)/3) and a film thickness (d (m)) in AxoScan.

Slow Axis Direction (°)

Re(λ)=R0(λ)

Rth(λ)=((nx+ny)/2−nz)×d

Although R0 (λ) is displayed as a numerical value calculated by AxoScan, it means Re (λ).

The laminate may have an aspect in which the laminate include the light absorption anisotropic layer A and a wire grid polarizer. Since the wire grid polarizer is a reflective type polarizer, reflected light may have an adverse effect as stray light. It is preferable that the laminate is formed such that an angle between the absorption axis of the light absorption anisotropic layer A and an absorption axis of the wire grid polarizer is 1° or less, so that the stray light can be reduced.

[Light Absorption Anisotropic Layer B]

The light absorption anisotropic layer B used in the laminate according to the embodiment of the present invention contains a dichroic coloring agent having a maximal absorption at a wavelength of 400 to 700 nm, in which a luminosity corrected single transmittance at the wavelength of 400 to 700 nm is 30% to 50%.

As the light absorption anisotropic layer B, for example, a layer obtained by stretching a PVA resin containing iodine (stretched polyvinyl alcohol dyed with iodine) can be used. In addition, as the light absorption anisotropic layer B, a stretched resin of a PVA containing an organic dichroic coloring agent, described in JP2019-86622A, can also be used. From the viewpoint of thickness of the light absorption anisotropic layer B, a layer in which a dichroic coloring agent is aligned by using an alignment of a liquid crystalline compound, described in WO2019/131943A, is also preferable.

As the dichroic coloring agent used for the light absorption anisotropic layer B, it is preferable that a plurality of dichroic coloring agents are used in combination from the viewpoint of wide band. In a case of using dichroic coloring agents in combination, it is more preferable to use a first dichroic coloring agent having a maximum absorption wavelength in a range of 560 nm or more and 700 nm or less (more preferably 560 to 650 nm and particularly preferably 560 to 640 nm), a second dichroic coloring agent having a maximum absorption wavelength in a range of 455 nm or more and less than 560 nm (more preferably 455 to 555 nm and particularly preferably 455 to 550 nm), and a third dichroic coloring agent having a maximum absorption wavelength in a range of 380 nm or more and less than 455 nm (more preferably 385 to 454 nm) in combination.

[Optically Anisotropic Layer]

The laminate according to the embodiment of the present invention preferably includes an optically anisotropic layer.

Here, the optically anisotropic layer denotes all films showing a retardation in transmitted light, and examples thereof include a stretched polymer film and a retardation film provided with an optically anisotropic layer having a liquid crystalline compound aligned on a support.

Here, the alignment direction of the liquid crystalline compound contained in the optically anisotropic layer is not particularly limited, and examples thereof include horizontal alignment, vertical alignment, and twisted alignment with respect to the film surface.

In addition, a λ/4 plate, a λ/2 plate, and the like have specific functions of the optically anisotropic layer.

In addition, the optically anisotropic layer may be formed of a plurality of layers. Regarding the optically anisotropic layer formed of a plurality of optically anisotropic layers, for example, the description in paragraphs to of JP2014-209219A can be referred to.

In addition, such an optically anisotropic layer and the above-described light absorption anisotropic layer A may be provided by coming into contact with each other, or another layer may be provided therebetween. Examples of such a layer include a pressure-sensitive adhesive layer and an adhesive layer for ensuring adhesiveness.

In a case where the laminate according to the embodiment of the present invention is used as a circularly polarizing plate of visible light, it is preferable that the laminate according to the embodiment of the present invention includes a λ/4 plate as the optically anisotropic layer described above, and more preferable that the laminate includes a λ/4 plate on the light absorption anisotropic layer A.

Here, the “λ/4 plate” is a plate having a λ/4 function, specifically, a plate having a function of converting linearly polarized light having a specific wavelength into circularly polarized light (or converting circularly polarized light into linearly polarized light).

Specific examples of an aspect in which the λ/4 plate has a monolayer structure include a stretched polymer film and a retardation film in which an optically anisotropic layer having a λ/4 function is provided on a support. In addition, specific examples of an aspect in which the λ/4 plate has a multilayer structure include a broadband λ/4 plate obtained by laminating a λ/4 plate and a λ/2 plate.

<Processing to Polarizing Plate>

The polarizing plate of the present invention can be produced by the methods described in the light absorption anisotropic layer A and the laminate above. A film which protects the light absorption anisotropic layer A or the like may be provided on one surface or both surfaces of the above-described polarizing plate through an adhesive, a pressure sensitive adhesive, or the like. By using the protective film, a physically stable and highly flexible film can be obtained. Examples of the protective film include a triacetyl cellulose film, an acrylic film, a polycarbonate film, and a cycloolefin film, which are used as a protective film of a polarizing plate in the related art. Among these, a protective film which is transparent, has little birefringence, and is unlikely to generate a phase difference is suitable. In a case where a film formed of a thermoplastic resin is used as a base material, since the base material already has high surface hardness and is not easily affected by humidity, the base material may be used the protective film as it is.

In addition, in the production of the polarizing plate, a polymerizable resin composition or the like may be applied onto the surface of the light absorption anisotropic layer A or the laminate to provide a hardcoat layer, an anti-glare layer, a low-reflective layer, or the like.

In a case where the protective film is provided on the polarizing plate, the protective film may be laminated on one surface or both surfaces of the polarizing plate through an adhesive, and then dried. Drying conditions can be appropriately changed depending on the concentration of adhesive used and the moisture permeability of the protective film, and examples thereof include 25° C. to 100° C. for 1 to 150 minutes.

Furthermore, the polarizing plate of the present invention can be used as a laminated substrate by being bonded to an inorganic substrate such as a prism and glass, or an organic substrate such as a plastic plate. It is also possible to form a curved laminated substrate or the like by bonding the polarizing plate to a curved surface of glass or plastic plate.

In a case where the polarizing plate is applied to, for example, a display device such as a liquid crystal display device, the polarizing plate may be used in combination with other layers or films. Examples of the other layers or films include various functional layers for improving viewing angle and/or contrast, and a layer or film having a brightness improving property. Examples of the various functional layers include a layer or film which controls a retardation. In a case where the polarizing plate is applied to a display device, it is preferable that the polarizing plate is bonded to the other layers or films or to the display device through a pressure sensitive adhesive. In a case where the other layers or films are bonded to the polarizing plate, the other layers or films may be bonded to any surface of the polarizing plate.

The polarizing plate may be provided with various known functional layers such as an antireflection layer, an antiglare layer, and a hardcoat layer on an exposed surface of the protective layer or film. As a method for producing the various functional layers, a coating method is preferable. Various functional films may be bonded to the laminate through an adhesive or a pressure sensitive adhesive to produce the various functional layers.

[Applications]

The light absorption anisotropic layer A and laminate according to the embodiment of the present invention can be used as a polarizer (polarizing plate) in the infrared wavelength region, and for example, it can be used as a linearly polarizing plate or a circularly polarizing plate, and can be used for any application that makes use of the feature which infrared light can be converted into linearly polarized light or circularly polarized light. Examples of specific applications include a display device, a sensor, a lens, a switching element, an isolator, and a camera, and it can be used for generating infrared polarized light or infrared circularly polarized light by being attached to an infrared light source, and for receiving only necessary infrared polarized light or infrared circularly polarized light by attaching to an infrared light reception unit. In addition, it can also be used as an infrared circularly polarizing plate in applications of antireflection of infrared light.

In an infrared sensor system described below, by converting emission (projection) and incidence (reception) of infrared light into linearly polarized light or circularly polarized light (polarized light), it is possible to obtain not only information on light intensity, but also information on changes in phase, and the like. In addition, by performing the projection and reception with the polarized light, influence of light from the outside can be reduced, and the S/N ratio can be increased.

[Infrared Light Sensor System]

The infrared light sensor system according to the embodiment of the present invention is not particularly limited as long as it includes the light absorption anisotropic layer A or laminate according to the embodiment of the present invention described above.

Examples of the infrared light sensor system include a sensor system for detecting an object, measuring distance to the object, and the like, and a sensor system for measuring a surface state or internal state of an object by detecting reflected light or transmitted light.

The infrared light sensor system is preferably mounted on a device or the like.

The device or the like, on which the infrared light sensor system is mounted, is not particularly limited, and examples thereof include portable devices such as a smartphone, a smart watch, and smart glasses, and stationary devices such as a television and a smart speaker. In addition, the infrared light sensor system may be mounted on an automobile, a drone, a building, a transportation infrastructure, or the like.

The infrared light sensor system according to the embodiment of the present invention preferably includes at least one of an infrared light source or an infrared light receiving section, and more preferably includes both. It is preferable that the light absorption anisotropic layer A and laminate according to the embodiment of the present invention are used on an emission side of the infrared light source and an incidence side of the infrared light receiving section, respectively.

As the infrared light source, any light source can be adopted, and typical examples thereof include infrared light-emitting light emitting diode (LED) devices, infrared lasers, and various lamps which emit light in the near-infrared region.

As the infrared light receiving section, a photodetector element such as a photodiode and a phototransistor, which has sensitivity in an invisible light region can be adopted. A photodiode or a phototransistor, which has sensitivity in a near-infrared region, is preferable. As the photodetector element, an organic photodiode (OPD) or an organic phototransistor (OPT) may be adopted.

A target detected by the light receiving section is not particularly limited, and examples thereof include a shape of a target, a surface state of a target, an eye movement of a user, an eye position, a facial expression, a face shape, a vein pattern, a blood flow, a pulse, a blood oxygen saturation, a fingerprint, and an iris. That is, the infrared light sensor system according to the embodiment of the present invention can detect or recognize a shape of a target, a surface state of a target, an eye movement of a user, an eye position, a facial expression, a face shape, a vein pattern, a blood flow, a pulse, blood oxygen saturation, a degree, a fingerprint, and an iris.

Aspects of the infrared light sensor system according to the embodiment of the present invention will be described with reference to the drawings. Each drawing is a schematic view and does not indicate the specific number, arrangement, distance, and the like of an actual aspect, and the number, arrangement, distance, and the like can be appropriately changed.

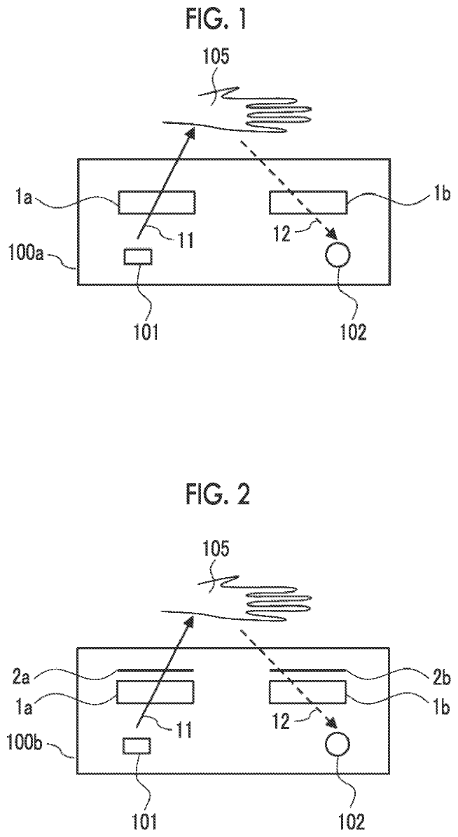

An infrared light sensor system 100a shown in FIG. 1 includes an infrared light source 101 and an infrared light receiving section 102, in which each of a light absorption anisotropic layer A 1a and a light absorption anisotropic layer A 1b is disposed on a measurement side (measurement target 105 side) of the infrared light source 101 and the infrared light receiving section 102.

In the infrared light sensor system 100a shown in FIG. 1, an infrared emitted light 11 is emitted from the infrared light source 101 through the light absorption anisotropic layer A 1a, and an infrared light reflected from the measurement target 105 is received by the infrared light receiving section 102 as an infrared incident light 12 through the light absorption anisotropic layer A 1b. It is possible to detect or recognize the measurement target 105 by receiving the infrared light reflected from the measurement target 105 as the infrared incident light 12 by the infrared light receiving section 102.

As described above, the light absorption anisotropic layer A 1a and the light absorption anisotropic layer A 1b can be used as a polarizer (polarizing plate) in the infrared wavelength region. Therefore, the infrared light emitted from the infrared light sensor system 100a may be polarized light (for example, linearly polarized light). The light absorption anisotropic layer A 1a and the light absorption anisotropic layer A 1b function as polarizers and polarizing filters, and the polarization directions may be determined according to the purpose. The infrared light sensor system 100 may include a mechanism (for example, a rotation mechanism) for changing the polarization directions of the light absorption anisotropic layer A 1a and the light absorption anisotropic layer A b.

In addition, the infrared light sensor system 100a may further include the light absorption anisotropic layer B absorbing visible light, which is described in the laminate above. Preferred aspects of the laminate are as described above.

The infrared light sensor system 100a shown in FIG. 1 may further include an optically anisotropic layer. That is, an aspect of an infrared light sensor system 100b shown in FIG. 2 may be applied.

The infrared light sensor system 100b shown in FIG. 2 includes an infrared light source 101 and an infrared light receiving section 102. In addition, in the infrared light sensor system 100b, a light absorption anisotropic layer A 1a and an optically anisotropic layer 2a are arranged on a measurement side (measurement target 105 side) of the infrared light source 101, and a light absorption anisotropic layer A 1b and an optically anisotropic layer 2b are arranged on a measurement side (measurement target 105 side) of the infrared light receiving section 102.

In the infrared light sensor system 100b shown in FIG. 2, an infrared emitted light 11 is emitted from the infrared light source 101 through the light absorption anisotropic layer A 1a and the optically anisotropic layer 2a, and an infrared light reflected from the measurement target 105 is received by the infrared light receiving section 102 as an infrared incident light 12 through the optically anisotropic layer 2b and the light absorption anisotropic layer A 1b. It is possible to detect or recognize the measurement target 105 by receiving the infrared light reflected from the measurement target 105 as the infrared incident light 12 by the infrared light receiving section 102.

The aspect in which the light absorption anisotropic layer A 1a, the optically anisotropic layer 2a, the light absorption anisotropic layer A 1b, and the optically anisotropic layer 2b are arranged corresponds to the aspect of the laminate described above.

As described above, with the laminate, infrared circularly polarized light can be generated, and the laminate also functions as a circularly polarized light filter. The orientation of the circularly polarized light may be determined according to the purpose, and the infrared light sensor system 100b may include a mechanism for changing the orientation of the circularly polarized light of the laminate. Preferred aspects of the laminate are as described above.

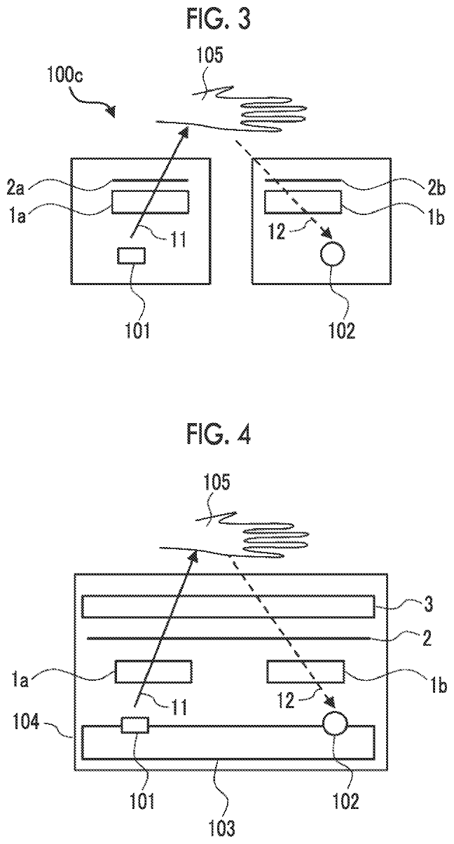

In addition, as the aspect of the infrared light sensor system 100b shown in FIG. 2, an aspect in which the infrared light source 101 and the infrared light receiving section 102 are provided in the same housing has been described, but the infrared light source 101 and the infrared light receiving section 102 may be provided in separate housings. That is, an aspect of an infrared light sensor system 100c shown in FIG. 3 may be applied.

The infrared light sensor system 100c shown in FIG. 3 includes an infrared emission device in which the infrared light source 101 is provided and a light absorption anisotropic layer A 1a and an optically anisotropic layer 2a are arranged on a measurement side (measurement target 105 side) of the infrared light source 101, and an infrared incidence device in which the infrared light receiving section 102 is provided and a light absorption anisotropic layer A 1b and an optically anisotropic layer 2b are arranged on a measurement side (measurement target 105 side) of the infrared light receiving section 102.

In the infrared light sensor system 100c shown in FIG. 3, an infrared emitted light 11 is emitted from the infrared light source 101 in the infrared emission device through the light absorption anisotropic layer A 1a and the optically anisotropic layer 2a. The infrared light reflected from the measurement target 105 is incident into the infrared incidence device, and is received by the infrared light receiving section 102 as an infrared incident light 12 through the optically anisotropic layer 2b and the light absorption anisotropic layer A 1b. It is possible to detect or recognize the measurement target 105 by receiving the infrared light reflected from the measurement target 105 as the infrared incident light 12 by the infrared light receiving section 102.

The aspect in which the light absorption anisotropic layer A 1a, the optically anisotropic layer 2a, the light absorption anisotropic layer A 1b, and the optically anisotropic layer 2b are arranged corresponds to the aspect of the laminate described above.

As described above, with the laminate, infrared circularly polarized light can be generated, and the laminate also functions as a circularly polarized light filter. The orientation of the circularly polarized light may be determined according to the purpose, and the infrared light sensor system 100c may include a mechanism for changing the orientation of the circularly polarized light of the laminate. Preferred aspects of the laminate are as described above.

In addition, the infrared light sensor system according to the embodiment of the present invention may be used in an image display device or the like.

For example, a light emitting panel or an image display device including the above-described infrared light sensor system can be applied to wearable devices such as a head-mounted display, mobile display devices such as a smartphone and a tablet, or stationary devices such as a television and a lighting.

An aspect in which the infrared light sensor system according to the embodiment of the present invention is used in an image display device or the like will be described with reference to the drawing.

An image display device 104 shown in FIG. 4 includes, from a viewing side (measurement target 105 side), a light absorption anisotropic layer B 3, an optically anisotropic layer 2, and a visible light emitting panel 103, and includes, on the optically anisotropic layer 2 side of the visible light emitting panel 103, an infrared light source 101 and an infrared light receiving section 102. In addition, in the image display device 104, a light absorption anisotropic layer A 1a is disposed between the infrared light source 101 and the optically anisotropic layer 2, and a light absorption anisotropic layer A 1b is disposed between the infrared light receiving section 102 and the optically anisotropic layer 2.

In the image display device 104 shown in FIG. 4, visible light from the visible light emitting panel 103 is emitted to the viewing side (measurement target 105 side) so that an image can be viewed, and an infrared emitted light 11 is emitted from the infrared light source 101 through the light absorption anisotropic layer A 1a, the optically anisotropic layer 2, and the light absorption anisotropic layer B 3. The infrared emitted light 11 is reflected from the measurement target 105, and the reflected infrared light is received by the infrared light receiving section 102 as an infrared incident light 12 through the light absorption anisotropic layer B 3, the optically anisotropic layer 2, and the optically anisotropic layer 2b. It is possible to detect or recognize the measurement target 105 by receiving the infrared light reflected from the measurement target 105 as the infrared incident light 12 by the infrared light receiving section 102.

Preferred aspects in a case where the light absorption anisotropic layer A 1a and the light absorption anisotropic layer A 1b are used in the image display device is as described above.

### EXAMPLES

Hereinafter, features of the present invention will be described in more detail with reference to Examples and Comparative Examples. The materials, amounts used, proportions, treatment details, and treatment procedure shown in the following Examples can be appropriately changed without departing from the spirit and scope of the present invention. Therefore, the scope of the present invention should not be construed as being limited to the following specific examples.

<Synthesis>

The following rod-like compound I-1, dichroic coloring agent II-1 and dichroic coloring agent II-2 having a hydrophilic group, and long-wavelength coloring agent III-1 were synthesized by known methods. The rod-like compound I-1 was a polymer (n was 2 or more), the number-average molecular weight of the rod-like compound I-1 was 24,000 and the molecular weight distribution was 6.8. The long-wavelength coloring agent III-1 corresponded to a water-insoluble dichroic coloring agent.

In addition, both the dichroic coloring agent II-1 and the dichroic coloring agent II-2 exhibited lyotropic liquid crystallinity.

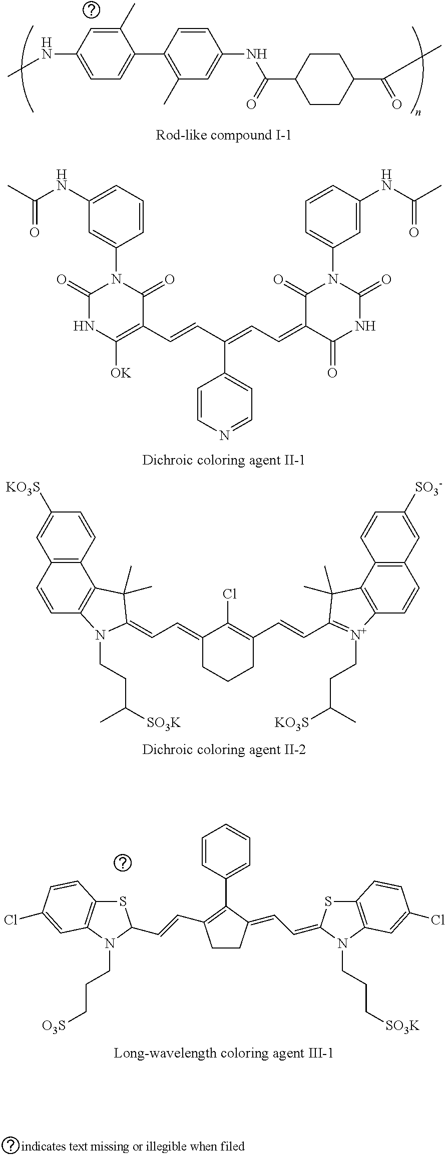

### Example 1

A composition 1 for forming a light absorption anisotropic layer A, having the following composition, was prepared. The composition 1 for forming a light absorption anisotropic layer A was a composition exhibiting lyotropic liquid crystallinity.

Composition 1 for forming light absorption anisotropic layer A

| | | |
|---|---|---|
| Rod-like compound I-1 described above | 10 | parts by mass |
| Dichroic coloring agent II-1 described | 0.5 | parts by mass |
| above | | |
| Dichroic coloring agent II-2 described | 0.5 | parts by mass |
| above | | |
| Water | 89 | parts by mass |

5 g of the composition 1 for forming a light absorption anisotropic layer A prepared above and 20 g of zirconia beads having a diameter of 2 mm were filled in a zirconia 45 mL container, and using a planetary ball mill P-7 classic line manufactured by Frisch GmbH, milling was performed for 50 minutes at a rotation speed of 300 rpm. The composition 1 for forming a light absorption anisotropic layer A, which had been subjected to the milling treatment described above, was applied onto a glass substrate (base material) with a wire bar (moving speed: 100 cm/s), and naturally dried. Next, the obtained coating film was immersed in a 1 mol/L calcium chloride aqueous solution for 5 seconds, washed with ion exchange water, and blast-dried to fix the alignment state, thereby producing a light absorption anisotropic layer 1 having a film thickness of 1.6 μm.

The film thickness was measured using ultra-high resolution non-contact 3D surface shape measurement system BW-A501 manufactured by Nikon Corporation. An alignment degree of the dichroic coloring agent was 0.85 at the maximal absorption wavelength. In addition, an average absorbance at a wavelength of 400 to 700 nm was 0.2 or less, and an average absorbance at a wavelength of 750 nm was 0.31.

### Example 2

A light absorption anisotropic layer 2 was produced by the same method as in Example 1, except that the composition 1 for forming a light absorption anisotropic layer A was changed to the following composition 2 for forming a light absorption anisotropic layer A. A film thickness of the light absorption anisotropic layer 2 was 1.2 μm. An alignment degree of the dichroic coloring agent was 0.81 at the maximal absorption wavelength. In addition, an average absorbance at a wavelength of 400 to 700 nm was 0.2 or less, and an average absorbance at a wavelength of 750 nm was 0.26.

Composition 2 for forming light absorption anisotropic layer A

| | | |
|---|---|---|
| Rod-like compound I-1 described above | 10 | parts by mass |
| Dichroic coloring agent II-1 | 0.31 | parts by mass |
| described above | | |
| Dichroic coloring agent II-2 | 0.31 | parts by mass |
| described above | | |
| Long-wavelength coloring agent III-1 | 0.31 | parts by mass |
| described above | | |
| Water | 89.1 | parts by mass |

### Comparative Example 1

A light absorption anisotropic layer 7 was produced by the same method as in Example 1, except that the composition 1 for forming a light absorption anisotropic layer A was changed to the following composition 7 for forming a light absorption anisotropic layer. A film thickness of the light absorption anisotropic layer 7 was 1.2 μm.

Composition 7 for forming light absorption anisotropic layer

| | | |
|---|---|---|
| Rod-like compound I-1 described above | 10 | parts by mass |
| Dichroic coloring agent II-1 | 0.15 | parts by mass |
| described above | | |
| Dichroic coloring agent II-2 | 0.15 | parts by mass |
| described above | | |
| Water | 89.7 | parts by mass |

The particle diameter was measured using Nanotrack UPA-EX manufactured by MicrotracBEL Corp, and in Examples 1 and 2 and Comparative Example 1 described above, the average particle diameters of the dichroic coloring agents in the compositions after the ball milling dispersion treatment were all 10 to 200 nm.

### Example 3

(Production of Transparent Support)

—Production of Core Layer Cellulose Acylate Dope—

The following composition was put into a mixing tank and stirred to dissolve each component, thereby preparing a cellulose acetate solution used as a core layer cellulose acylate dope.

Core layer cellulose acylate dope

| | | |
|---|---|---|
| Cellulose acetate having acetyl substitution | 100 | parts by mass |
| degree of 2.88 | | |
| Polyester compound B described in | 12 | parts by mass |
| Examples of JP2015-227955A | | |
| Compound F | 2 | parts by mass |
| Methylene chloride (first solvent) | 430 | parts by mass |
| Methanol (second solvent) | 64 | parts by mass |

Compound F

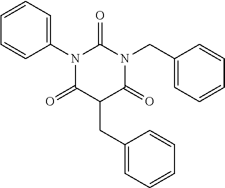 [SMILES: O=C1C(Cc2ccccc2)C(=O)N(c2ccccc2)C(=O)N1Cc1ccccc1]

—Production of Outer Layer Cellulose Acylate Dope—

10 parts by mass of the following matting agent solution was added to 90 parts by mass of the above-described core layer cellulose acylate dope, thereby preparing a cellulose acetate solution used as an outer layer cellulose acylate dope.

Matting agent solution

| | | |
|---|---|---|
| Silica particles with average particle size of 20 nm | 2 | parts by mass |
| (AEROSIL R972, manufactured by | | |
| Nippon Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

—Production of Cellulose Acylate Film 1—

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to produce an optical film (transparent support) having a thickness of 40 μm, and the optical film was used as a cellulose acylate film 1. An in-plane retardation of the obtained cellulose acylate film 1 was 0 nm.

(Formation of Photo-Alignment Film PA1)

The cellulose acylate film 1 was continuously coated with a coating liquid PA1 for forming a photo-alignment film described below with a wire bar. The support on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film PA1, thereby obtaining a triacetyl cellulose (TAC) film with the photo-alignment film. A film thickness of the photo-alignment film PA1 was 0.5 μm.

Coating liquid PA1 for forming photo-alignment film

| | | |
|---|---|---|
| Polymer PA-1 | 100.00 | parts by mass |
| Acid generator PAG-1 | 8.25 | parts by mass |
| Stabilizer DIPEA | 0.6 | parts by mass |
| Xylene | 1126.60 | parts by mass |
| Methyl isobutyl ketone | 125.18 | parts by mass |

Polymer PA-1 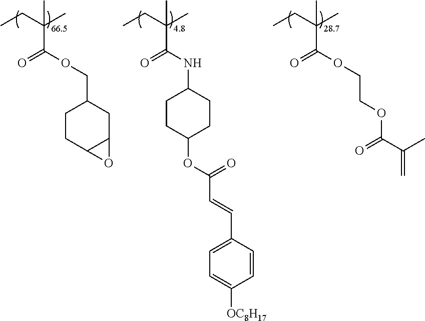
Acid generator PAG-1 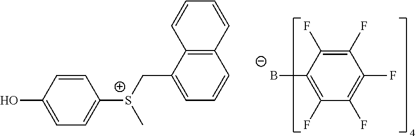
Stabilizer DIPEA

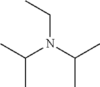

(Production of Light Absorption Anisotropic Layer 3)

A coating layer 3 was formed by continuously coating the obtained photo-alignment film PA1 with a composition 3 for forming a light absorption anisotropic layer A, having the following composition, with a wire bar.

Next, the coating layer 3 was heated at 140° C. for 15 seconds, and the coating layer P1 was cooled to room temperature (23° C.).

Next, the coating layer was heated at 80° C. for 60 seconds and cooled to room temperature again.

Thereafter, the coating layer was irradiated with an LED lamp (central wavelength of 365 nm) for 2 seconds under an irradiation condition of an illuminance of 200 mW/cm², thereby producing alight absorption anisotropic layer 3 on the photo-alignment film PA1. The dichroic coloring agent IR-1 corresponded to a water-insoluble dichroic coloring agent. A film thickness of the light absorption anisotropic layer 3 was 2.0 μm.

Composition 3 for forming light absorption anisotropic layer A

| | | |
|---|---|---|
| Dichroic coloring agent C-1 | 0.65 | parts by mass |
| Dichroic coloring agent M-1 | 0.15 | parts by mass |
| Dichroic coloring agent Y-1 | 0.52 | parts by mass |
| Dichroic coloring agent IR-1 | 0.38 | parts by mass |
| Liquid crystalline compound L-1 | 2.67 | parts by mass |
| Liquid crystalline compound L-4 | 1.15 | parts by mass |
| Adhesion improver A-1 | 0.17 | parts by mass |
| Polymerization initiator | 0.17 | parts by mass |
| IRGACURE OXE-02 (manufactured by BASF SE) | | |
| Surfactant F-1 | 0.020 | parts by mass |
| Cyclopentanone | 91.95 | parts by mass |
| Benzyl alcohol | 2.36 | parts by mass |

Dichroic coloring agent C-1 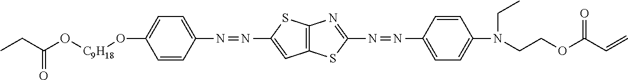
Dichroic coloring agent M-1 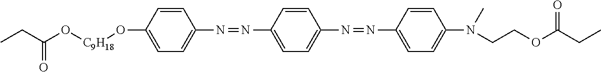
Dichroic coloring agent Y-1 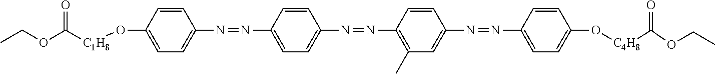
Dichroic coloring agent IR-1 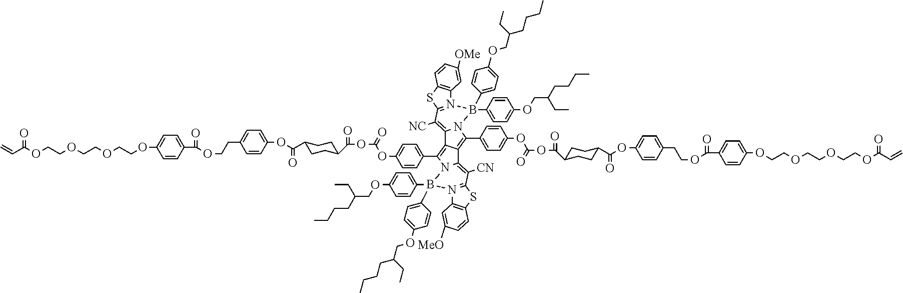
Liquid crystalline compound L-1 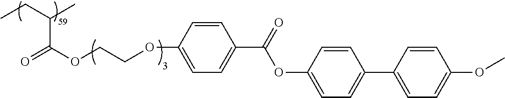 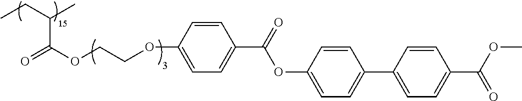 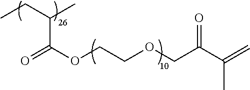
Liquid crystalline compound L-4 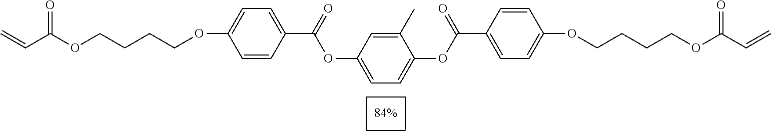 [SMILES: C=CC(=O)OCCCCOc1ccc(C(=O)Oc2ccc(OC(=O)c3ccc(OCCCCOC(=O)C=C)cc3)c(C)c2)cc1] 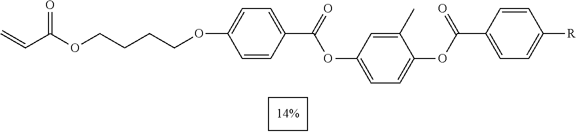 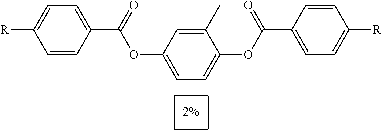 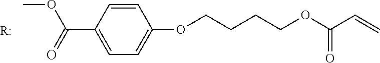
Adhesion improver A-1 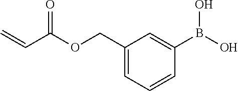
Surfactant F-1

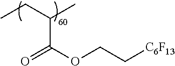

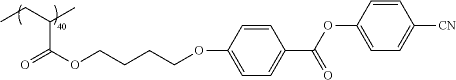

(Formation of Oxygen-Shielding Layer B1)

The light absorption anisotropic layer 3 was continuously coated with a coating liquid B1 having the following composition with a wire bar. Thereafter, the coating layer was dried with hot air at 80° C. for 5 minutes, and irradiated with ultraviolet rays (300 mJ/cm², using an ultra-high pressure mercury lamp), thereby obtaining a laminate A on which an oxygen-shielding layer B1 consisting of polyvinyl alcohol (PVA) with a thickness of 1.0 μm was formed, that is, a laminate 3 including the cellulose acylate film 1 (transparent support), the photo-alignment film PA1, the light absorption anisotropic layer 3, and the oxygen-shielding layer B1 adjacent to each other in this order. A luminosity corrected single transmittance of the laminate 3 at a wavelength of 400 to 700 nm was 42%.

Coating liquid B1 for forming oxygen-shielding layer

| | | |
|---|---|---|
| Modified polyvinyl alcohol shown below | 3.80 | parts by mass |
| Initiator Irg2959 | 0.20 | parts by mass |
| Water | 70 | parts by mass |
| Methanol | 30 | parts by mass |

Modified polyvinyl alcohol

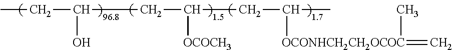

### Example 4

A light absorption anisotropic layer 4 was produced by the same method as in Example 1, except that the composition 1 for forming a light absorption anisotropic layer A was changed to the following composition 4 for forming a light absorption anisotropic layer A. A film thickness of the light absorption anisotropic layer 4 was 1.2 μm. An alignment degree of the dichroic coloring agent was 0.85 at the maximal absorption wavelength. In addition, an average absorbance at a wavelength of 400 to 700 nm was 0.2 or less, and an average absorbance at a wavelength of 750 nm was 0.22.

Composition 4 for forming light absorption anisotropic layer A

| | | |
|---|---|---|
| Rod-like compound I-1 described above | 10 | parts by mass |
| Dichroic coloring agent II-1 | 0.35 | parts by mass |
| described above | | |
| Dichroic coloring agent II-2 | 0.35 | parts by mass |
| described above | | |
| Water | 89.3 | parts by mass |

The particle diameter was measured using Nanotrack UPA-EX manufactured by MicrotracBEL Corp, and in Examples 1 and 2 and Comparative Example 1 described above, the average particle diameters of the dichroic coloring agents in the compositions after the ball milling dispersion treatment were all 10 to 200 nm.

### Example 5

A light absorption anisotropic layer 5 was produced by the same method as in Example 1, except that the composition 1 for forming a light absorption anisotropic layer A was changed to the following composition 5 for forming a light absorption anisotropic layer A. A film thickness of the light absorption anisotropic layer 5 was 1.2 μm. An alignment degree of the dichroic coloring agent was 0.85 at the maximal absorption wavelength. In addition, an average absorbance at a wavelength of 400 to 700 nm was 0.2 or less, and an average absorbance at a wavelength of 750 nm was 0.13.

Composition 5 for forming light absorption anisotropic layer A

| | | |
|---|---|---|
| Rod-like compound I-1 described above | 10 | parts by mass |
| Dichroic coloring agent II-1 | 0.18 | parts by mass |
| described above | | |
| Dichroic coloring agent II-2 | 0.18 | parts by mass |
| described above | | |
| Water | 89.6 | parts by mass |

The particle diameter was measured using Nanotrack UPA-EX manufactured by MicrotracBEL Corp, and in Examples 1 and 2 and Comparative Example 1 described above, the average particle diameters of the dichroic coloring agents in the compositions after the ball milling dispersion treatment were all 10 to 200 nm.

### Example 6

The following components were mixed, and the obtained mixture was stirred at 80° C. for 1 hour, and then cooled to room temperature to prepare a composition 6 for forming a light absorption anisotropic layer A. The dichroic substance coloring agent IR-3 corresponded to a water-insoluble dichroic coloring agent.

Composition 6 for forming light absorption anisotropic layer A

| | | |
|---|---|---|
| Polymerizable liquid crystalline | 29.3 | parts by mass |
| compound L-5 | | |
| Dichroic coloring agent IR-3 | 2.2 | parts by mass |
| Polymerization initiator | 2.0 | parts by mass |
| IRGACURE 369 (manufactured by | | |
| BASF Japan) | | |
| Leveling agent | 0.1 | parts by mass |
| BYK361N (manufactured by BYK | | |
| Chemie Japan Co., Ltd.) | | |
| Cyclopentanone | 66.4 | parts by mass |

IRGACURE 369 is a trade name, and the compound name is 2-dimethylamino-1-(4-morpholinophenyl)-2-benzylbutan-1-one.

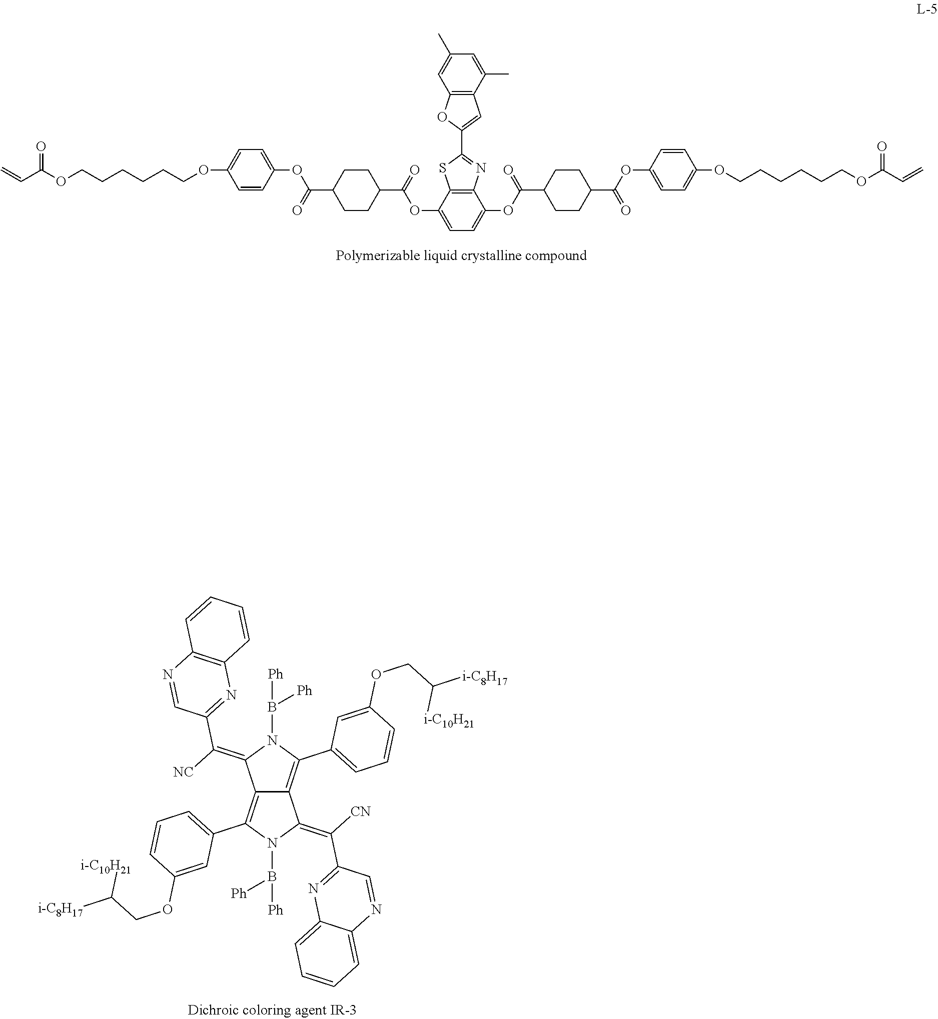

A2% by mass aqueous solution of polyvinyl alcohol (Polyvinyl alcohol 1000 completely saponified type, manufactured by Wako Pure Chemical Industries, Ltd.) was applied onto a glass substrate, and heat-dried at 120° C. for 60 minutes to obtain a polyvinyl alcohol film having a thickness of 89 nm on the glass substrate. Subsequently, a surface of the polyvinyl alcohol film was subjected to a rubbing treatment to obtain a laminate of the alignment film and the glass substrate. The surface of the obtained laminate, on which the rubbing treatment had been performed, was coated with a solution of the composition 6 for forming a light absorption anisotropic layer A according to a spin coating method. The laminate coated with the solution was dried on a hot plate for 1 minute, and irradiated with ultraviolet rays of an irradiation amount of 2400 mJ/cm² while being heated, thereby obtaining alight absorption anisotropic layer 6. A film thickness of the light absorption anisotropic layer 6 was 1.2 μm. An alignment degree of the dichroic coloring agent was 0.53 at the maximal absorption wavelength. In addition, an average absorbance at a wavelength of 400 to 700 nm was 0.2 or less.

### Example 12

A light absorption anisotropic layer 12 and a laminate 12 were produced by the same method as in Example 3, except that the composition 3 for forming a light absorption anisotropic layer A was changed to a composition 12 for forming a light absorption anisotropic layer A having the following composition. The dichroic substance coloring agent IR-2 corresponded to a water-insoluble dichroic coloring agent. A film thickness of the light absorption anisotropic layer 12 was 1.2 μm.

Composition 12 for forming light absorption anisotropic layer A

| | | |
|---|---|---|
| Dichroic coloring agent IR-2 | 0.39 | parts by mass |
| Liquid crystalline compound L-1 described above | 2.71 | parts by mass |
| Liquid crystalline compound L-4 described above | 1.16 | parts by mass |
| Adhesion improver A-1 described above | 0.17 | parts by mass |
| Polymerization initiator | 0.17 | parts by mass |
| IRGACURE OXE-02 (manufactured by BASF SE) | | |
| Surfactant F-1 described above | 0.020 | parts by mass |
| Cyclopentanone | 93.00 | parts by mass |
| Benzyl alcohol | 2.38 | parts by mass |

Dichroic coloring agent IR-2

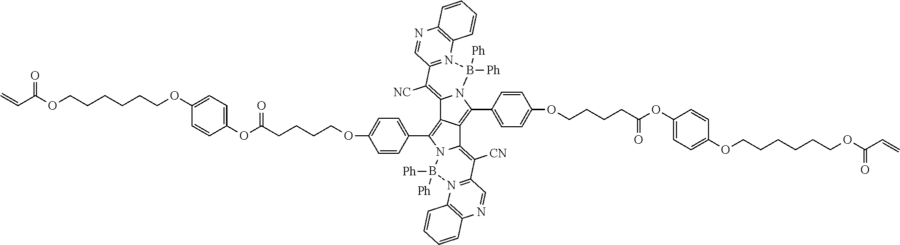

### Example 13

A light absorption anisotropic layer 13 and a laminate 13 were produced by the same method as in Example 3, except that the composition 3 for forming a light absorption anisotropic layer A was changed to a composition 13 for forming a light absorption anisotropic layer A having the following composition. A film thickness of the light absorption anisotropic layer 13 was 1.2 μm.

Composition 13 for forming light absorption anisotropic layer A

| | | |
|---|---|---|
| Dichroic coloring agent IR-3 described above | 0.39 | parts by mass |
| Liquid crystalline compound L-1 | 2.70 | parts by mass |
| described above | | |
| Liquid crystalline compound L-4 | 1.16 | parts by mass |
| described above | | |
| Adhesion improver A-1 described above | 0.17 | parts by mass |
| Polymerization initiator | 0.17 | parts by mass |
| IRGACURE OXE-02 (manufactured by | | |
| BASF SE) | | |
| Surfactant F-1 | 0.020 | parts by mass |
| Cyclopentanone | 92.86 | parts by mass |
| Benzyl alcohol | 2.38 | parts by mass |

### Example 14

A light absorption anisotropic layer 14 and a laminate 14 were produced by the same method as in Example 3, except that the composition 3 for forming a light absorption anisotropic layer A was changed to a composition 14 for forming a light absorption anisotropic layer A having the following composition. A film thickness of the light absorption anisotropic layer 14 was 1.2 μm. An alignment axis of the liquid crystalline compound was parallel to an absorption axis of the dichroic coloring agent. The maximal absorption wavelength was 840 nm and 1100 nm, and an average absorbance at 1100 nm was 0.22.

Composition 14 for forming light absorption anisotropic layer A

| | | |
|---|---|---|
| Dichroic coloring agent IR-3 described above | 0.39 | parts by mass |
| Dichroic coloring agent IR-4 | 1.00 | part by mass |
| Liquid crystalline compound L-1 described above | 2.70 | parts by mass |
| Liquid crystalline compound L-4 described above | 1.16 | parts by mass |
| Adhesion improver A-1 described above | 0.17 | parts by mass |
| Polymerization initiator | 0.17 | parts by mass |
| IRGACURE OXE-02 (manufactured by | | |
| BASF SE) | | |
| Surfactant F-1 described above | 0.020 | parts by mass |
| Cyclopentanone | 92.86 | parts by mass |
| Benzyl alcohol | 2.38 | parts by mass |

Dichroic substance coloring agent IR-4

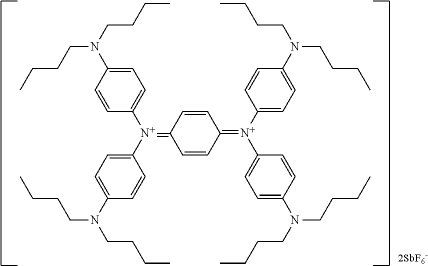

### Example 15

In the formation of the light absorption anisotropic film 3 in Example 3, a coating layer 15 was formed by continuously coating the obtained photo-alignment film PA1 with the following composition 15 for forming a light absorption anisotropic layer A with a wire bar.

Next, the coating layer 15 was heated at 120° C. for 60 seconds, and then was cooled to room temperature (23° C.) to form a dried coating film. In the dried coating film, the liquid crystalline compound was in a smectic B phase.

Thereafter, the coating layer was irradiated with an LED lamp (central wavelength of 365 nm) for 2 seconds under an irradiation condition of an illuminance of 200 mW/cm², thereby producing a light absorption anisotropic layer 15 on the photo-alignment film PAL. A film thickness of the light absorption anisotropic layer 15 was 1.2 μm. In addition, a Bragg peak (peak derived from Bragg reflection) was observed by X-ray diffraction measurement.

A laminate of Example 15 was obtained according to the same method as in Example 3, except that the light absorption anisotropic film 15 was used instead of the light absorption anisotropic film 3.

A composition 15 for forming a light absorption anisotropic layer A was prepared with the following composition, dissolved by heating at 50° C. for 3 hours with stirring, and filtered through a 0.45 μm filter.

Composition 15 for forming light absorption anisotropic layer A

| | | |
|---|---|---|
| Dichroic coloring agent IR-2 described above | 7.6 | parts by mass |
| Liquid crystalline compound M4 shown | 75.5 | parts by mass |
| below | | |
| Polymerization initiator IRGACURE 819 | 0.8 | part by mass |
| (manufactured by BASF) | | |
| Surfactant F-1 described above | 0.6 | parts by mass |
| Cyclopentanone | 274.5 | parts by mass |
| Tetrahydrofuran | 640.5 | parts by mass |

Liquid crystalline compound M4 (the following compound A and the following compound B was mixed at 75/25 (mass ratio))

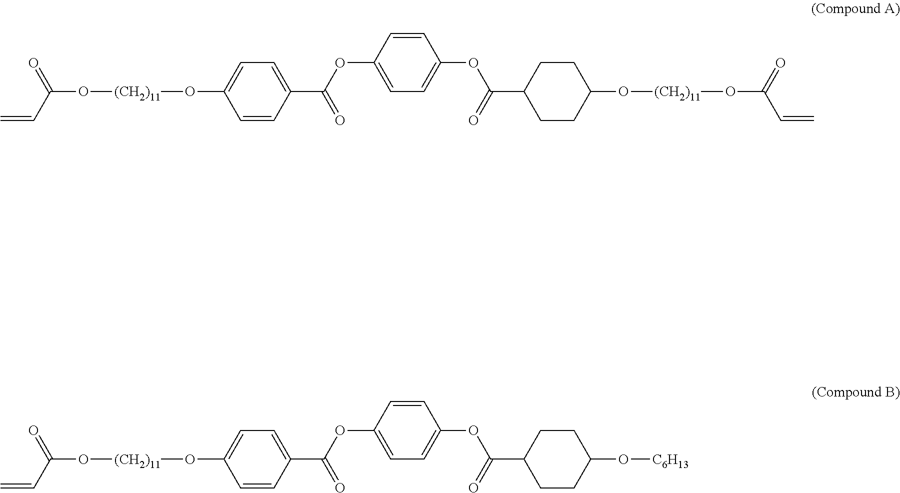

### Example 16

In the formation of the light absorption anisotropic layer 3 in Example 3, a coating layer H1 was formed by continuously coating the obtained photo-alignment film PA1 with the following composition H1 for forming a light absorption anisotropic layer A with a wire bar.

Next, the coating layer H1 was heated at 100° C. for 5 minutes, and then was cooled to 60° C. to form a dried coating film. In the dried coating film, the liquid crystalline compound was in a nematic phase.

Thereafter, the coating layer was irradiated with an LED lamp (central wavelength of 365 nm) for 2 seconds under an irradiation condition of an illuminance of 200 mW/cm², thereby producing a light absorption anisotropic layer H1 on the photo-alignment film PA1. A film thickness of the light absorption anisotropic layer H1 was 2.5 μm. In addition, in X-ray diffraction measurement, only a broad halo was observed in a wide angle region.

A laminate of Example 16 was obtained according to the same method as in Example 3, except that the light absorption anisotropic film H1 was used instead of the light absorption anisotropic film 3.

A composition H1 for forming a light absorption anisotropic layer A was prepared with the following composition, dissolved by heating at 50° C. for 3 hours with stirring, and filtered through a 0.45 μm filter.

Composition H1 for forming light absorption anisotropic layer A

| | | |
|---|---|---|
| Dichroic coloring agent IR-2 described above | 7.6 | parts by mass |
| Liquid crystalline compound H1 shown below | 75.5 | parts by mass |
| Polymerization initiator IRGACURE 819 | 0.8 | part by mass |
| (manufactured by BASF) | | |
| Surfactant F-1 described above | 0.6 | parts by mass |
| Cyclopentanone | 274.5 | parts by mass |
| Tetrahydrofuran | 640.5 | parts by mass |

Liquid crystal compound H1 (mixture of the following three kinds of compounds; mixing ratio (mass ratio) is described on the upper left side of the compound)

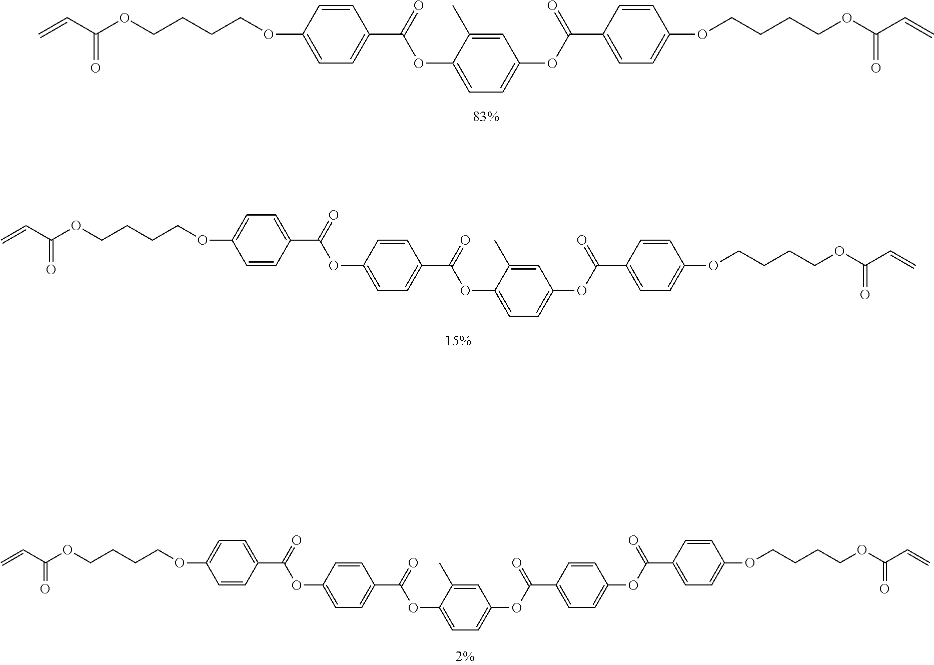

### Example 17

[Production of Optical Element]

A cellulose acylate film T1 (“TD40UL”, manufactured by FUJIFILM Corporation) passed through a gap between dielectric heating rolls at a temperature of 60° C. to increase a film surface temperature to 40° C.

Next, an alkali solution having a composition shown below was applied to a single surface of the film using a bar coater in an application amount of 14 mL/m², and the film was heated to 110° C.

Next, the obtained film was transported under a steam far infrared heater (manufactured by Noritake Co., Ltd.) so that a staying time was 10 seconds.

Next, with regard to the transported film, a surface of the film was coated with pure water in a coating amount of 3 mL/m² using the same bar coater.

Next, the obtained film was washed with water by a fountain coater and drained by an air knife three times, and then transported to a drying zone at 70° C. for 10 seconds and dried to produce a cellulose acylate film subjected to an alkali saponification treatment as a support.

(Alkali solution)

| | | |
|---|---|---|
| Potassium hydroxide | 4.7 | parts by mass |
| Water | 15.8 | parts by mass |
| Isopropanol | 63.7 | parts by mass |
| Surfactant | 1.0 | part by mass |
| (C₁₄H₂₉O(CH₂CH₂O)₂₀H) | | |
| Propylene glycol | 14.8 | parts by mass |

A alignment film coating liquid having the following composition was continuously applied to the above-described support using a #14 wire bar.

Next, the support on which the coating film had been formed was dried using hot air at 60° C. for 60 seconds and was dried using hot air at 100° C. for 120 seconds.

Next, the dried coating film was continuously rubbed to form an alignment film. At this time, a longitudinal direction and a transport direction of the elongated film were parallel to each other, and a rotation axis of a rubbing roller with respect to the longitudinal direction of the film was set to 0° clockwise.

(Alignment film coating liquid)

| | | |
|---|---|---|
| Modified polyvinyl alcohol shown below | 10.0 | parts by mass |
| Water | 371.0 | parts by mass |
| Methanol | 119.0 | parts by mass |
| Glutaraldehyde | 0.5 | parts by mass |
| Polymerization initiator (IRGACURE 2959, | 0.3 | part by mass |
| manufactured by BASF) | | |

Modified Polyvinyl Alcohol (in the Following Structural Formula, the Proportion is a Molar Ratio)

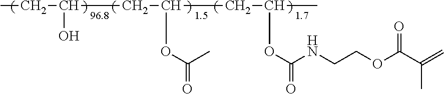

A coating layer H2 was formed by continuously coating the obtained alignment film with the composition H2 for forming a light absorption anisotropic layer A with a wire bar.

Next, the coating layer H2 was heated with hot air at 15° C. for 90 seconds, and then heated with hot air at 80° C. for 60 seconds to form a dried coating film. In the dried coating film, the liquid crystalline compound was in a nematic phase.

Thereafter, the coating layer was irradiated with an LED lamp (central wavelength of 365 nm) for 2 seconds under an irradiation condition of an illuminance of 200 mW/cm², thereby producing a light absorption anisotropic layer H2 on the alignment film. A film thickness of the light absorption anisotropic layer H2 was 3.2 μm.

The liquid crystalline compound D-1 was a discotic liquid crystal (DLC) compound, and it was confirmed that an average tilt angle of a disc plane of the DLC compound with respect to the film surface was 90° and the DLC compound was aligned perpendicularly to the film surface. In addition, in X-ray diffraction measurement, only a broad halo was observed in a wide angle region.

A laminate of Example 17 was obtained according to the same method as in Example 3, except that the light absorption anisotropic film H2 was used instead of the light absorption anisotropic film 3.

A composition H2 for forming a light absorption anisotropic layer A was prepared with the following composition, dissolved by heating at 50° C. for 3 hours with stirring, and filtered through a 0.45 μm filter.

Composition H2 for forming light absorption anisotropic layer A

| | | |
|---|---|---|
| Liquid crystalline compound D-1 shown below | 100 | parts by mass |
| Infrared absorbing coloring agent IR-5 shown below | 10 | parts by mass |
| Photopolymerization initiator (IRGACURE 907, manufactured by BASF) | 3 | parts by mass |
| Fluorine-containing compound F-2 described below (air interface alignment agent) | 0.25 | parts by mass |
| Additive T-1 shown below | 0.9 | parts by mass |
| Methyl ethyl ketone | 760 | parts by mass |

Liquid crystalline compound D-1 (mixture of the following two kinds of compounds) 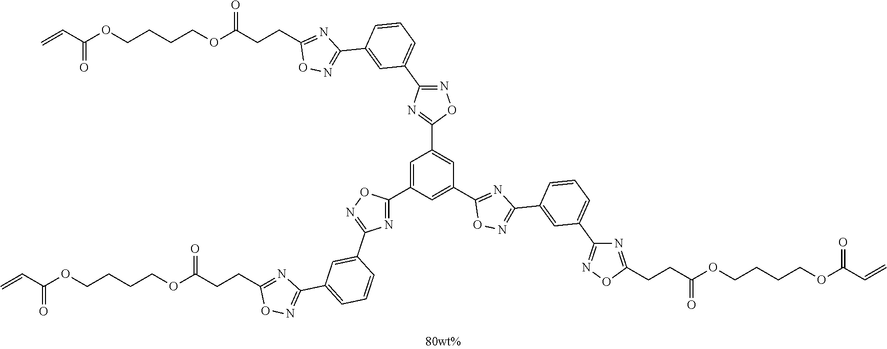 [SMILES: C=CC(=O)OCCCCOC(=O)CCc1nc(-c2cccc(-c3noc(-c4cc(-c5nc(-c6cccc(-c7noc(CCC(=O)OCCCCOC(=O)C=C)n7)c6)no5)cc(-c5nc(-c6cccc(-c7noc(CCC(=O)OCCCCOC(=O)C=C)n7)c6)no5)c4)n3)c2)no1] 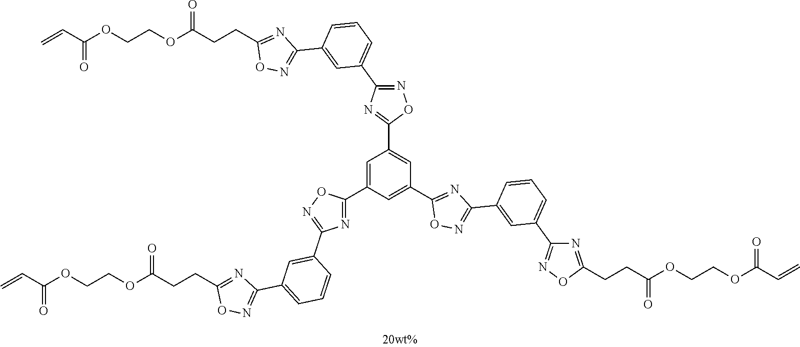 [SMILES: C=CC(=O)OCCOC(=O)CCc1nc(-c2cccc(-c3noc(-c4cc(-c5nc(-c6cccc(-c7noc(CCC(=O)OCCOC(=O)C=C)n7)c6)no5)cc(-c5nc(-c6cccc(-c7noc(CCC(=O)OCCOC(=O)C=C)n7)c6)no5)c4)n3)c2)no1]
Infrared absorbing coloring agent IR-5 (maximal absorption wavelength: 867 nm) 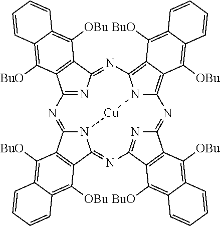
Fluorine-containing compound F-2 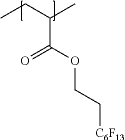 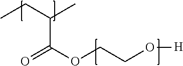
Additive T-1

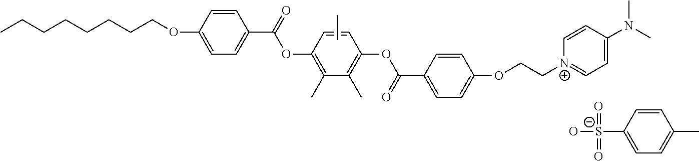

### Reference Example

(Production of Polarizer 1 with Protective Film on One Surface)

A surface of a support of a cellulose triacetate film TJ25 (manufactured by Fujifilm Corporation; thickness: 25 μm) was subjected to an alkali saponification treatment. Specifically, the support was immersed in a 1.5 N sodium hydroxide aqueous solution at 55° C. for 2 minutes, washed in a water bath at room temperature, and further neutralized with a 0.1 N sulfuric acid at 30° C. After neutralization, the support was washed in a water bath at room temperature and further dried with hot air at 100° C. to obtain a polarizer protective film 1.

A polyvinyl alcohol-based film (VF-XS manufactured by Kuraray) having a thickness of 75 μm, a polymerization degree of 2400, and a saponification degree of 99% or more was swelled with hot water at 40° C., and then dyed with an aqueous solution containing iodine, potassium iodide, and boric acid. The dyed film was stretched in a solution containing 3% by mass of boric acid, and immersed in an aqueous solution containing 5% by mass of potassium iodide after the stretching. The film immersed in the potassium iodide aqueous solution for 15 seconds was dried in a dryer at 70° C. for 10 minutes to obtain a polarizer 1 having a thickness of 25 μm.

The above-described polarizer protective film 1 was bonded to one surface of the above-described polarizer 1 using the above-described PVA adhesive to produce a polarizer 1 with a protective film on one surface. A luminosity corrected single transmittance of the polarizer 1 was 42%.

### Example 7

A pressure sensitive adhesive (SK-2057, manufactured by Soken Chemical & Engineering Co., Ltd.) was applied onto the polarizer side of the above-described polarizer 1 with a protective film on one surface to form a pressure sensitive adhesive layer, and the above-described light absorption anisotropic layer 1 was closely bonded to the pressure sensitive adhesive layer to obtain a laminate 7. The orientation of the absorption axis of the polarizer and the orientation of the absorption axis of the dichroic coloring agent of the light absorption anisotropic layer 1 were set to 0°.

### Example 8

A pressure sensitive adhesive (SK-2057, manufactured by Soken Chemical & Engineering Co., Ltd.) was applied onto a coating surface side of a laminate 8-1 described below to form a pressure sensitive adhesive layer, and the above-described light absorption anisotropic layer 1 was closely bonded to the pressure sensitive adhesive layer to obtain a laminate 8. The orientation of the absorption axis of the laminate 8-1 and the orientation of the absorption axis of the dichroic coloring agent of the light absorption anisotropic layer 1 were set to 0°.

(Production of Laminate 8-1)

A light absorption anisotropic layer 8 and a laminate 8-1 were produced by the same method as in Example 3, except that the composition 3 for forming a light absorption anisotropic layer A was changed to a composition 8 for forming a light absorption anisotropic layer having the following composition. A film thickness of the light absorption anisotropic layer 8 was 2.0 μm. A luminosity corrected single transmittance of the laminate 8-1 was 42%.

Composition 8 for forming light absorption anisotropic layer

| | | |
|---|---|---|
| Dichroic coloring agent C-1 | 0.65 | parts by mass |
| described above | | |
| Dichroic coloring agent M-1 | 0.15 | parts by mass |
| described above | | |
| Dichroic coloring agent Y-1 | 0.52 | parts by mass |
| described above | | |
| Liquid crystalline compound L-1 | 2.68 | parts by mass |
| described above | | |
| Liquid crystalline compound L-4 | 1.15 | parts by mass |
| described above | | |
| Adhesion improver A-1 described above | 0.17 | parts by mass |
| Polymerization initiator | 0.17 | parts by mass |
| IRGACURE OXE-02 (manufactured by | | |
| BASF SE) | | |
| Surfactant F-1 | 0.020 | parts by mass |
| Cyclopentanone | 92.14 | parts by mass |
| Benzyl alcohol | 2.36 | parts by mass |

### Example 9

A laminate 9 was produced by the same method as in Example 8, except that the orientation of the absorption axis of the laminate 8-1 and the orientation of the absorption axis of the dichroic coloring agent of the light absorption anisotropic layer 1 were set to 90°.

### Example 10

A pressure sensitive adhesive (SK-2057, manufactured by Soken Chemical & Engineering Co., Ltd.) was applied onto a surface of a wire grid polarizer (MOXTEK, Inc., UVT300A), on which the wire grids were not formed, to form a pressure sensitive adhesive layer, and the above-described light absorption anisotropic layer 1 was closely bonded to the pressure sensitive adhesive layer to obtain a laminate 10. The orientation of the absorption axis of the polarizer and the orientation of the absorption axis of the dichroic coloring agent of the light absorption anisotropic layer 1 were set to 0°.

### Example 11

A pressure sensitive adhesive (SK-2057, manufactured by Soken Chemical & Engineering Co., Ltd.) was applied onto a coating surface side of an optically anisotropic layer A described below to form a pressure sensitive adhesive layer, and the above-described light absorption anisotropic layer 1 was closely bonded to the pressure sensitive adhesive layer to obtain a laminate 11. The orientation of a slow axis of the optically anisotropic layer A and the orientation of the absorption axis of the dichroic coloring agent of the light absorption anisotropic layer 1 were set to 0°.

(Preparation of Cellulose Ester Solution A-1)

The following composition was put into a mixing tank and stirred while being heated to dissolve each component, thereby preparing a cellulose ester solution A-1.

Cellulose ester solution A-1

| | | |
|---|---|---|
| Cellulose acetate (acetylation degree: 2.86) | 100 | parts by mass |
| Methylene chloride (first solvent) | 320 | parts by mass |
| Methanol (second solvent) | 83 | parts by mass |
| 1-Butanol (third solvent) | 3 | parts by mass |
| Triphenyl phosphate | 7.6 | parts by mass |
| Biphenyl diphenyl phosphate | 3.8 | parts by mass |

(Preparation of Matting Agent Dispersion Liquid B-1)

The following composition was put into a disperser and stirred to dissolve each component, thereby preparing a matting agent dispersion liquid B-1.

Matting agent dispersion liquid B-1

| | | |
|---|---|---|
| Silica particle dispersion (average particle | 10.0 | parts by mass |
| diameter: 16 nm) AEROSIL R972, | | |
| manufactured by Nippon Aerosil Co., Ltd. | | |
| Methylene chloride | 72.8 | parts by mass |
| Methanol | 3.9 | parts by mass |
| Butanol | 0.5 | parts by mass |
| Cellulose ester solution A-1 | 10.3 | parts by mass |

(Preparation of Ultraviolet Absorbing Agent Solution C-1)

The following composition was put into a mixing tank and stirred while being heated to dissolve each component, thereby preparing an ultraviolet absorbing agent solution C-1.

Ultraviolet absorbing agent solution C-1

| | | |
|---|---|---|
| Ultraviolet absorbing agent (UV-1 shown below) | 10.0 | parts by mass |
| Ultraviolet absorbing agent (UV-2 shown below) | 10.0 | parts by mass |
| Methylene chloride | 55.7 | parts by mass |
| Methanol | 10 | parts by mass |
| Butanol | 1.3 | parts by mass |
| Cellulose ester solution A-1 | 12.9 | parts by mass |

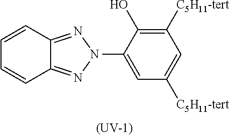

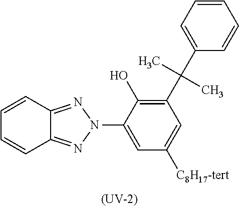

(Preparation of Cellulose Ester Film)

The ultraviolet absorbing agent solution C-1 was added to a mixture of 94.6 parts by mass of the cellulose ester solution A-1 and 1.3 parts by mass of the matting agent dispersion liquid B-1 such that the amount of the ultraviolet absorbing agent (UV-1) and the amount of the ultraviolet absorbing agent (UV-2) respectively reached 1.0 parts by mass with respect to 100 parts by mass of cellulose acylate, and the solution was sufficiently stirred while being heated to dissolve each component, thereby preparing a dope. The obtained dope was heated to 30° C. and cast on a mirror surface stainless steel support, serving as a drum having a diameter of 3 μm, through a casting geeser. The surface temperature of the mirror surface stainless steel support was set to −5° C., and the coating width was set to 1470 mm. The cast dope film was dried by applying drying air at 34° C. on the drum at 150 μm³/min, and the dope film was peeled off from the drum in a state where the amount of the residual solvent was 150%. During the peeling, the film was stretched by 15% in the transport direction (longitudinal direction). Thereafter, both ends of the film in the width direction (direction orthogonal to the casting direction) were transported while being grasped by a pin tenter (pin tenter shown in FIG. 3 of JP1992-1009A (JP-H4-1009A), and the film was not subjected to a stretching treatment in the width direction. Furthermore, the film was further dried by being transported between rolls of a heat treatment device, thereby producing a cellulose acylate film (T1). The produced elongated cellulose acylate film (T1) had a residual solvent amount of 0.2% and a thickness of 60 μm, and Re (in-plane retardation) and Rth (retardation in thickness direction) at a wavelength of 550 nm were respectively 0.8 nm and 40 nm.

(Alkali Saponification Treatment)

After passing the above-described cellulose acylate film (T1) through a dielectric heating roll at a temperature of 60° C. to raise the film surface temperature to 40° C., an alkaline solution having the composition shown below was applied onto a band surface of the film using a bar coater at a coating amount of 14 mL/m², followed by heating to 110° C., and transportation of the film under a steam type far-infrared heater manufactured by Noritake Company Limited for 10 seconds. Subsequently, pure water was applied at 3 ml/m² using the same bar coater. Next, the film was washed with water by a fountain coater and drained by an air knife three times, and then transported to a drying zone at 70° C. for 10 seconds and dried to produce a cellulose acylate film subjected to an alkali saponification treatment.

Composition of alkali solution

| | | |
|---|---|---|
| Potassium hydroxide | 4.7 | parts by mass |
| Water | 15.8 | parts by mass |
| Isopropanol | 63.7 | parts by mass |
| Surfactant SF-1 | 1.0 | part by mass |
| C₁₄H₂₉O(CH₂CH₂O)₂₀H | | |
| Propylene glycol | 14.8 | parts by mass |

(Formation of Alignment Film)

The surface of the cellulose acylate film (T1) on which the alkali saponification treatment had been performed was continuously coated with an alignment film coating liquid (A) having the following composition using a #14 wire bar. The surface was dried with hot air at 60° C. for 60 seconds and further dried with hot air at 100° C. for 120 seconds. The saponification degree of the used modified polyvinyl alcohol was 88%.

Alignment film coating liquid (A) Modified polyvinyl alcohol shown below 10 parts by mass

Alignment film coating liquid (A)

| | | |
|---|---|---|
| Modified polyvinyl alcohol shown below | 10 | parts by mass |
| Water | 308 | parts by mass |
| Methanol | 70 | parts by mass |
| Isopropanol | 29 | parts by mass |
| Photopolymerization initiator | 0.8 | parts by mass |
| (IRGACURE 2959, manufactured by | | |
| Chiba Japan Co., Ltd.) | | |

Modified polyvinyl alcohol

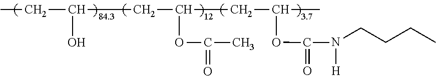 [SMILES: CCCCNC(=O)OC(C)CC(CC(O)CC)OC(C)=O]

(Formation of Optically Anisotropic Layer A)

The alignment film produced above was continuously subjected to a rubbing treatment. In this case, the longitudinal direction and the transport direction of the elongated film were parallel to each other, and an angle between the longitudinal direction (transport direction) of the film and the rotation axis of the rubbing roller was set to 72.5° (in a case where the longitudinal direction (transport direction) of the film was indicated by 90° and a counterclockwise direction was indicated by a positive value with reference to the width direction of the film as a reference (0°) observed from the alignment film side, the rotation axis of the rubbing roller was −17.5°; in other words, the position of the rotation axis of the rubbing roller corresponded to a position rotated by 72.5° clockwise with reference to the longitudinal direction of the film).

The alignment film produced above was continuously coated with an optically anisotropic layer coating liquid (A) containing a discotic liquid crystal (DLC) compound having the following composition using a #5.0 wire bar. A transportation speed (V) of the film was 26 μm/min. In order to dry the solvent of the coating liquid and to mature the alignment of the discotic liquid crystalline (DLC) compound, the film was heated with hot air at 115° C. for 90 seconds, further heated with hot air at 80° C. for 60 seconds, and irradiated with ultraviolet (UV) rays (irradiation amount: 70 mJ/cm²) at 80° C. to fix the alignment of the liquid crystalline compound. A thickness of the optically anisotropic layer A was 2.0 μm. It was confirmed that an average tilt angle of a disc plane of the DLC compound with respect to the film surface was 90°, and the DLC compound was aligned perpendicular to the film surface. In addition, the angle of the slow axis was parallel to the rotation axis of the rubbing roller, and in a case where the longitudinal direction (transport direction) of the film was indicated by 900 (the width direction of the film was 0° and a counterclockwise direction was indicated by a positive value with reference to the width direction of the film as a reference (0°) observed from the alignment film side), the angle of the slow axis was −17.5°. The obtained optically anisotropic layer A corresponded to a λ/2 plate, and the Re and Rth at a wavelength of 550 nm were respectively Re (550): 238 nm and Rth (550): −119 nm.

Optically anisotropic layer coating liquid (A)

| | | |
|---|---|---|
| Discotic liquid crystalline compound (A) shown below | 80 | parts by mass |
| Discotic liquid crystalline compound (B) shown below | 20 | parts by mass |
| Ethylene oxide-modified trimethylolpropane triacrylate | 5 | parts by mass |
| (V#360, manufactured by Osaka Organic Chemical Industry Ltd.) | | |
| Photopolymerization initiator | 4 | parts by mass |
| (IRGACURE 907, manufactured by Chiba Japan Co., Ltd.) | | |
| Compound (A) shown below | 2 | parts by mass |
| Pyridinium salt (A) shown below | 1.2 | parts by mass |
| Polymer (A) shown below | 0.2 | parts by mass |
| Polymer (B) shown below | 0.1 | parts by mass |
| Polymer (C) shown below | 0.06 | parts by mass |
| Methyl ethyl ketone | 212.9 | parts by mass |

Discotic liquid crystalline compound (A) 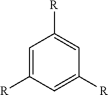 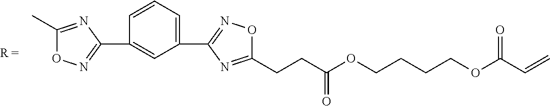 [SMILES: C=CC(=O)OCCCCOC(=O)CCc1nc(-c2cccc(-c3noc(C)n3)c2)no1]
Discotic liquid crystalline compound (B) 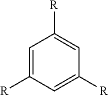 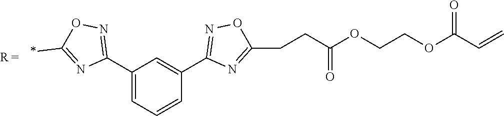 [SMILES: *c1nc(-c2cccc(-c3noc(CCC(=O)OCCOC(=O)C=C)n3)c2)no1]
Pyridinium salt (A) 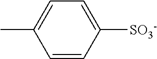
Compound (A) 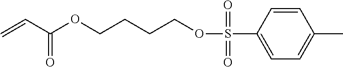 [SMILES: C=CC(=O)OCCCCOS(=O)(=O)c1ccc(C)cc1]
Polymer (A) 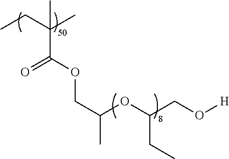
Polymer (B) 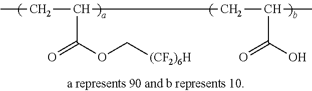
Polymer (C)

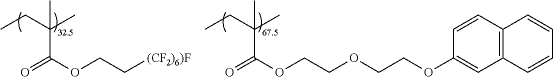

<Evaluation>

(Optical Properties)

—Contrast Evaluation—

The obtained light absorption anisotropic layers 1 to 6 and 12 to 15, the polarizer 1, and the laminates 7 to 11 were evaluated as follows.

The absorption maximal wavelength of each light absorption anisotropic layer and an absorbance at the absorption maximal wavelength with respect to non-polarized light was measured with an ultraviolet-visible-near infrared spectrophotometer V-660. In addition, with regard to the each light absorption anisotropic layer, a transmittance TzO which was a transmittance in an absorption axis direction with respect to polarized light and a transmittance TyO in a transmission axis direction with respect to the polarized light was measured with an ultraviolet-visible-near infrared spectrophotometer V-660 provided with an automatic absolute reflectivity measuring unit ARMN-735, manufactured by Jasco Corporation. A contrast of the each light absorption anisotropic layer was calculated according to the following expression, and the contrast was evaluated according to the following standard. A large contrast means a high S/N ratio for generating polarized light with respect to rays in the infrared wavelength region.
A: contrast at a wavelength of 830 nm was 50 or more.
B: contrast at a wavelength of 830 nm was 5 or more and less than 50.
C: contrast at a wavelength of 830 nm was 2 or more and less than 5.
D: contrast at a wavelength of 830 nm was less than 2.

Calculation Method:

Contrast=Ty0/Tz0

—Absorption Axis Evaluation—

Optical properties of the obtained light absorption anisotropic layer was measured with AxoScan OPMF-1 (manufactured by Opto Science, Inc.). Using an ultraviolet-visible-near infrared spectrophotometer V-660 provided with an automatic absolute reflectivity measuring unit ARMN-735, manufactured by Jasco Corporation, in an infrared region of 700 to 1500 nm, an absorbance A1 in a direction parallel to the slow axis of each light absorption anisotropic layer and an absorbance A2 in a direction parallel to a fast axis were measured, and the orientation of the absorption axis of the dichroic coloring agent was evaluated according to the following standard.

The slow axis of the light absorption anisotropic layer had the same definition as the alignment axis of the liquid crystalline compound, and the alignment axis of the liquid crystalline compound was evaluated as the absorption axis direction at a wavelength of 250 nm. In addition, “alignment axis of the liquid crystalline compound was parallel to the absorption axis of the above-described dichroic coloring agent” means that an angle between the alignment axis of the liquid crystalline compound and the absorption axis of the dichroic coloring agent was 0° to 5°.

A1/A2 was more than 1: alignment axis of the liquid crystalline compound was parallel to the absorption axis of the above-described dichroic coloring agent.

A1/A2 was less than 1: alignment axis of the liquid crystalline compound was orthogonal to the absorption axis of the above-described dichroic coloring agent.

(Moisture-Heat Resistance Evaluation)

With regard to test conditions for the moisture-heat resistance, a test in which an object was left to stand in an environment of 85° C. and a relative humidity of 85% for 500 hours was carried out.

The polarization degree and transmittance of the light absorption anisotropic layer before the test, and the polarization degree and transmittance of the light absorption anisotropic layer after the test were measured, and the moisture-heat resistance was evaluated according to the following standard. The results are shown in Table 1 below.
A: each change amount in polarization degree and transmittance after the test with respect to polarization degree and transmittance before the test was less than 20%.
B: any change amount in polarization degree and transmittance after the test with respect to polarization degree and transmittance before the test was 20% or more.

The results are summarized in Tables 1 and 2.

In Table 1, “Maximal absorption wavelength” indicates the maximal absorption wavelength of the dichroic coloring agent. However, in Reference Example, “Maximal absorption wavelength” indicates the maximal absorption wavelength of iodine.

In Table 1, “Absorbance at 850 nm” indicates the average absorbance of the light absorption anisotropic layer at a wavelength of 850 nm.

In Table 1, “Parallel” in the column of “Absorption axis evaluation” indicates that A1/A2 was more than 1, and “Orthogonal” indicates that A1/A2 was less than 1.

In Table 2, “Anisotropic layer X” is a general term for the polarizer 1, the laminate 8-1, the wire grid polarizer, and the optically anisotropic layer A.

TABLE 1

| | Thickness of | Maximal | | | | |
|---|---|---|---|---|---|---|
| | light absorption | absorption | | | | |
| | anisotropic layer | wavelength | Absorbance | Absorption | Contrast | Moisture-heat |
| | (μm) | (nm) | at 850 nm | axis evaluation | evaluation | resistance |
| Example 1 | 1.6 | 925 | 0.44 | Parallel | A | A |
| Example 2 | 1.2 | 928 | 0.39 | Parallel | B | A |
| Example 3 | 2.0 | 808 | 0.24 | Orthogonal | C | A |
| Example 4 | 1.2 | 925 | 0.35 | Parallel | B | A |
| Example 5 | 1.2 | 925 | 0.24 | Parallel | C | A |
| Example 6 | 1.2 | 830 | 0.34 | Parallel | C | A |
| Example 12 | 1.2 | 840 | 0.41 | Parallel | B | A |
| Example 13 | 1.2 | 830 | 0.40 | Parallel | B | A |
| Example 14 | 1.2 | 840 | 0.39 | Parallel | B | A |
| Example 15 | 1.2 | 840 | 0.46 | Parallel | B | A |
| Example 16 | 2.5 | 840 | 0.32 | Parallel | C | A |
| Example 17 | 3.2 | 865 | 0.41 | Parallel | C | A |
| Comparative | 1.2 | 925 | 0.22 | Parallel | D | A |
| Example 1 | | | | | | |
| Reference | 25.0 | <700 | — | — | D | B |
| Example | | | | | | |

TABLE 2

| | Light absorption | | Coating surface of | Orientation of absorption axis of | Contrast of |
|---|---|---|---|---|---|
| | anisotropic layer A | Anisotropic layer X | pressure sensitive adhesive | light absorption anisotropic layer A | laminate |
| Example 7 | Light absorption | Polarizer 1 | Polarizer side of polarizer 1 | 0° with respect to absorption axis | A |
| | anisotropic layer 1 | | | of polarizer 1 | |
| Example 8 | Light absorption | Laminate 8-1 | Coating surface side of | 0° with respect to absorption axis | A |
| | anisotropic layer 1 | | laminate 8-1 | of laminate 8-1 | |
| Example 9 | Light absorption | Laminate 8-1 | Coating surface side of | 90° with respect to absorption | A |
| | anisotropic layer 1 | | laminate 8-1 | axis of laminate 8-1 | |
| Example 10 | Light absorption | Wire grid | Non-forming surface of | 0° with respect to absorption axis | A |
| | anisotropic layer 1 | polarizer | wire grid polarizer | of wire grid polarizer | |
| Example 11 | Light absorption | Optically | Coating surface side of | 0° with respect to slow axis of | A |
| | anisotropic layer 1 | anisotropic layer A | optically anisotropic layer A | optically anisotropic layer A | |

From the results in Table 1, it was found that the light absorption anisotropic layer according to the embodiment of the present invention had a high contrast in the infrared region and favorable moisture-heat resistance. In addition, it was confirmed that the light absorption anisotropic layer according to the embodiment of the present invention had excellent moisture-heat resistance. In addition, from the results in Table 2, it was found that, even in a case of including the light absorption anisotropic layer B containing the dichroic coloring agent having a maximal absorption at a wavelength of 400 to 700 nm, in addition to the light absorption anisotropic layer A containing the dichroic coloring agent in the infrared region (700 to 1500 nm), favorable contrast was exhibited.

That is, since the light absorption anisotropic layer according to the embodiment of the present invention had a high contrast in the infrared region, the S/N ratio for generating polarized light with respect to rays in the infrared wavelength region was high. In addition, in the light absorption anisotropic layer according to the embodiment of the present invention, the thickness of the optically anisotropic layer was 5 μm or less, so that it was lightweight and had excellent handleability.

In addition, in the light absorption anisotropic layers according to the embodiment of the present invention (Examples 1 to 6 and 12 to 15) and the laminates according to the embodiment of the present invention (Examples 7 to 11), since the S/N ratio for generating polarized light with respect to rays in the infrared wavelength region was high, they could be suitably used for an infrared light sensor system.

### EXPLANATION OF REFERENCES

1a, 1b: light absorption anisotropic layer A
2, 2a, 1b: optically anisotropic layer
3: light absorption anisotropic layer B
11: infrared emitted light
12: infrared incident light
100a, 100b, 100c: infrared light sensor system
101: infrared light source
102: infrared light receiving section
103: visible light emitting panel
104: image display device
105: measurement target

What is claimed is:

1. Alight absorption anisotropic layer comprising:
a dichroic coloring agent having a maximal absorption at a wavelength of 700 to 1500 nm,
wherein an average absorbance at a wavelength of 850 nm is 0.24 to 0.50, and
a thickness is 5 μm or less.

2. The light absorption anisotropic layer according to claim 1, further comprising:
a liquid crystalline compound.

3. The light absorption anisotropic layer according to claim 1,
wherein an angle between an absorption axis at a wavelength of 250 nm and an absorption axis at a maximal absorption wavelength of the dichroic coloring agent is 0° to 5°.

4. The light absorption anisotropic layer according to claim 1,
wherein the light absorption anisotropic layer is formed of a composition containing the dichroic coloring agent and a liquid crystalline polymer.

5. The light absorption anisotropic layer according to claim 2,
wherein a content of the dichroic coloring agent is 1% to 50% by mass with respect to a content of the liquid crystalline compound.

6. The light absorption anisotropic layer according to claim 4,
wherein an aqueous solution of the liquid crystalline polymer exhibits lyotropic liquid crystallinity.

7. The light absorption anisotropic layer according to claim 2,
wherein the liquid crystalline compound exhibits thermotropic liquid crystallinity.

8. The light absorption anisotropic layer according to claim 1,
wherein the dichroic coloring agent exhibits thermotropic liquid crystallinity.

9. The light absorption anisotropic layer according to claim 1,
wherein an aqueous solution of the dichroic coloring agent exhibits lyotropic liquid crystallinity.

10. The light absorption anisotropic layer according to claim 1,
wherein an alignment degree at a maximal absorption wavelength of the dichroic coloring agent is 0.80 or more.

11. The light absorption anisotropic layer according to claim 2,
wherein the light absorption anisotropic layer shows a Bragg peak in an X-ray diffraction measurement.

12. The light absorption anisotropic layer according to claim 1,
wherein the light absorption anisotropic layer contains two or more kinds of the dichroic coloring agents.

13. The light absorption anisotropic layer according to claim 1, further comprising:
a dichroic coloring agent having a maximal absorption at a wavelength of 400 to 700 nm.

14. The light absorption anisotropic layer according to claim 13,
wherein an angle between an absorption axis at a maximal absorption wavelength of the dichroic coloring agent having a maximal absorption at a wavelength of 400 to 700 nm and an absorption axis at a maximal absorption wavelength of the dichroic coloring agent is 10° to 900.

15. The light absorption anisotropic layer according to claim 1,
wherein a luminosity corrected single transmittance at a wavelength of 400 to 700 nm is 30% to 50%.

16. The light absorption anisotropic layer according to claim 1,
wherein an average absorbance at a wavelength of 400 to 700 nm is 0.2 or less.

17. The light absorption anisotropic layer according to claim 1,
wherein an average absorbance at a wavelength of 750 nm is 0.2 to 0.5.

18. The light absorption anisotropic layer according to claim 1,
wherein an average absorbance at a wavelength of 1100 nm is 0.2 to 0.5.

19. A laminate comprising:
the light absorption anisotropic layer A according to claim 1; and
a light absorption anisotropic layer B,
wherein the light absorption anisotropic layer B contains a dichroic coloring agent having a maximal absorption at a wavelength of 400 to 700 nm, and
a luminosity corrected single transmittance of the light absorption anisotropic layer B at a wavelength of 400 to 700 nm is 30% to 50%.

20. The laminate according to claim 19,
wherein the light absorption anisotropic layer B consists of a stretched polyvinyl alcohol dyed with iodine.

21. The laminate according to claim 19,
wherein the light absorption anisotropic layer B contains a liquid crystalline compound.

22. The laminate according to claim 19,
wherein an absorption axis at a maximal absorption wavelength of the light absorption anisotropic layer A is parallel to an absorption axis at a maximal absorption wavelength of the light absorption anisotropic layer B.

23. The laminate according to claim 19,
wherein an angle between an absorption axis at a maximal absorption wavelength of the light absorption anisotropic layer A and an absorption axis at a maximal absorption wavelength of the light absorption anisotropic layer B is 10° to 90°.

24. A laminate comprising:
the light absorption anisotropic layer A according to claim 1; and
an optically anisotropic layer,
wherein, in a case where a maximal absorption wavelength of the light absorption anisotropic layer A is defined as a wavelength XA, an in-plane retardation of the optically anisotropic layer at the wavelength XA is 10 to λ_{A}/4 nm.

25. A laminate comprising:
the light absorption anisotropic layer A according to claim 1; and
an optically anisotropic layer,
wherein an in-plane retardation of the entire laminate at a wavelength of 550 nm is 0 to 50 nm.

26. The laminate according to claim 19, further comprising:
an optically anisotropic layer,
wherein, in a case where a maximal absorption wavelength of the light absorption anisotropic layer A is defined as a wavelength XA, an in-plane retardation of the optically anisotropic layer at the wavelength XA is 10 to λ_{A}/4 nm.

27. The laminate according to claim 19, further comprising:
an optically anisotropic layer,
wherein a sum of out-plane retardations of respective members of the laminate at a wavelength of 550 nm is −50 to 50 nm.

28. A laminate comprising:
the light absorption anisotropic layer A according to claim 1; and
a wire grid polarizer,
wherein an angle between an absorption axis of the light absorption anisotropic layer A and an absorption axis of the wire grid polarizer is 1° or less.

29. An infrared light sensor system comprising:
the light absorption anisotropic layer according to claim 1; and
at least one of an infrared reception unit or an infrared light source.

30. The light absorption anisotropic layer according to claim 1,
wherein the light absorption anisotropic layer is used for a display device, a sensor, a lens, a switching element, an isolator, or a camera.

31. The laminate according to claim 19,
wherein the laminate is used for a display device, a sensor, a lens, a switching element, an isolator, or a camera.
